(19) United States
(12) Patent Application Publication
(10) Pub. No.: US 2026/0211278 A1
(43) Pub. Date: Jul. 23, 2026

(54) SMART WINDOW ARTICLE WITH LIQUID CRYSTAL LAYER INCLUDING NEGATIVE AND POSITIVE LIQUID CRYSTALS AND INSULATED GLASS UNIT WITH SAME

(71) Applicants: CORNING INCORPORATED, CORNING, NY (US); KENT STATE UNIVERSITY, KENT, OH (US)

(72) Inventors: Liang-Chy Chien, Hudson, OH (US); Mingqian He, Horseheads, NY (US); Xiang-Dong Mi, Corning, NY (US); Timothy Ogolla, Morton, PA (US)

(21) Appl. No.: 19/456,327

(22) Filed: Jan. 22, 2026

Related U.S. Application Data
(60) Provisional application No. 63/748,942, filed on Jan. 23, 2025.

(51) Int. Cl. G02F 1/1333; G02F 1/1337; G02F 1/1343

(52) U.S. Cl. CPC G02F 1/133365; G02F 1/1337; G02F 1/13439

(57) ABSTRACT

A smart window article including: a first transparent substrate; a second transparent substrate; a first transparent electrode layer disposed on the first transparent substrate; a second transparent electrode layer disposed on the second transparent substrate; and a liquid crystal layer sandwiched between the first transparent electrode layer and the second transparent electrode layer. The liquid crystal layer includes a negative liquid crystal and a positive liquid crystal. The smart window article is operable to, from, and between a first voltage state and a second voltage state during which the liquid crystal layer is subjected to a working voltage of less than or equal to 55 V. During the first voltage state, the smart window article exhibits a haze of less than or equal to 20%. During the second voltage state, the smart window article exhibits a haze of greater than or equal to 70%.

### CROSS-REFERENCE TO RELATED APPLICATION

This application claims the benefit of priority under 35 U.S.C. § 119 of U.S. Provisional Application Ser. No. 63/748,942 filed on Jan. 23, 2025, the content of which is relied upon and incorporated herein by reference in its entirety.

### FIELD

The present disclosure pertains to a smart window article, such as to be incorporated into a multi-pane insulated glass unit, and more particularly to a smart window article with a liquid crystal layer including both positive liquid crystal and negative liquid crystal, and optionally a polymer.

### BACKGROUND

A window is a hole through an otherwise non-transparent structure, such as a wall of a building. The window permits the passage of waves, such as visible light, therethrough. Sometimes, a transparent article covers the window, such as glazing, which limits the passage of other things through the hole, such as birds, heat, rain, sound, and so on. A window covering, such as drapes, has been used to selectively permit or deny the passage of the visible light beyond or into the window.

Smart glass, sometimes referred to as switchable glass or a smart window, is a modern alternative to previous window coverings. With smart glass/windows, the selective passage of light is a function of some passive or active signal, such as electrical voltage or temperature, among other options. The former is generally referred to as electrically switchable smart glass/window, and visible light transmission through the smart glass/window changes as a function of voltage applied across a working material within the smart glass/window.

There are a variety of working materials that have been used with smart glass/windows. One category of working material is polymer-dispersed liquid crystal (PDLC), where droplets of liquid crystal are dispersed within a polymer matrix. In a smart glass/window, a layer of PDLC is sandwiched between transparent electrode layers. As the voltage to which the PDLC layer is subjected changes, so do one or more optical properties, such as transmittance. Another category is polymer-network liquid crystal (PNLC), which is similar to PDLC, but the liquid crystal is continuous rather than dispersed.

When using PDLC or PNLC as the working material, the layer of PDLC or PNLC may have a layer thickness of about 100 μm. The layer is typically formed on a plastic substrate and the resulting workpiece is then laminated to another piece of thick soda lime glass (outer panes) to form an article. The relatively thick layer of PDLC or PNLC combined with the thick soda lime glass can result in the article having a total thickness that is unsuitable for some applications, such as thin triple pane insulated glass units, and unsuitable for existing conventional LCD production facilities. Additionally, the layer of PDLC or PNLC typically requires driving voltage of greater than 48 Volts, which is suboptimally high and results in a device utilizing the layer to be classified as a Class 3 circuit under the National Electrical Code (NEC). Class 3 circuits require more stringent wiring and safety measures than other classes, such as Class 2, that utilize lower voltages. Third, smart glass utilizing PDLC or PNLC may exhibit suboptimally high haze in a clear state when viewed through an off-axis angle. The presence of the polymer with the layer of PDLC or PNLC can be haze inducing.

### SUMMARY

The present disclosure addresses those problems, among others, with a smart window article that incorporates a liquid crystal layer with both a positive liquid crystal and a negative liquid crystal. In some embodiments, the liquid crystal layer further comprises a polymer. In other embodiments, the liquid crystal layer is substantially free of polymer material. The smart window article can exhibit low haze under a no voltage state but a high haze under a working voltage state. The working voltage can be less than 48 V. The smart window article is sufficiently thin to incorporate into a multi-pane insulated glass unit.

According to a first aspect of the present disclosure, a smart window article comprises: (1) a first transparent substrate comprising a first inward facing surface and a first outward facing surface; (2) a second transparent substrate comprising a second inward facing surface and a second outward facing surface, the second inward facing surface opposing the first inward facing surface; (3) a first transparent electrode layer disposed on the first inward facing surface of the first transparent substrate; (4) a second transparent electrode layer disposed on the second inward facing surface of the second transparent substrate; and (5) a liquid crystal layer sandwiched between the first transparent electrode layer and the second transparent electrode layer, the liquid crystal layer comprising: a negative liquid crystal that exhibits a dielectric anisotropy (Δε) that is less than 0; and a positive liquid crystal that exhibits a dielectric anisotropy (Δε) that is greater than 0, wherein (a) the smart window article is operable to, from, and between (i) a first voltage state and (ii) a second voltage state during which the smart window article subjects the liquid crystal layer to a working voltage that is greater than a voltage to which the liquid crystal layer is subjected during the first voltage state, (b) during the first voltage state, the smart window article exhibits a haze of less than or equal to 20%, (c) during the second voltage state, the smart window article exhibits a haze of greater than or equal to 70%, and (d) the working voltage during the second voltage state is less than or equal to 55 V.

According to a second aspect of the present disclosure, the smart window article of the first aspect is presented, wherein the first transparent substrate and second transparent substrate each individually comprise glass, glass-ceramic, or plastic.

According to a third aspect of the present disclosure, the smart window article of the first aspect or the second aspect is presented, wherein the liquid crystal layer further comprises a polymer.

According to a fourth aspect of the present disclosure, the smart window article of the third aspect is presented, wherein the polymer comprises a polyacrylate, a diacrylate, a polyurethane, a polyurethane acrylate, a polyvinyl alcohol, a polyvinyl acetate, a poly(vinyl alcohol-co-vinyl acrylate), polyethylene, polypropylene, copolymers of any of the foregoing, or mixtures of any of the foregoing.

According to a fifth aspect of the present disclosure, the smart window article of the third aspect or the fourth aspect is presented, wherein the polymer is prepared by polymerizing one or more monomers selected from the group consisting of acrylate, diacrylate, methacrylate, methyl methacrylate, urethane, vinyl acetate, ethylene, and propylene.

According to a sixth aspect of the present disclosure, the smart window article of any one of the third through fifth aspects is presented, wherein a weight percentage of the polymer within the liquid crystal layer is in a range of greater than or equal to 50 wt. %, based on the total weight of the liquid crystal layer.

According to a seventh aspect of the present disclosure, the smart window article of any one of the third through fifth aspects is presented, wherein a weight percentage of the polymer within the liquid crystal layer is in a range of 1 wt. % to 15 wt. %, based on the total weight of the liquid crystal layer.

According to an eighth aspect of the present disclosure, the smart window article of the seventh aspect is presented, wherein the weight percentage of the polymer within the liquid crystal layer is in a range of 3 wt. % to 10 wt. %, based on the total weight of the liquid crystal layer.

According to a ninth aspect of the present disclosure, the smart window article of the first aspect or the second aspect is presented, wherein the liquid crystal layer is substantially free of a polymer.

According to a tenth aspect of the present disclosure, the smart window article of any one of the first through sixth aspects is presented, wherein during the first voltage state, the smart window article exhibits a transmittance of greater than or equal to 20%.

According to an eleventh aspect of the present disclosure, the smart window article of any one of the first through fifth aspects or seventh through tenth aspects is presented, wherein during the first voltage state, the smart window article exhibits a transmittance of greater than or equal to 50%.

According to a twelfth aspect of the present disclosure, the smart window article of the eleventh aspect is presented, wherein during the first voltage state, the transmittance that the smart window article exhibits is greater than or equal to 60%.

According to a thirteenth aspect of the present disclosure, the smart window article of the eleventh aspect is presented, wherein during the first voltage state, the transmittance that the smart window article exhibits is greater than or equal to 70%.

According to a fourteenth aspect of the present disclosure, the smart window article of the eleventh aspect is presented, wherein during the first voltage state, the transmittance that the smart window article exhibits is greater than or equal to 80%.

According to a fifteenth aspect of the present disclosure, the smart window article of the eleventh aspect is presented, wherein during the first voltage state, the transmittance that the smart window article exhibits is greater than or equal to 85%.

According to a sixteenth aspect of the present disclosure, the smart window article of any one of the first through fifteenth aspects is presented, wherein the first transparent electrode layer and the second transparent electrode layer each comprise a transparent conductive oxide.

According to a seventeenth aspect of the present disclosure, the smart window article of any one of the first through sixteenth aspects is presented, wherein the negative liquid crystal and the positive liquid crystal are both organic molecules that lack fluorine as an atomic constituent.

According to an eighteenth aspect of the present disclosure, the smart window article of any one of the first through seventeenth aspects is presented, wherein the positive liquid crystal comprises a nematic liquid crystal, a smectic liquid crystal, or a dimeric mesogen.

According to a nineteenth aspect of the present disclosure, the smart window article of any one of the first through eighteenth aspects is presented, wherein the negative liquid crystal comprises a nematic liquid crystal, or one or more of HNG-715600-100 and MLC-2079.

According to a twentieth aspect of the present disclosure, the smart window article of any one of the first through nineteenth aspects is presented, wherein the positive liquid crystal comprises one or more of 5CB, 8CB, CB5CB, HTG-135200-100, BL006, 80CB, E7, and MLC-6080.

According to a twenty-first aspect of the present disclosure, the smart window article of any one of the first through twentieth aspects is presented, wherein a weight percentage of the positive liquid crystal within the liquid crystal layer is within a range of from 6.0 wt % to 35 wt %, based on the total weight of the positive liquid crystal and the negative liquid crystal.

According to a twenty-second aspect of the present disclosure, the smart window article of any one of the first through twenty-first aspects is presented, wherein the liquid crystal layer has a LC layer thickness that is within a range of from 2 μm to 20 μm.

According to a twenty-third aspect of the present disclosure, the smart window article of any one of the first through twenty-second aspects is presented, wherein the liquid crystal layer has a layer thickness that is less than or equal to 10 μm.

According to a twenty-fourth aspect of the present disclosure, the smart window article of any one of the first through twenty-third aspects is presented, wherein the liquid crystal layer has a layer thickness that is less than or equal to 8 μm.

According to a twenty-fifth aspect of the present disclosure, the smart window article of any one of the first through twenty-fourth aspects is presented, wherein (i) the liquid crystal layer further comprises a chiral dopant, and (ii) the liquid crystal layer exhibits a chiral nematic phase at room temperature.

According to a twenty-sixth aspect of the present disclosure, the smart window article of any one of the first through twenty-fifth aspects is presented, wherein a weight percentage of the chiral dopant within the liquid crystal is sufficient to cause the liquid crystal to exhibit a twist within a range of from 0.25 T to 1.25 T.

According to a twenty-seventh aspect of the present disclosure, the smart window article of any one of the first through twenty-sixth aspects is presented, wherein the liquid crystal layer further comprises a dichroic dye.

According to a twenty-eighth aspect of the present disclosure, the smart window article of the twenty-seventh aspect is presented, wherein a weight percentage of the dichroic dye within the liquid crystal layer is within a range of from 0.2 wt % to 3.5 wt %.

According to a twenty-ninth aspect of the present disclosure, the smart window article of any one of the first through twenty-eighth aspects further comprises: (i) a first alignment layer disposed on the first transparent electrode; and (ii) a second alignment layer disposed on the second transparent electrode and opposing the first alignment layer, wherein, the liquid crystal layer is sandwiched between and contacting the first alignment layer and the second alignment layer.

According to a thirtieth aspect of the present disclosure, the smart window article of the twenty-ninth aspect is presented, wherein the first alignment layer and the second alignment layer provide parallel alignment of molecules of the negative liquid crystal and the positive liquid crystal contacting the first alignment layer and the second alignment layer.

According to a thirty-first aspect of the present disclosure, the smart window article of the twenty-ninth aspect is presented, wherein the first alignment layer and the second alignment layer provide vertical alignment of molecules of the negative liquid crystal and the positive liquid crystal contacting the first alignment layer and the second alignment layer.

According to a thirty-second aspect of the present disclosure, the smart window article of any one of the twenty-ninth through thirty-first aspects is presented, wherein the first alignment layer and the second alignment layer each comprise a polyimide.

According to a thirty-third aspect of the present disclosure, the smart window article of any one of the first through thirty-second aspects further comprises a total thickness that is less than or equal to 0.50 mm.

According to a thirty-fourth aspect of the present disclosure, the smart window article of any one of the first through thirty-second aspects further comprises a total thickness that is less than or equal to 0.70 mm.

According to a thirty-fifth aspect of the present disclosure, the smart window article of any one of the first through thirty-second aspects further comprises a total thickness that is less than or equal to 1.1 mm.

According to a thirty-sixth aspect of the present disclosure, the smart window article of any one of the first through thirty-second aspects further comprises a total thickness that is within a range of from 0.15 mm to 1.1 mm.

According to a thirty-seventh aspect of the present disclosure, the smart window article of any one of the first through thirty-sixth aspects is presented, wherein, during the first voltage state, the haze that the smart window article exhibits is less than or equal to 3%.

According to a thirty-eighth aspect of the present disclosure, the smart window article of any one of the first through thirty-sixth aspects is presented, wherein, during the first voltage state, the haze that the smart window article exhibits is less than or equal to 1%.

According to a thirty-ninth aspect of the present disclosure, the smart window article of any one of the first through thirty-sixth aspects is presented, wherein, during the first voltage state, the haze that the smart window article exhibits is less than or equal to 0.5%.

According to a fortieth aspect of the present disclosure, the smart window article of any one of the first through thirty-ninth aspects is presented, wherein, during the second voltage state, the haze that the smart window article exhibits is greater than or equal to 80%.

According to a forty-first aspect of the present disclosure, the smart window article of any one of the first through thirty-ninth aspects is presented, wherein, during the second voltage state, the haze that the smart window article exhibits is greater than or equal to 90%.

According to a forty-second aspect of the present disclosure, the smart window article of any one of the first through thirty-ninth aspects is presented, wherein, during the second voltage state, the haze that the smart window article exhibits is greater than or equal to 97%.

According to a forty-third aspect of the present disclosure, the smart window article of any one of the first through forty-second aspects is presented, wherein the working voltage during the second voltage state is less than or equal to 41 V.

According to a forty-fourth aspect of the present disclosure, the smart window article of any one of the first through forty-second aspects is presented, wherein the working voltage during the second voltage state is less than or equal to 31V.

According to a forty-fifth aspect of the present disclosure, the smart window article of any one of the first through forty-second aspects is presented, wherein the working voltage during the second voltage state is within a range of from 20 V to 28 V.

According to a forty-sixth aspect of the present disclosure, the smart window article of any one of the first through forty-fifth aspects is presented, wherein the smart window article is operable at a third voltage state, wherein the working voltage during the third voltage state is less than the working voltage during the second voltage state and greater than or equal to the working voltage during the first voltage state, and during the third voltage state, the transmittance that the smart window article exhibits is (i) lower than the transmittance that the smart window article exhibits during the first voltage state and (ii) higher than the transmittance that the smart window article exhibits during the second voltage state.

According to a forty-seventh aspect of the present disclosure, the smart window article of the forty-sixth aspect is presented, wherein during the third voltage state, the haze that the smart window article exhibits is (i) similar to the haze that the smart window article exhibits during the first voltage state and (ii) lower than the haze that the smart window article exhibits during the second voltage state.

According to a forty-eighth aspect of the present disclosure, a method of operating the smart window article of any one of the first through forty-seventh aspects comprises a privacy transition step comprising applying a working voltage of less than or equal to 55 V to the first transparent electrode layer and the second transparent electrode layer, thereby causing the smart window article to transition from the first voltage state to the second voltage state.

According to a forty-ninth aspect of the present disclosure, an insulated glass unit comprises a first outer pane, a second outer pane, and at least one spacer element defining a space between the first outer pane and the second outer pane, wherein at least one of the first outer pane and the second outer pane comprises the smart window article of any one of the first through forty-seventh aspects.

According to a fiftieth aspect of the present disclosure, an insulated glass unit comprises a first outer pane, a second outer pane, an inner pane disposed between the first outer pane and the second outer pane; and at least one spacer element further defines (i) a first space between the first outer pane and the inner pane and (ii) a second space between the inner pane and the second outer pane, wherein at least one of the first outer pane, the second outer pane, and the inner pane comprises the smart window article of any one of the first through forty-seventh aspects.

According to a fifty-first aspect, the insulated glass unit of the fiftieth aspect is presented wherein the inner pane comprises the smart window article of any one of the first through forty-seventh aspects.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description, serve to explain principles and operation of the various embodiments.

### BRIEF DESCRIPTION OF THE DRAWINGS

In the Drawings:

FIG. 1 is a perspective view of a smart window article of the present disclosure, illustrating a liquid crystal layer disposed between a first transparent substrate and a second transparent substrate;

FIG. 2 is an elevational view of a cross-section of the smart window article taken through line II-II of FIG. 1, illustrating the smart window article further including a first transparent electrode layer on the first transparent substrate facing the liquid crystal layer, a second transparent electrode layer on the second transparent substrate facing the liquid crystal layer, a first alignment layer on the first electrode layer contacting the liquid crystal layer, a second alignment layer on the second electrode layer contacting the liquid crystal layer, and an electrical circuit in communication with the first transparent electrode layer and the second transparent electrode layer to subject the liquid crystal layer to a voltage during a second voltage state;

FIG. 3 is a schematic diagram of a method of operating the smart window article, illustrating (i) a voltage increase step during which the liquid crystal layer is subjected to a voltage and the haze that the smart window article exhibits increases and (ii) a voltage decrease step during which the liquid crystal layer is subjected to no voltage or less of a working voltage and the haze that the smart window article exhibits decreases;

FIG. 4 is a perspective view of an insulated glass unit that incorporates the smart window article of the present disclosure;

FIG. 5 is an elevational view of a cross-section of the insulated glass unit of FIG. 4, illustrating the smart window article disposed between a first outer pane and a second outer pane and separated therefrom by a first space and a second space by one or more spacer elements; and

FIGS. 6-47, pertaining to Examples 1-121, reproduce graphs that plot either transmittance or haze that smart window articles exhibit as a function of the working voltage to which the liquid crystal layer is subjected.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The term “substantially” may be utilized herein to represent the inherent degree of uncertainty that may be attributed to any quantitative or qualitative comparison, value, measurement, or other representation. This term is also utilized herein to represent the degree by which a quantitative or qualitative representation may vary from a stated reference without resulting in a change in the basic character or function of the subject matter at issue. Thus, for example, a composition that is “substantially free” of any specific component (e.g., Al₂O₃, MgO, or any other component) is one in which the component is not actively added or batched into the composition, but may be present in small amounts as a contaminant (e.g., less than 1000, 500, 400, 300, 200, or 100 ppm), or, if actively added or batched, is present in an amount less than 1 wt. % (e.g., or can be specified to be less than 0.5 wt. %, 0.1 wt. %, or 0.05 wt. %), based on total amount of the composition (moles or mass for ppm, and mass for wt. %). Similarly, for example, a surface of a glass-based substrate or article that is “substantially planar” is one in which there may be slight deviations from planarity, but the overall character and function of the surface is unaffected by such deviations for the purposes of the surface being planar. A composition that is “free of” a component means that the component is not detectable by a reasonable standard method typically utilized in the art for detecting such a component (i.e., this would exclude exotic, hypersensitive methods for detecting such a component).

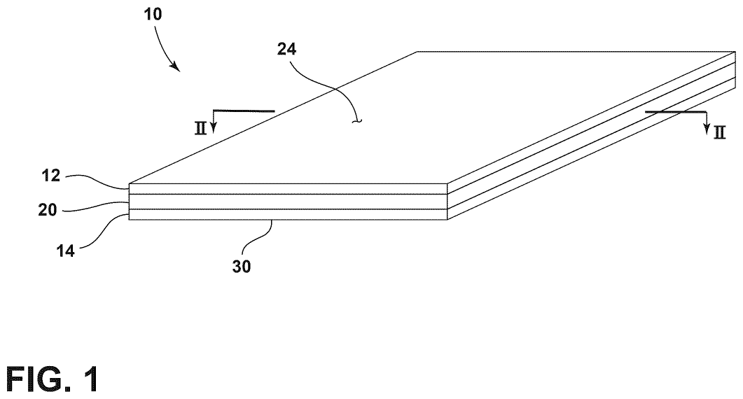

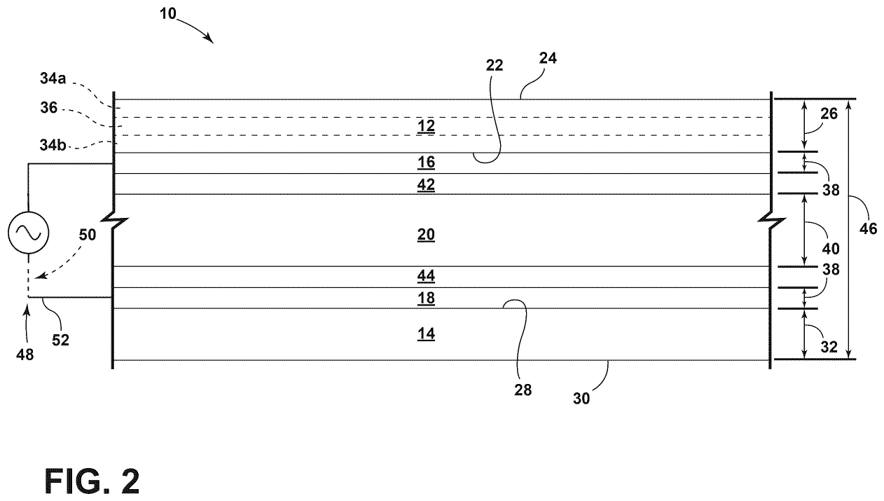

Referring now to FIGS. 1 and 2, a smart window article 10 of the present disclosure is herein described. The smart window article 10 includes a first transparent substrate 12, a second transparent substrate 14, a first transparent electrode layer 16, a second transparent electrode layer 18, and a liquid crystal layer 20. The smart window article 10 can include additional components, some of which are described below. As used herein, the term “smart window article” encompasses a liquid crystal layer sandwiched between two transparent electrode layers, and the two transparent electrode layers having the liquid crystal layer sandwiched therebetween is further sandwiched between two transparent substrates. Unless indicated otherwise, the term “smart window article” does not encompass any outer panes disposed adjacent (directly or indirectly) to an outward facing surface of either of the two transparent substrates.

The first transparent substrate 12 includes a first inward facing surface 22 and a first outward facing surface 24. The first inward facing surface 22 and the first outward facing surface 24 face in generally opposite directions. Both the first inward facing surface 22 and the first outward facing surface 24 can be planar and parallel to each other but need not be. The first transparent substrate 12 further includes a first substrate thickness 26. The first substrate thickness 26 is the shortest straight-line distance between the first inward facing surface 22 and the first outward facing surface 24. A micrometer can be utilized to determine the first substrate thickness 26. In embodiments, the first substrate thickness 26 is within a range of from 0.1 mm to 4 mm. For example, the first substrate thickness 26 can be 0.1 mm, 0.2 mm, 0.3 mm, 0.4 mm, 0.5 mm, 0.6 mm, 0.7 mm, 0.8 mm, 0.9 mm, 1.0 mm, 1.2 mm, 1.4 mm, 1.6 mm, 1.8 mm, 2.0 mm, 2.2 mm, 2.4 mm, 2.6 mm, 2.8 mm, 3.0 mm, 3.2 mm, 3.4 mm, 3.6 mm, 3.8 mm, 4.0 mm, or within any range bound by any two of those values (e.g., from 0.2 mm to 0.8 mm, from 1.0 mm to 2.0 mm, and so on). The first substrate thickness 26 can be greater than 4.0 mm.

The second transparent substrate 14 includes a second inward facing surface 28 and a second outward facing surface 30. The second inward facing surface 28 and the second outward facing surface 30 face in generally opposite directions. The second inward facing surface 28 opposes the first inward facing surface 22 of the first transparent substrate 12. Both the second inward facing surface 28 and the second outward facing surface 30 can be planar and parallel to each other but need not be. The second transparent substrate 14 further includes a second substrate thickness 32. The second substrate thickness 32 is the shortest straight-line distance between the second inward facing surface 28 and the second outward facing surface 30. A micrometer can be utilized to determine the second substrate thickness 32. In embodiments, the second substrate thickness 32 is within a range of from 0.1 mm to 4 mm. For example, the second substrate thickness 32 can be 0.1 mm, 0.2 mm, 0.3 mm, 0.4 mm, 0.5 mm, 0.6 mm, 0.7 mm, 0.8 mm, 0.9 mm, 1.0 mm, 1.2 mm, 1.4 mm, 1.6 mm, 1.8 mm, 2.0 mm, 2.2 mm, 2.4 mm, 2.6 mm, 2.8 mm, 3.0 mm, 3.2 mm, 3.4 mm, 3.6 mm, 3.8 mm, 4.0 mm, or within any range bound by any two of those values (e.g., from 0.2 mm to 0.8 mm, from 1.0 mm to 2.0 mm, and so on). The second substrate thickness 32 can be greater than 4.0 mm.

The first transparent substrate 12 and the second transparent substrate 14 can have any composition that renders the first transparent substrate 12 and the second transparent substrate 14 suitable for its intended application. The compositions of the first transparent substrate 12 and the second transparent substrate 14 can be the same or they can be different. Examples include glass, glass-ceramic, and plastic compositions. The glass-ceramic composition differs from the glass composition in that the former has both an amorphous phase and a crystalline phase, while the latter includes an amorphous phase but no substantial crystalline phase.

Suitable glass compositions include soda lime glass compositions, aluminosilicate glass compositions, alkali aluminosilicate glass compositions, borosilicate glass compositions, alkali borosilicate glass compositions, aluminoborosilicate glass compositions, alkali aluminoborosilicate glass compositions, alkaline earth boro-aluminosilicate glass compositions, among other options.

The alkali aluminosilicate glass composition, if included as part of the first transparent substrate 12 or the second transparent substrate 14, includes alumina, at least one alkali metal, and SiO₂, such as greater than 50 mol % SiO₂. The alkali aluminosilicate glass composition can include at least 58 mol % SiO₂, and in still other embodiments at least 60 mol % SiO₂, wherein the ratio ((Al₂O₃+B₂O₃)/Σ_{modifiers})>1, and where in the ratio the components are expressed in mol % and the modifiers are alkali metal oxides. A more particular example includes from 58 mol % to 72 mol % SiO₂; from 9 mol % to 17 mol % Al₂O₃; from 2 mol % to 12 mol % B₂O₃; from 8 mol % to 16 mol % Na₂O, and from 0 to 4 mol % K₂O, wherein the ratio ((Al₂O₃+B₂O₃)/Σ_{modifiers})>1.

The soda lime glass composition, if included as part of the substrate 12, includes SiO₂, Na₂O, and CaO. An example soda lime composition includes 72 mol % SiO₂, 1 mol % Al₂O₃, 14 mol % Na₂O, 4 mol % MgO, and 7 mol % CaO.

The alkaline earth boroaluminosilicate glass composition, if included as part of the first transparent substrate 12 or the second transparent substrate 14, includes an alkaline earth metal, B₂O₃, alumina, and silica. An example alkaline earth boroaluminosilicate glass composition comprises, on an oxide basis, from 65 wt % to 75 wt % SiO₂, from 7 wt % to 13 wt % Al₂O₃, from 5 wt % to 15 wt % B₂O₃, from 5 wt % to 15 wt % CaO, from 0 to 5 wt % BaO, from 0 to 3 wt % MgO, and from 0 to 5 wt % SrO. Another example alkaline earth boroaluminosilicate glass composition comprises, on an oxide basis, from 65 mol % to 70 mol % SiO₂, from 3.0 mol % to 4.0 mol % B₂O₃, from 12.0 mol % to 13.0 mol % Al₂O₃, from 13.0 mol % to 14.0 mol % Na₂O, >0 mol % K₂O, from 1.7 mol % to 2.7 mol % MgO, >0 mol % Fe₂O₃, and >0 mol % SnO₂. Yet another example alkaline earth boroaluminosilicate glass composition comprises, on an oxide basis, from 70 mol % to 80 mol % SiO₂, from 12.0 mol % to 13.0 mol % B₂O₃, from 3.0 mol % to 4.0 mol % Al₂O₃, from 5.0 mol % to 6.0 mol % Na₂O, from 0.5 mol % to 1.5 mol % K₂O, from 1.3 mol % to 2.3 mol % MgO, >0 mol % CaO, >0 mol % BaO, >0 mol % Fe₂O₃, >0 mol % TiO₂, >0 mol % SnO₂, and >0 mol % ZnO₂. These glass compositions are exemplary only and are not intended to be limiting. Two more particular glass compositions are set forth in Table 1 below.

TABLE 1

| | Glass A | | Glass B | |
|---|---|---|---|---|
| oxide | wt % | mol % | wt % | mol % |
| SiO₂ | 61.88 | 67.55 | 72.65 | 76.06 |
| B₂O₃ | 3.90 | 3.67 | 13.8 | 12.47 |
| Al₂O₃ | 19.69 | 12.67 | 5.65 | 3.49 |
| Li₂O | — | — | — | — |
| Na₂O | 12.91 | 13.66 | 5.09 | 5.16 |
| K₂O | 0.02 | 0.01 | 1.39 | 0.93 |
| MgO | 1.43 | 2.33 | 1.12 | 1.75 |
| CaO | | | 0.02 | 0.01 |
| BaO | | | 0.004 | 0.002 |
| Fe₂O₃ | 0.02 | 0.01 | 0.01-0.1 | 0.01-0.04 |
| TiO₂ | | | 0.01 | 0.01 |
| SnO₂ | 0.22 | 0.10 | 0.15 | 0.06 |
| ZrO₂ | | | 0.02 | 0.01 |

The first transparent substrate 12 and the second transparent substrate 14 having the glass composition can be formed from any suitable process. In embodiments where the first transparent substrate 12 and the second transparent substrate 14 takes the form of a sheet, the first transparent substrate 12 and the second transparent substrate 14 can be formed via a float process or an overflow downdraw fusion process, although other processes are envisioned. In the float process, a glass ribbon is formed on the surface of a molten metal bath, e.g., a molten tin bath, and after being removed from the bath is passed through an annealing lehr before being cut into individual sheets. In the case of the fusion process, a glass ribbon is formed by passing molten glass around the outside of a forming structure (known in the art as an “isopipe”) to produce two layers of glass that fuse together at the bottom of the forming structure (the root of the isopipe) to form the glass ribbon. The glass ribbon is pulled away from the isopipe by pulling rollers and cooled as it moves vertically downward through a temperature-controlled housing. At, for example, the bottom of the housing (bottom of the draw), individual glass sheets are cut from the ribbon.

The glass-ceramic composition can be formed from the glass composition through a suitable heat-treatment process or formed directly where crystallization occurs upon casting and does not require a separate heat-treatment process. Suitable glass-ceramic compositions are set forth in Table 2 below.

TABLE 2

| composition (mol %) | Ex. A | Ex. B | Ex. C |
|---|---|---|---|
| SiO₂ | 70.39 | 70.77 | 68.98 |
| A1₂O₃ | 4.21 | 4.21 | 4.03 |
| P₂O₅ | 0.85 | 0.85 | 1.01 |
| Li₂O | 21.16 | 21.98 | 22.31 |
| Na₂O | 1.50 | 0.06 | 0.07 |
| K₂O | 0.13 | 0.07 | 0.07 |
| ZrO₂ | 1.71 | 2.01 | 2.78 |
| CaO | 0.01 | 0.02 | 0.71 |
| Fe₂O₃ | 0.02 | 0.02 | 0.02 |
| HfO₂ | 0.02 | 0.02 | 0.03 |
| SnO₂ | 0.01 | 0.01 | 0.01 |

After heat-treatment, the glass-ceramics resulting from the above compositions contain the following phase assemblages presented in Table 3.

TABLE 3

| | | lithium disilicate | petalite | other |
|---|---|---|---|---|
| | Glass | (Li₂Si₂O₅) | (LiAlSi₄O₁₀) | phases |
| Material | (wt %) | (wt %) | (wt %) | (wt %) |
| Ex. A | 19 | 43 | 38 | <2% |
| Ex. B | 12 | 45 | 43 | <2% |
| Ex. C | 13 | 44 | 42 | <2% |

In embodiments, one or more of the first transparent substrate 12 and the second transparent substrate 14 further includes a compressive stress region 34a at or near the first outward facing surface 24 or the second outward facing surface 30, as the case may be. In such circumstances, one or more of the first transparent substrate 12 and the second transparent substrate 14 can be referred to as a strengthened substrate. Similarly, the one or more of the first transparent substrate 12 and the second transparent substrate 14 can include another compressive stress region 34b at or near the first inward facing surface 22 or the second inward facing surface 28, as the case may be. In such instances, a tensile stress region 36 (e.g., central tension) balances, and is disposed between the compressive stress regions 34a, b. The compressive stress regions 34a, b strengthen the one or more of the first transparent substrate 12 and the second transparent substrate 14. Photoelastic methods (e.g., transmission photoelasticity) can be utilized to determine whether the one or more of the first transparent substrate 12 and the second transparent substrate 14 has the compressive stress regions 34a, b.

The compressive stress regions 34a, b can be imparted to the one or more of the first transparent substrate 12 and the second transparent substrate 14 through a variety of methods. Examples include chemical tempering (e.g., ion-exchange), thermal tempering, and lamination.

With ion-exchange, alkali cations within a source of such cations (e.g., a molten salt or “ion-exchange” bath) are exchanged with smaller alkali cations within the first transparent substrate 12. For example, potassium ions from the cation source are exchanged for sodium and/or lithium ions within the first transparent substrate 12 during ion-exchange by immersing the first transparent substrate 12 in a molten salt bath comprising a potassium salt such as, but not limited to, potassium nitrate (KNO₃). Other potassium salts that may be used in the ion-exchange process include, but are not limited to, potassium chloride (KCl), potassium sulfate (K₂SO₄), combinations thereof, and the like. The ion-exchange baths described herein may contain alkali ions other than potassium and their corresponding salts. For example, the ion-exchange bath may also include sodium salts such as sodium nitrate, sodium sulfate, sodium chloride, or the like. The exchange of the cations generates the compressive stress regions 34 a, b. The compressive stress region 34a extends from the first outward facing surface 24 to a depth of compression (DOC) within the first transparent substrate 12. Likewise, the other compressive stress region 34b, if included, extends from the first inward facing surface 22, to the DOC. The second transparent substrate 14 can be chemically tempered in the same manner without having to repeat the details above.

With thermal tempering, the first transparent substrate 12 is heated to a temperature near its softening point. The first transparent substrate 12 is then removed from the heating medium and the first outward facing surface 24 and first inward facing surface 22 thereof are rapidly cooled to below the strain point of the glass of the first transparent substrate 12, e.g., the temperature at which a molten glass is deemed to have become rigid. Thus, the glass near the first outward facing surface 24 and the first inward facing surface 22 of the first transparent substrate 12 quickly contracts and rigidifies while the glass at an interior further away from the first outward facing surface 24 and the first inward facing surface 22 is still relatively more fluid and expanded. As the first transparent substrate 12 is cooled to a constant ambient temperature, the interior tries to contract more than the glass near the first outward facing surface 24 and the first inward facing surface 22 due to the slower cooling rate of the interior, but it is restrained by the rigidity of the glass near the first outward facing surface 24 and the first inward facing surface 22. Hence, when the temperatures of the first transparent substrate 12 reach equilibrium, the stresses at the first outward facing surface 24 and the first inward facing surface 22 become highly compressive and are balanced by tensile stress within the interior of the first transparent substrate 12. When the compressive stress regions 34a, b have been imparted by thermal tempering, the first transparent substrate 12 can be referred to as a tempered material. The second transparent substrate 14 can be thermally tempered in the same manner without having to repeat the details above.

With lamination, surface layers or skins of relatively low thermal expansion are fused to core layers of relatively high thermal expansion so that compressive stress can develop in the major surface regions as the first transparent substrate 12 (with the laminated layers) is cooled following formation. Lamination is like thermal tempering in that, as the first transparent substrate 12 cools, the interior (with the relatively high thermal expansion) tries to contract but is restrained by the major surface regions (with the relatively low thermal expansion) that are contracting less upon cooling. The second transparent substrate 14 can be subjected to lamination in the same manner without having to repeat the details above.

One or more of the first transparent substrate 12 and the second transparent substrate 14 can be polymer films such as polyethylene terephthalate (PET). The polymer films include films made of polyolefin, polyester, polyvinyl chloride, polyvinyl fluoride, polyvinylidene difluoride, polyvinylidene chloride, polyacrylate, polycarbonate, polyurethane, and combinations thereof.

In embodiments, the first transparent substrate 12 and the second transparent substrate 14 each exhibits an average transmittance of greater than or equal to 50% throughout the visible spectrum. For example, the average transmittance throughout the visible spectrum that the first transparent substrate 12 and the second transparent substrate 14 each exhibit can be 50%, 55%, 60%, 70%, 75%, 80%, 85%, 90%, or 95%, or within any range bound by any two of those values (e.g., from 50% to 95%, from 50% to 85%, and soon). The average transmittance can be determined according to ASTM D1003.

As mentioned, the smart window article 10 includes the first transparent electrode layer 16 and the second transparent electrode layer 18. The first transparent electrode is disposed on the first inward facing surface 22 of the first transparent substrate 12. Similarly, the second transparent electrode is disposed on the second inward facing surface 28 of the second transparent substrate 14. The first transparent electrode and the second transparent electrode oppose each other.

The first transparent electrode layer 16 and the second transparent electrode layer 18 can each be or include one or more transparent conductive oxides (TCOs). Examples of suitable TCOs include indium tin oxide (ITO), indium zinc oxide (IZO), gallium zinc oxide (GZO), and aluminum zinc oxide (AZO), among others. Alternatively, and additionally, first transparent electrode layer 16 and the second transparent electrode layer 18 can each be or include other transparent materials, such as a conductive mesh, e.g., silver nanowires or other nanomaterials such as graphene or carbon nanotubes. Printable conductive ink layers such as Activegrid® from DuPont (Delaware, USA) may also be used. In embodiments, the first transparent electrode layer 16 and the second transparent electrode layer 18 each exhibit a sheet resistance of 10Ω/γ (ohms/square), 50Ω/γ, 100Ω/γ, 200Ω/γ, 300Ω/γ, 400Ω/γ, 500Ω/γ, 600Ω/γ, 700Ω/γ, 800Ω/γ, 900Ω/γ, 1000Ω/γ, or within any range bound by any two of those values (e.g., from 50Ω/γ to 1000Ω/γ, from 500Ω/γ to 700 f/γ, and so on).

The first transparent electrode layer 16 and the second transparent electrode layer 18 can each be fabricated using any technique known in the art. Such techniques include vacuum sputtering, film lamination, and printing techniques.

The first transparent electrode layer 16 and the second transparent electrode layer 18 each include an electrode layer thickness 38. The electrode layer thickness 38 of the first transparent electrode layer 16 is measured orthogonally to the first inward facing surface 22 of the first transparent substrate 12. The electrode layer thickness 38 of the second transparent electrode layer 18 is measured orthogonally to the second inward facing surface 28 of the second transparent substrate 14. The measurements can be made using a scanning electron microscope. In embodiments, the electrode layer thicknesses 38 are each independently 1 nm, 5 nm, 10 nm, 100 nm, 200 nm, 300 nm, 400 nm, 500 nm, 600 nm, 700 nm, 800 nm, 900 nm, 1000 nm, or within any range bound by any two of those values (e.g., from 1 nm to 1000 nm, from 5 nm to 200 nm, and so on).

As mentioned, the smart window article 10 includes the liquid crystal layer 20. The liquid crystal layer 20 is sandwiched between the first transparent electrode layer 16 and the second transparent electrode layer 18. The liquid crystal layer 20 includes both a negative liquid crystal and a positive liquid crystal. The negative liquid crystal exhibits a dielectric anisotropy (Δε) that is less than 0. The positive liquid crystal exhibits a dielectric anisotropy (Δε) that is greater than 0. In embodiments, the negative liquid crystal and the positive liquid crystal are both organic molecules. In embodiments, the negative liquid crystal and the positive liquid crystal both lack fluorine as an atomic constituent. The lack of fluorine as an atomic constituent may render the liquid crystal layer 20 and thus the smart window article 10 more optimal from an environmental point of view. In embodiments, the negative liquid crystal is a nematic liquid crystal. In embodiments, the positive liquid crystal is or includes (at room temperature) a nematic liquid crystal, a smectic liquid crystal, or a dimeric mesogen. Suitable examples for the negative liquid crystal include HNG-715600-100 (HCCH, China) and MLC-2079 (Merck Chemical Company, Darmstadt, Germany), which are both nematic liquid crystals, and combinations thereof. The structure of the negative liquid crystal is not limited to those two that are listed. Suitable examples for the positive liquid crystal are or include one or more of 5CB (4-Cyano-4′-pentylbiphenyl, structure below, Hebei Maison Chemicals, China), 8CB (like 5CB but including an 8 carbon chain off the benzene instead of a 5 carbon chain, TCI Chemicals, Japan), CB5CB (structure below, University of Aberdeen, Scotland), CBnCB (where n=7, 9, or 11, structure same as CB5CB but including n-carbon chain instead of 5-carbon chain between the cyanobiphenyl groups, University of Aberdeen, Scotland), HTG-135200-100 (HCCH, China), BL006 (Merck Chemical Company), 80CB (structure below, Hebei, Maison Chemicals, China), E7 (a liquid crystal mixture, CAS 63748-28-7, HCCH, China), and MLC-6080 (Merck Chemical Company). HTG-135200-100 is a eutectic mixture which forms a nematic phase at room temperature and exhibits positive dielectric anisotropy.

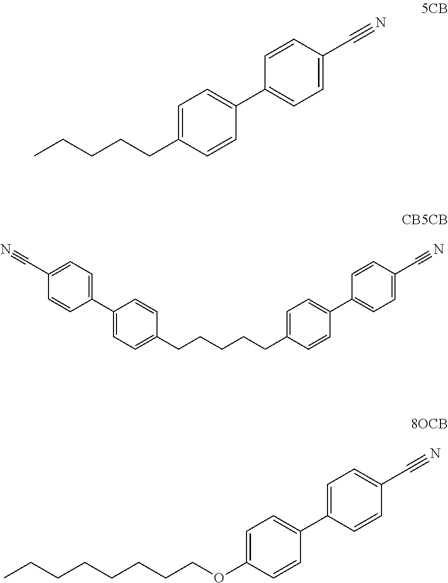 [SMILES: CCCCCc1ccc(-c2ccc(C#N)cc2)cc1 ; N#Cc1ccc(-c2ccc(CCCCCc3ccc(-c4ccc(C#N)cc4)cc3)cc2)cc1 ; CCCCCCCCOc1ccc(-c2ccc(C#N)cc2)cc1]

The structure of the positive liquid crystal is not limited to those that are listed. The positive liquid crystal can be a mixture of compounds, such as those forming the nematic phase at room temperature.

In embodiments, the liquid crystal layer 20 comprises, consists essentially of, or consists of, the negative liquid crystal and the positive liquid crystal. In embodiments, the liquid crystal layer 20 is substantially free of a polymer, such as those that may be found in PDLC and PNLC layers.

In other embodiments, the liquid crystal layer 20 further comprises a polymer. The polymer may be in the form of a polymer network. Suitable polymers include polyacrylates, polydiacrylates, polyurethanes, polyurethane acrylates, polyvinyl alcohols, polyvinyl acetates, poly(vinyl alcohol-co-vinyl acrylates), polyethylene, polypropylene, copolymers of any of the foregoing, or mixtures of any of the foregoing. The polymer may be prepared by polymerizing one or more monomers. Suitable monomers include acrylates, diacrylates, methacrylates, methyl methacrylates, urethanes, vinyl acetates, ethylene, and propylene. Examples of suitable photopolymerizable monomers include acrylic acid and methacrylic acid, esters thereof, each of which contains an alkyl group, an aryl group, or a cycloalkyl group including three or more carbon atoms, and halides thereof. Such photocurable monomers are, for example, isobutyl acrylate, stearyl acrylate, lauryl acrylate, isoamyl acrylate, 2-ethylhexyl acrylate, n-butyl methacrylate, n-lauryl methacrylate, tridecyl methacrylate, n-stearyl methacrylate, n-cyclohexyl methacrylate, benzyl methacrylate, isobornyl methacrylate, and 2-phenoxyethyl methacrylate. Polyfunctional compounds may also be used. Polyfunctional compounds are, for example, ethylene glycol dimethacrylate, bisphenol-A diacrylate, bisphenol-A dimethacrylate, 1,4-butanediol dimethacrylate, 1,6-hexanediol dimethacrylate, trimethylolpropane triacrylate, and tetramethylolmethane tetraacrylate. Such monomers and polyfunctional compounds may be used independently or in a combination of two or more. In embodiments, the monomer is a bi-functional monomer, a mono-functional monomer, or a mixture of bi-functional and mono-functional monomers.

In embodiments, a weight percentage of the polymer within the liquid crystal layer 20 is in a range of greater than or equal to 50 wt. %, based on the total weight of the liquid crystal layer 20. In such embodiments, the liquid crystals are dispersed within the polymer in the liquid crystal layer. In other embodiments, a weight percentage of the polymer within the liquid crystal layer 20 is in a range of 1 wt. % to 15 wt. %, or 3 wt. % to 10 wt. %, based on the total weight of the liquid crystal layer 20. In such embodiments, the polymer forms a cross-linked network within a continuous liquid crystal phase in the liquid crystal layer. In embodiments, a weight percentage of the polymer within the liquid crystal layer 20 is in a range of greater than 15 wt. % to less than 50 wt. %. In such embodiments, the liquid crystals may be dispersed within the polymer or the polymer may form a cross-linked network within a continuous liquid crystal phase, depending on the selection of the polymer and the liquid crystals. Without intending to be bound by theory, it is believed that as the weight percentage of the polymer within the liquid crystal layer 20 decreases below a threshold, e.g., below about 1 wt. %, then the polymer may not form a polymer network and/or be too brittle or weak to be of practical use in a PNLC. Further without intending to be bound by theory, it is believed that as the weight percentage of the polymer within the liquid crystal layer 20 increases, the haze of the liquid crystal layer generally increases in its clear state. The polymer may be formed by initiating the polymerization of the monomers within the liquid crystal layer 20. This can be done via UV polymerization, thermal polymerization, or other suitable method. In UV polymerization, exposing the mixture to ultraviolet light activates a photoinitiator, triggering polymerization. In thermal polymerization, heating the mixture can initiate polymerization if thermally activated monomers are used. Sufficient time allows the polymerization process to complete, ensuring the network is fully formed.

Without being bound by theory, it is thought that the combination of the positive liquid crystal and the negative liquid crystal within the liquid crystal layer 20 enhances turbulent scattering. Light scattering is observed when the negative liquid crystal is the host (e.g., has a higher concentration than the positive liquid crystal) within the liquid crystal layer 20. It is postulated that the positive liquid crystal molecules serve to disrupt the vortex motion of the negative liquid crystal molecules at the onset of the electrohydrodynamic (EHDI) effect, resulting in a chaotic state that scatters incident light. As will be further shown in the Examples that follow, by optimizing the concentration of the positive liquid crystal in the mixtures, a scattering mode in which the haze reaches up to >90% can be obtained while the transparent 0 V state remains essentially haze-free at all viewing angles.

The smart window article 10 may be based on electrohydrodynamic instabilities, resulting in a dynamic scattering mode without any additional ion doping, facilitated by mixing liquid crystal components of opposite dielectric properties. With the negative nematic liquid crystal as host, positive liquid crystal can be used so long as the resultant mixture is in the nematic phase. It is believed that a sort of microphase segregation, facilitated by the opposite dielectric anisotropy of the components in the mixture, results in the positive liquid crystal molecules disrupting the vortex motion of the negative nematic liquid crystal at the onset of the EHDI, consequently forming a dynamic scattering mode (DSM). At optimized positive liquid crystal concentrations, the haze of the DSM can be as high as 90% while the transparent state remains essentially haze-free (haze value <3% or even less than 1%) at all viewing angles, unlike polymer-doped systems (e.g., incorporating the layer of PDLC or PNLC mentioned in the Background). Effectively, it would be possible to achieve the DSM for any mixture in which an EHDI is formed by one of the components, and another component responds differently to the applied electric field.

Some relevant properties for suitable examples of the negative liquid crystal and the positive liquid crystal are set forth in Table 4 below.

TABLE 4

| Material | T_{K-X} (° C.) | T_{X-N} (° C.) | T_{N-I} (° C.) | Δε @ 1 kHz | Δn |
|---|---|---|---|---|---|
| HNG- | — | — | 88 | −12.2 | 0.15 (@589 nm) |
| 715600-100 | | | | | |
| MLC-2079 | — | — | 102 | −6.1 | 0.15 (@589 nm) |
| E7 | — | — | 58 | +13.8 | 0.22 (@589 nm) |
| HTG- | — | — | 98 | +99 | 0.205 (@633 nm) |
| 135200-100 | | | | | |
| BL006 | — | — | 113 | +17.3 | 0.30 (@589 nm) |
| MLC-6080 | — | — | 95 | +7.2 | 0.203 (@633 nm) |
| CB5CB | 150_{(K-NTB)} | (92)_{(NTB-N)} | (97) | ~+0.4 (@95° C.)* | 0.15 (@633 nm)* |
| CB7CB | 102_{(K-NTB)} | 103_{(NTB-N)} | 114 | ~+0.4 (@95° C.) | 0.15 (@633 nm) |
| CB9CB | 86_{(K-NTB)} | 108_{(NTB-N)} | 124 | ~+0.4 (@95° C.)* | 0.15 (@633 nm)* |
| CB11CB | 105_{(K-NTB)} | 109_{(NTB-N)} | 126 | ~+0.4 (@95° C.)* | 0.15 (@633 nm)* |
| 5CB | — | — | 35 | +13 | 0.16 (@589 nm) |
| MBBA | 20_{(K-N)} | | 47 | +0.6 | 0.32 (@633 nm) |
| 8CB | 21 | 33_{(SmA-N)} | 40 | +8.4 | 0.17 (@633 nm) |
| 80CB | 53 | 62_{(SmA-N)} | 80 | +10.9 | 0.18 (@632 nm) |

In the Table 4 above, “K-X” indicates transition from a crystalline phase to a mesophase, “X-N” is a transition from a mesophase to a nematic phase, and “N-I” is a transition from a nematic phase to an isotropic phase. “K-NTB” indicates transition from a crystalline phase to a nematic-twist-bend phase. “NTB-N” indicates transition from a nematic-twist-bend phase to a nematic phase. The asterisk in reference to the dimers denotes that the measurements are reported only for CB7CB but the optical and dielectric properties for the other dimers are assumed to be the same.

In embodiments, a weight percentage of the positive liquid crystal within the liquid crystal layer 20 is 6.0 wt %, 7.0 wt %, 8.0 wt %, 9.0 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, or within any range bound by any two of those values (e.g., from 6.0 wt % to 35 wt %, from 11 wt % to 28 wt %, and so on), based on the total weight of the positive liquid crystal and the negative liquid crystal. The weight percentage of the positive liquid crystal within the liquid crystal layer 20 can be less than 6.0 wt % or greater than 35 wt %, however.

In embodiments, a weight percentage of the negative liquid crystal within the liquid crystal layer 20 is within a range of from 65 wt % to 94 wt %, based on the total weight of the negative liquid crystal and the positive liquid crystal. For example, the weight percentage of the negative liquid crystal within the liquid crystal layer 20 can be 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, or within any range bound by any two of those values (e.g., from 70 wt % to 90 wt %, from 77 wt % to 92 wt %, and so on). The weight percentage of the negative liquid crystal within the liquid crystal layer 20 can be less than 65 wt % or greater than 94 wt %, however.

The liquid crystal layer 20 has an LC layer thickness 40. The LC layer thickness 40 is measured orthogonally to the first inward facing surface 22 of the first transparent substrate 12. The LC layer thickness 40 can be measured with a micrometer. Alternatively, an air gap of an empty cell can be derived from the interference pattern of a reflective spectrum. In embodiments, the LC layer thickness 40 is less than or equal to 10 μm or even less than or equal to 8 μm. For example, the LC layer thickness 40 can be 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, or within any range bound by any two of those values (e.g., from 2 μm to 20 μm, from 5 μm to 11 μm, and so on). The LC layer thickness 40 can be less than 2 μm or greater than 20 μm, however.

In embodiments, the liquid crystal layer 20 further includes a chiral dopant. When the chiral dopant is present, the liquid crystal layer 20 exhibits a chiral nematic phase at room temperature. In embodiments, a weight percentage of the chiral dopant within the liquid crystal layer 20 is sufficient to cause the liquid crystal layer 20 to exhibit a twist within a range of from 0.25 T (T meaning twist) to 1.25 T. For example, the angle that the liquid crystal layer 20 exhibits when the chiral dopant is present can be 0.25 T, 0.30 T, 0.40 T, 0.50 T, 0.60 T, 0.70 T, 0.75 T, 0.80 T, 0.90 T, 1.0 T, 1.1 T, 1.2 T, 1.25 T, or within any range bound by any of those values (e.g., from 0.25 T to 0.75 T, from 0.50 T to 1.25 T, and so on). Twist T may be equated with twist angle, with 1 T corresponding to a full twist rotation of 360 degrees (i.e., 271 radians). Examples of suitable molecules for the chiral dopant include CB-15 (structure below, chiral carbon noted with asterisk, HCCH, China) and R-811 (structure below, chiral carbon noted with asterisk, Merck, Germany), but that list is not exhaustive.

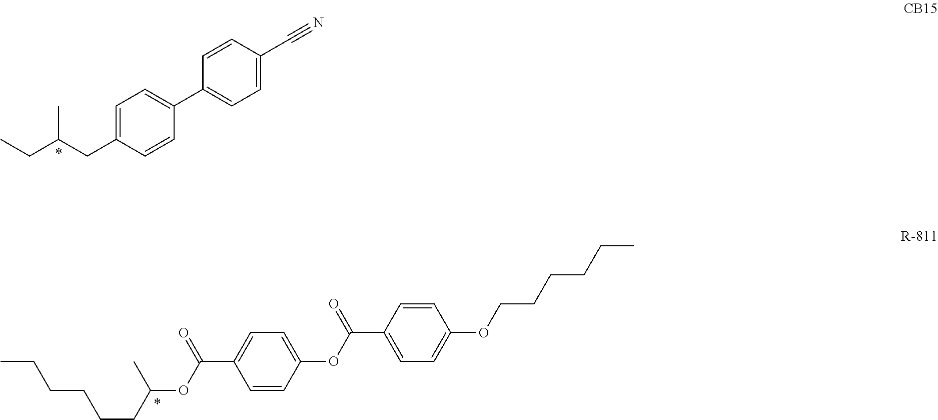 [SMILES: CCC(C)Cc1ccc(-c2ccc(C#N)cc2)cc1 ; CCCCCCOc1ccc(C(=O)Oc2ccc(C(=O)OC(C)CCCCCC)cc2)cc1]

In embodiments, the liquid crystal layer 20 further includes a dichroic dye. An example of a suitable dichroic dye is M1012 (available from Mitsui Chemicals, Tokyo, Japan). Other dichroic dyes are envisioned. In embodiments, a weight percentage of the dichroic dye within the liquid crystal layer 20 is within a range of from 0.2 wt % to 3.5 wt %, based on the total weight of the dichroic dye, negative liquid crystal, and positive liquid crystal. For example, the weight percentage of the dichroic dye can be 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, or within any range bound by any two of those values (e.g., from 0.5 wt % to 2.0 wt %, from 1.0 wt % to 2.5 wt %, and so on). The weight percentage of the dichroic dye can be less than 0.2 wt % or greater than 3.5 wt %, however.

In embodiments, the smart window article 10 further includes a first alignment layer 42 and a second alignment layer 44. In such embodiments, the first alignment layer 42 is disposed on the first transparent electrode layer 16 and the second alignment layer 44 is disposed on the second transparent electrode layer 18. The second alignment layer 44 opposes the first alignment layer 42. The liquid crystal layer 20 is sandwiched between, and contacts each of, the first alignment layer 42 and the second alignment layer 44. In some instances, the first alignment layer 42 and the second alignment layer 44 provide parallel alignment of molecules of the negative liquid crystal and the positive liquid crystal contacting the first alignment layer 42 and the second alignment layer 44. Parallel alignment as used here means alignment of molecules parallel to first alignment layer 42 and the second alignment layer 44. In other instances, the first alignment layer 42 and the second alignment layer 44 provide vertical alignment of molecules of the negative liquid crystal and the positive liquid crystal contacting the first alignment layer 42 and the second alignment layer 44. Vertical alignment here means alignment of molecules orthogonal to the first alignment layer 42 and the second alignment layer 44. The first alignment layer 42 and the second alignment layer 44 are manipulated, such as by rubbing or exposure to directional UV light, to induce a small tilt or pretilt angle in the parallel or vertical alignment as desired. The tilt or pretilt angle is typically less than 10, 5, or 2 degrees. In embodiments, the first alignment layer 42 and the second alignment layer 44 each comprise a polyimide. However, other compositions are envisioned. In other instances, the first alignment layer 42 and the second alignment layer 44 may provide different alignment, that is, one being vertical alignment while the other being parallel alignment.

The smart window article 10 has a total thickness 46. The total thickness 46 is the shortest straight-line distance between the first outward facing surface 24 of the first transparent substrate 12 and the second outward facing surface 30 of the second transparent substrate 14, with the straight-line extending through the liquid crystal layer 20. The total thickness 46 can be measured with a micrometer. The total thickness 46 refers to the total thickness of the two substrates and anything in-between (e.g., alignment layers, electrode layers, and liquid crystal layer), and does not include the thickness of one or more additional outer panes (e.g., tempered glass) that the smart window article 10 may be incorporated with in an insulated glass unit. In embodiments, the total thickness 46 is less than or equal to 1.0 mm, less than or equal to 0.5 mm, less than or equal to 0.4 mm, or even less than or equal to 0.2 mm. For example, the total thickness 46 can be 0.15 mm, 0.20 mm, 0.30 mm, 0.40 mm, 0.50 mm, 0.60 mm, 0.70 mm, 0.75 mm, 0.80 mm, 0.90 mm, 1.0 mm, 1.1 mm, or within any range bound by any two of those values (e.g., from 0.15 mm to 0.75 mm, from 0.20 mm to 0.50 mm, from 0.15 to 1.1 mm, and so on).

The smart window article 10 is operable to, from, and between a first voltage state 48 and a second voltage state 50. During the second voltage state 50, the smart window article 10 subjects the liquid crystal layer 20 to a working voltage that is greater than a voltage, if any, to which the liquid crystal layer 20 is subjected during the first voltage state 48. During the first voltage state 48, the voltage to which the liquid crystal layer 20 is subjected can be no voltage (a value of 0 V). An electrical circuit 52 otherwise connecting the first transparent electrode layer 16 to the second transparent electrode layer 18 can be open during the first voltage state 48. During the second voltage state 50, the working voltage to which the liquid crystal layer 20 is subjected is increased relative to the first voltage state 48.

The working voltage during the second voltage state 50 causes a change in the transmittance and haze that the smart window article 10 exhibits compared to the first voltage state 48. More particularly, during the first voltage state 48, the smart window article 10 exhibits a haze of less than 20%. In embodiments, during the first voltage state 48, the smart window article 10 exhibits a transmittance of greater than 50%. The first voltage state 48 may be referred to herein as a clear state or a no voltage state. In embodiments, during the first voltage state 48, the transmittance that the smart window article 10 exhibits is greater than or equal to 20%, greater than or equal to 30%, greater than or equal to 40%, greater than or equal to 50%, greater than or equal to 60%, greater than or equal to 70%, greater than or equal to 80%, or even greater than or equal to 85%. For example, the transmittance that the smart window article 10 exhibits during the first voltage state 48 can be 20%, 25%, 30%, 35%, 40%, 45%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, about 90%, 91%, 92%, or within any range bound by any two of those values (e.g., from 20% to 92%, from 50% to 92%, from 80% to 91%, and so on). To determine transmittance that the smart window article 10 exhibits, an Ocean Optics USB4000 UV-Vis spectrometer equipped with an LS-1 tungsten halogen light source can be used to measure the transmission of the fabricated cells as a function of applied voltage (or without any voltage applied). The smart window article 10 is placed at a distance of about 10 cm from the light source and about 5 cm from the detector.

In embodiments, during the first voltage state 48, the haze that the smart window article 10 exhibits is less than or equal to 20%, less than or equal to 10%, less than or equal to 5%, less than or equal to 3%, less than or equal to 1%, or even less than or equal to 0.5%. For example, the haze that the smart window article 10 exhibits during the first voltage state 48 can be 20%, 19%, 18%, 17%, 16%, 15%, 14%, 13%, 12%, 11%, 10%, 9%, 8%, 7%, 6%, 5%, 4%, 3%, 2%, 1%, about 1%, 0.9%, 0.8%, 0.7%, 0.6%, 0.5%, 0.4%, 0.3%, 0.2%, 0.1%, or within any range bound by any two of those values (e.g., from 0.1% to 20%, from 0.1% to 3.0%, and soon). To determine the haze that the smart window article 10 exhibits as a function of applied voltage (including no voltage), a Shimadzu UV-3600 Plus UV-Vis spectrometer equipped with an integrating sphere can be used. In this measurement, haze (H) is defined by the ratio of diffuse transmittance, Td, to the total transmittance, Tt:

$$H = \frac{{T}_{d}}{{T}_{t}} \times 100 \%$$

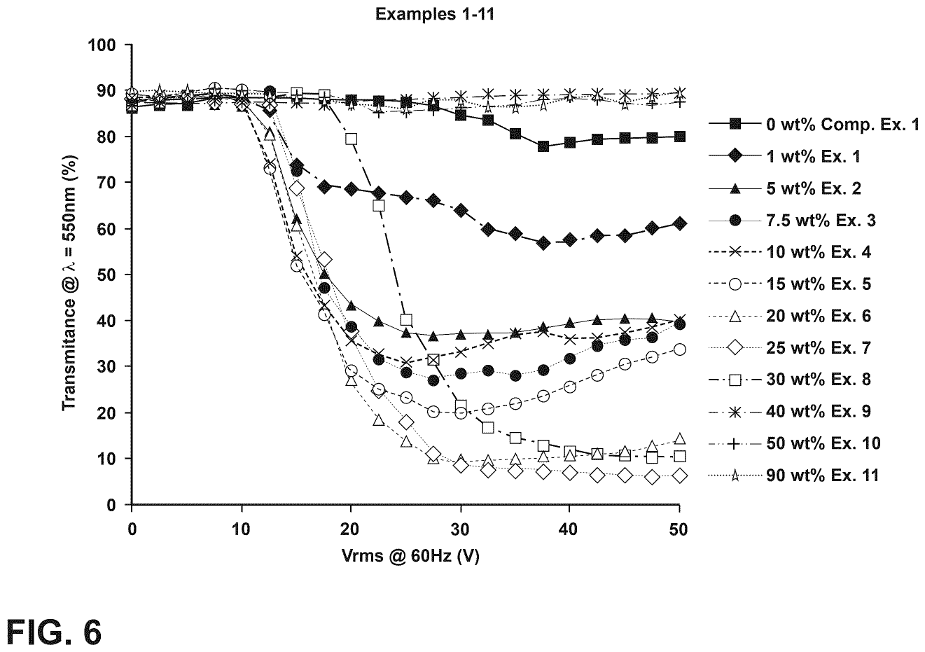

T_{d} is obtained from:

$${T}_{d} = {T}_{4} - ( \frac{{T}_{3} \times {T}_{t}}{100} )$$

where T₃ is the instrument diffusion and T₄ is the sample diffusion. Whereas T₃ is measured only once, T₄ and Tt are measured for each value of applied voltage. The plots of haze as a function of voltage (H-V curves), as set forth in the graphs of FIGS. 6-47, are at the wavelength λ=550 nm. All transmittance and haze measurements are measured under ambient conditions.

However, during the second voltage state 50, the smart window article 10 exhibits a haze of greater than or equal to 70%, greater than or equal to 80%, greater than or equal to 90%, or even greater than or equal to 97%. For example, the haze that the smart window article 10 exhibits during the second voltage state 50 can be 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or within any range bound by any two of those values (e.g., from 70% to 97%, from 71% to 85%, and so on). The second voltage state 50 may be referred to herein as the privacy state or hazy state.

The working voltage during the second voltage state 50 is less than or equal to 55 V. In embodiments, the working voltage during the second voltage state 50 is less than or equal to 41 V, less than or equal to 31 V, or even less than or equal to 24 V. In embodiments, the working voltage during the second voltage state 50 is 20 V, 21 V, 22 V, 23 V, 24 V, 25 V, 26 V, 27 V, 28 V, 29 V, 30 V, 31 V, 32 V, 33 V, 34 V, 35 V, 36 V, 37 V, 38 V, 39 V, 40 V, 41 V, 42 V, 43 V, 44 V, 45 V, 46 V, 47 V, 48 V, 49 V, 50 V, 51 V, 52 V, 53 V, 54 V, 55 V, or within any range bound by any two of those values (e.g., from 20 V to 55 V, from 21 V to 47 V, from 20 V to 28 V, and so on). The working voltage of 55 V is suitable for both a system including a polymer in the liquid crystal layer 20 and a system that does not include a polymer in the liquid crystal layer 20. When determining transmittance or haze as a function of voltage applied, the smart window article 10 can be driven by applying a square wave AC voltage of 60 Hz, using an HP-33120 A waveform generator connected to a voltage amplifier (F10A), with the voltage continuously applied in the ON state. All voltage values provided herein are root mean square voltage.

In embodiments, the smart window article 10 is operable to and from a third voltage state. During the third voltage state, the working voltage to which the liquid crystal layer 20 is subjected is less than the working voltage to which the liquid crystal layer 20 is subjected during the second voltage state 50. However, during the third voltage state, the working voltage to which the liquid crystal layer 20 is subjected is greater than the working voltage to which the liquid crystal layer 20 is subjected during the first voltage state 48. The third voltage state can be thought of as an intermediate voltage state (in terms of working voltage) between the first voltage state 48 and the second voltage state 50. During the third voltage state, the transmittance that the smart window article 20 exhibits is (i) lower than the transmittance that the smart window article 10 exhibits during the first voltage state 48 and (ii) higher than the transmittance that the smart window article 10 exhibits during the second voltage state 50. However, during the third voltage state, the haze that the smart window article 10 exhibits is (i) similar to the haze that the smart window article 10 exhibits during the first voltage state 48 and (ii) lower than the haze that the smart window article 10 exhibits during the second voltage state 50. “Similar” here means less than or equal to 5%. For example, if the haze that the smart window article 10 exhibits during the first voltage state 48 is 0.5%, then to be “similar,” the haze that the smart glass window 10 exhibits during the third voltage state would be 5.5% or less (5.5%−0.5%=5.0%). In embodiments, the difference in haze that the smart window article 10 exhibits between the first voltage state 48 and the third voltage state is 0%, 0.1%, 0.5%, 1.0%, 2.0%, 3.0%, 4.0%, 5.0%, or within any range bound between any two of those values (e.g., from 0% to 5%, from 0% to 1.0%, and so on). In short, the working voltage can be manipulated in some embodiments so that the smart window article 20 exhibits a decrease in transparency without much commensurate increase in haze. The increase in haze (and further decrease in transmittance) can be achieved with further increase in working voltage from the third voltage state to the second voltage state 50.

In embodiments, the liquid crystal layer 20 is substantially free of, or free of, ions. Unlike other dynamic scattering materials actively doped with a substantial amount of ions, in some embodiments, the liquid crystal layer 20 of the present disclosure does not need to be additionally doped with ions.

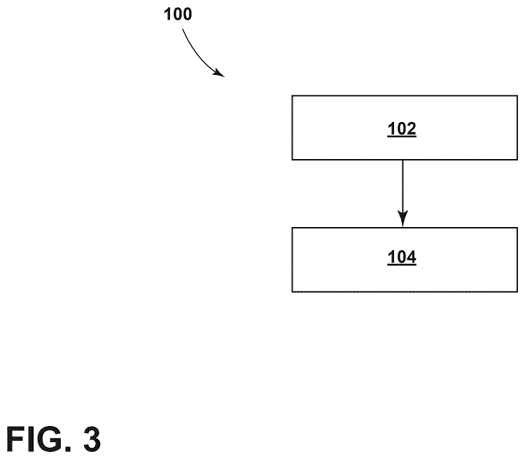

Referring now to FIG. 3, a method 100 of operating the smart window article 10 is herein described. The method 100 includes a voltage increase step 102. The voltage increase step 102 includes applying the working voltage of less than or equal to 55 V to the first transparent electrode layer 16 and the second transparent electrode layer 18. The application of the working voltage to the first transparent electrode layer 16 and the second transparent electrode layer 18 subjects the liquid crystal layer 20 to the working voltage and induces a change in haze and/or transparency that the smart window article 10 exhibits. The application of the working voltage to the first transparent electrode layer 16 and the second transparent electrode layer 18 causes the smart window article 10 to transition from the first voltage state 48 to the second voltage state 50.

In embodiments, the method 100 further includes a voltage decrease step 104 comprising applying a voltage that is less than the working voltage (e.g., 0 V or opening the electrical circuit 52) to the to the first transparent electrode layer 16 and the second transparent electrode layer 18. The liquid crystal layer 20 is no longer subjected to the working voltage. The haze that the smart glass window exhibits decreases, in embodiments, to a minimum haze that the smart glass window can exhibit.

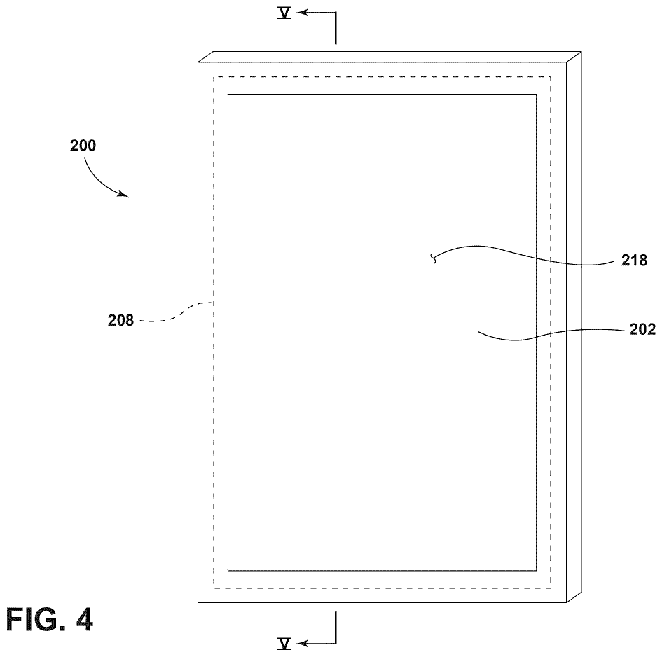

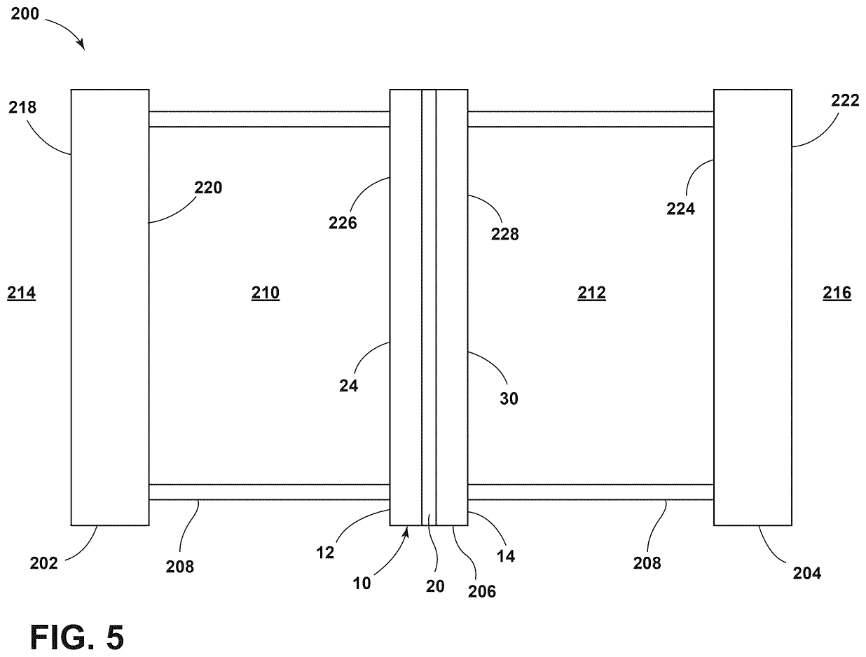

Referring now to FIGS. 4 and 5, an insulated glass unit (IGU) 200 incorporating the smart window article 10 is herein disclosed. The IGU 200 includes a first outer pane 202 and a second outer pane 204 and at least one spacer element 208. The IGU can further include an inner pane 206 disposed between the first outer pane 202 and the second outer pane 204. The at least one spacer element 208 defines a first space 210. When no inner pane 206 is included, the first space 210 is between the first outer pane 202 and the second outer pane 204. When the inner pane 206 is included, the at least one spacer element 208 further defines a second space 212, the first space 210 is between the first outer pane 202 and the inner pane 206, and the second space 212 is between the inner pane 206 and the second outer pane 204. At least one of the first outer pane 202, the second outer pane 204, and the inner pane 206 (if included) comprises the smart window article 10 of the present disclosure. In embodiments, the inner pane 206 is included, and is or comprises the smart window article 10.

In use, either the first outer pane 202 or the second outer pane 204 faces an external environment 214 (e.g., outside, such as of a room or of a building), while the other of the first outer pane 202 and the second outer pane 204 faces an internal environment 216 (e.g., inside). The first outer pane 202 and the second outer pane 204 are sheet-like in dimensions. The first outer pane 202 includes an outward primary surface 218 positioned to face away from the second outer pane 204 and an inward primary surface 220 positioned to face toward the second outer pane 204. Similarly, the second outer pane 204 includes an outward primary surface 222 positioned to face away from the first outer pane 202 and an inward primary surface 224 positioned to face the first outer pane 202. The inner pane 206 includes a first primary surface 226 (e.g., the first outward facing surface 24 of the first transparent substrate 12) positioned to face the first outer pane 202 and a second primary surface 228 (e.g., the second outward facing surface 30 of the second transparent substrate 14) positioned to face the second outer pane 204. The outward primary surfaces 218, 222, the inward primary surfaces 220, 224, the first primary surface 226, and the second primary surface 228 are planar to the extent possible within manufacturing capabilities and parallel to each other.

In embodiments, one or more of the first space 210 and the second space 212 is filled with a gas, such as a noble gas (e.g., Ar, Kr, Xe) or air. Filling the first space 210 and the second space 212 with a gas can reduce conductive heat transfer through the IGU 200 because of the low thermal conductivity of the gas, as well as improve acoustic insulation due to their increased atomic weights. In other embodiments, the first space 210 and the second space 212 are evacuated to have a pressure that is lower than atmospheric pressure. In other embodiments, one or more of the first space 210 and the second space 212 is a bonding material, such as ethylene-vinyl acetate (EVA) or polyvinyl butyral (PVB).

In embodiments, the first outer pane 202 and the second outer pane 204 each have a glass composition, which can be the same or different from each other. Suitable glass compositions are described above. One or both of the first outer pane 202 and the second outer pane 204 can be made by a float manufacturing process or a fusion draw manufacturing process, among other options. One or both of the first outer pane 202 and the second outer pane 204 can be chemically strengthened (e.g., subjected to ion-exchange) or thermally tempered. In embodiments, at least one of the inward primary surface 220 of the first outer pane 202 and the inward primary surface 224 of the second outer pane 204 can be coated with at least one low emissivity coating. Low emissivity coatings are known in the art and may include, without limitation, sputter-coated and pyrolytic coatings that include, for example, one or more metals and/or metal oxides such as silver, titanium, and fluorine-doped tin oxide, to name a few.

The smart window article 10 can be used for several other related applications such as light shutters/valves, transparent displays, phase gratings, among others. The smart window article 10 avoids shortcomings such as increased device power consumption, reduced long-term stability, and heating, typically associated with DSM devices that require ion-doping.

The smart window article 10 of the present disclosure addresses the problems set forth in the Background in a variety of ways. First, while a conventional layer of PDLC or PNLC might have a layer thickness of about 100 μm, the LC layer thickness 40 of the liquid crystal layer 20 is less than or equal to 20 μm and even as thin as less than or equal to 8 μm. Such a thin LC layer thickness 40 opens applications for the smart window article 10 that would not be available to articles incorporating the thicker layer of PDLC or PNLC, such as the IGU 200. Such a thin LC layer thickness allows the fabrication of the smart window article with well-established one-dropping filing method. Second, while the layer of conventional PDLC or PNLC typically requires being subjected to a working voltage of greater than 48 V, the working voltage for the liquid crystal layer 20 can be less than 48 V, even less than or equal to 24 V, which permits the smart window article 10 to include a Class 2 circuit under the NEC instead of a Class 3 circuit. Third, the smart window article 10 may be clearer (e.g., higher transmittance and lower haze) in the clear state (first voltage state 48) than similar articles relying on a conventional layer of PDLC or PNLC.

Various aspects of the disclosure are described below.

Aspect 1. A smart window article comprising a first transparent substrate comprising a first inward facing surface and a first outward facing surface; a second transparent substrate comprising a second inward facing surface and a second outward facing surface, the second inward facing surface opposing the first inward facing surface; a first transparent electrode layer disposed on the first inward facing surface of the first transparent substrate; a second transparent electrode layer disposed on the second inward facing surface of the second transparent substrate; and a liquid crystal layer sandwiched between the first transparent electrode layer and the second transparent electrode layer, the liquid crystal layer comprising: a negative liquid crystal that exhibits a dielectric anisotropy (Δε) that is less than 0; and a positive liquid crystal that exhibits a dielectric anisotropy (Δε) that is greater than 0, wherein, the smart window article is operable to, from, and between (i) a first voltage state and (ii) a second voltage state during which the smart window article subjects the liquid crystal layer to a working voltage that is greater than a voltage to which the liquid crystal layer is subjected during the first voltage state, wherein, during the first voltage state, the smart window article exhibits a haze of less than or equal to 20%, wherein, during the second voltage state, the smart window article exhibits a haze of greater than or equal to 70%, and wherein, the working voltage during the second voltage state is less than or equal to 55 V.

Aspect 2. The smart window article of aspect 1, wherein the first transparent substrate and second transparent substrate each individually comprise glass, glass-ceramic, or plastic.

Aspect 3. The smart window article of aspect 1 or aspect 2, wherein the liquid crystal layer further comprises a polymer.

Aspect 4. The smart window article of aspect 3, wherein the polymer comprises a polyacrylate, a diacrylate, a polyurethane, a polyurethane acrylate, a polyvinyl alcohol, a polyvinyl acetate, a poly(vinyl alcohol-co-vinyl acrylate), polyethylene, polypropylene, copolymers of any of the foregoing, or mixtures of any of the foregoing.

Aspect 5. The smart window article of aspect 3 or aspect 4, wherein the polymer is prepared by polymerizing one or more monomers selected from the group consisting of acrylate, diacrylate, methacrylate, methyl methacrylate, urethane, vinyl acetate, ethylene, and propylene.

Aspect 6. The smart window article of any one of aspects 3 to 5, wherein a weight percentage of the polymer within the liquid crystal layer is in a range of greater than or equal to 50 wt. %, based on the total weight of the liquid crystal layer.

Aspect 7. The smart window article of any one of aspects 3 to 5, wherein a weight percentage of the polymer within the liquid crystal layer is in a range of 1 wt. % to 15 wt. %, based on the total weight of the liquid crystal layer.

Aspect 8. The smart window article of aspect 7, wherein the weight percentage of the polymer within the liquid crystal layer is in a range of 3 wt. % to 10 wt. %, based on the total weight of the liquid crystal layer.

Aspect 9. The smart window article of aspect 1 or aspect 2, wherein the liquid crystal layer is substantially free of a polymer.

Aspect 10. The smart window article of any one of aspects 1 to 6, wherein during the first voltage state, the smart window article exhibits a transmittance of greater than or equal to 20%.

Aspect 11. The smart window article of any one of aspects 1 to 5 or 7 to 10, wherein during the first voltage state, the smart window article exhibits a transmittance of greater than or equal to 50%.

Aspect 12. The smart window article of aspect 11, wherein during the first voltage state, the transmittance that the smart window article exhibits is greater than or equal to 60%.

Aspect 13. The smart window article of aspect 11, wherein during the first voltage state, the transmittance that the smart window article exhibits is greater than or equal to 70%.

Aspect 14. The smart window article of aspect 11, wherein during the first voltage state, the transmittance that the smart window article exhibits is greater than or equal to 80%.

Aspect 15. The smart window article of aspect 11, wherein during the first voltage state, the transmittance that the smart window article exhibits is greater than or equal to 85%.

Aspect 16. The smart window article of any one of aspects 1-15, wherein the first transparent electrode layer and the second transparent electrode layer each comprise a transparent conductive oxide.

Aspect 17. The smart window article of any one of aspects 1-16, wherein the negative liquid crystal and the positive liquid crystal are both organic molecules that lack fluorine as an atomic constituent.

Aspect 18. The smart window article of any one of aspects 1-17, wherein the positive liquid crystal comprises a nematic liquid crystal, a smectic liquid crystal, or a dimeric mesogen.

Aspect 19. The smart window article of any one of aspects 1-18, wherein the negative liquid crystal comprises a nematic liquid crystal, or one or more of HNG-715600-100 and MLC-2079.

Aspect 20. The smart window article of any one of aspects 1-19, wherein the positive liquid crystal comprises one or more of 5CB, 8CB, CB5CB, HTG-135200-100, BL006, 8OCB, E7, and MLC-6080.

Aspect 21. The smart window article of any one of aspects 1-20, wherein a weight percentage of the positive liquid crystal within the liquid crystal layer is within a range of from 6.0 wt % to 35 wt %, based on the total weight of the positive liquid crystal and the negative liquid crystal.

Aspect 22. The smart window article of any one of aspects 1-21, wherein the liquid crystal layer has a LC layer thickness that is within a range of from 2 μm to 20 μm.

Aspect 23. The smart window article of any one of aspects 1-22, wherein the liquid crystal layer has a layer thickness that is less than or equal to 10 μm.

Aspect 24. The smart window article of any one of aspects 1-23, wherein the liquid crystal layer has a layer thickness that is less than or equal to 8 μm.

Aspect 25. The smart window article of any one of aspects 1-24, wherein the liquid crystal layer further comprises a chiral dopant, and the liquid crystal layer exhibits a chiral nematic phase at room temperature.

Aspect 26. The smart window article of any one of aspects 1-25, wherein a weight percentage of the chiral dopant within the liquid crystal is sufficient to cause the liquid crystal to exhibit a twist within a range of from 0.25 T to 1.25 T.

Aspect 27. The smart window article of any one of aspects 1-26, wherein the liquid crystal layer further comprises a dichroic dye.

Aspect 28. The smart window article of aspect 27, wherein a weight percentage of the dichroic dye within the liquid crystal layer is within a range of from 0.2 wt % to 3.5 wt %.

Aspect 29. The smart window article of any one of aspects 1-28 further comprising a first alignment layer disposed on the first transparent electrode; and a second alignment layer disposed on the second transparent electrode and opposing the first alignment layer, wherein, the liquid crystal layer is sandwiched between and contacting the first alignment layer and the second alignment layer.

Aspect 30. The smart window article of aspect 29, wherein the first alignment layer and the second alignment layer provide parallel alignment of molecules of the negative liquid crystal and the positive liquid crystal contacting the first alignment layer and the second alignment layer.

Aspect 31. The smart window article of aspect 29, wherein the first alignment layer and the second alignment layer provide vertical alignment of molecules of the negative liquid crystal and the positive liquid crystal contacting the first alignment layer and the second alignment layer.

Aspect 32. The smart window article of any one of aspects 29-31, wherein the first alignment layer and the second alignment layer each comprise a polyimide.

Aspect 33. The smart window article of any one of aspects 1-32 further comprising: a total thickness that is less than or equal to 0.50 mm.

Aspect 34. The smart window article of any one of aspects 1-32 further comprising: a total thickness that is less than or equal to 0.70 mm.

Aspect 35. The smart window article of any one of aspects 1-32 further comprising: a total thickness that is less than or equal to 1.1 mm.

Aspect 36. The smart window article of any one of aspects 1-32 further comprising: a total thickness that is within a range of from 0.15 mm to 1.1 mm.

Aspect 37. The smart window article of any one of aspects 1-36, wherein during the first voltage state, the haze that the smart window article exhibits is less than or equal to 3%.

Aspect 38. The smart window article of any one of aspects 1-36, wherein during the first voltage state, the haze that the smart window article exhibits is less than or equal to 1%.

Aspect 39. The smart window article of any one of aspects 1-36, wherein during the first voltage state, the haze that the smart window article exhibits is less than or equal to 0.5%.

Aspect 40. The smart window article of any one of aspects 1-39, wherein during the second voltage state, the haze that the smart window article exhibits is greater than or equal to 80%.

Aspect 41. The smart window article of any one of aspects 1-39, wherein during the second voltage state, the haze that the smart window article exhibits is greater than or equal to 90%.

Aspect 42. The smart window article of any one of aspects 1-39, wherein during the second voltage state, the haze that the smart window article exhibits is greater than or equal to 97%.

Aspect 43. The smart window article of any one of aspects 1-42, wherein the working voltage during the second voltage state is less than or equal to 41 V.

Aspect 44. The smart window article of any one of aspects 1-42, wherein the working voltage during the second voltage state is less than or equal to 31 V.

Aspect 45. The smart window article of any one of aspects 1-42, wherein the working voltage during the second voltage state is within a range of from 20 V to 28 V.

Aspect 46. The smart window article of any one of aspects 1-45, wherein the smart window article is operable at a third voltage state, wherein the working voltage during the third voltage state is less than the working voltage during the second voltage state and greater than or equal to the working voltage during the first voltage state, and during the third voltage state, the transmittance that the smart window article exhibits is (i) lower than the transmittance that the smart window article exhibits during the first voltage state and (ii) higher than the transmittance that the smart window article exhibits during the second voltage state.

Aspect 47. The smart window article of aspect 46, wherein during the third voltage state, the haze that the smart window article exhibits is (i) similar to the haze that the smart window article exhibits during the first voltage state and (ii) lower than the haze that the smart window article exhibits during the second voltage state.

Aspect 48. A method of operating the smart window article of any one of aspects 1-47 comprising: a privacy transition step comprising applying a working voltage of less than or equal to 55 V to the first transparent electrode layer and the second transparent electrode layer, thereby causing the smart window article to transition from the first voltage state to the second voltage state.

Aspect 49. An insulated glass unit comprising a first outer pane; a second outer pane; and at least one spacer element defining a space between the first outer pane and the second outer pane; wherein at least one of the first outer pane and the second outer pane comprises the smart window article of any one of aspects 1-47.

Aspect 50. An insulated glass unit comprising a first outer pane; a second outer pane; an inner pane disposed between the first outer pane and the second outer pane; and at least one spacer element further defines (i) a first space between the first outer pane and the inner pane and (ii) a second space between the inner pane and the second outer pane, wherein at least one of the first outer pane, the second outer pane, and the inner pane comprises the smart window article of any one of aspects 1-47.

Aspect 51. The insulated glass unit of aspect 50, wherein the inner pane comprises the smart window article of any one of aspects 1-47.

### Examples

Comparative Examples 1-4—For each of these comparative examples, two transparent glass substrates were obtained. Each of the two transparent glass substrates were coated on a primary surface thereof with an electrode layer. The electrode layer was made of ITO. Two sets of the transparent glass substrates with the ITO electrode layer were designated for vertical alignment of molecules of a yet to be added liquid crystal layer. The other two sets were designated for parallel alignment.

The ITO surface of the substrates designated for vertical alignment was spun-coated with a polyimide PI-5611 (Nissan Chemical Corporation, Tokyo, Japan). The polyimide-coated substrates were then baked and rubbed two times to form an alignment layer intended to induce vertical alignment of molecules of the yet to be added liquid crystal layer. To form a precursor to a smart window article, pairs of the substrate were assembled with the rubbing directions of the alignment layer anti-parallel to each other. Anti-parallel here means that the rubbing direction of one alignment layer is 180 degrees from the rubbing direction of the other alignment layer. Silica spacer fibers were added between the pair of substrates to define a nominal cell gap of 10 μm.

The ITO surface of the substrates designated for parallel alignment was spun-coated with a polyimide PI-2170 (Nissan Chemical Corporation, Tokyo, Japan). The polyimide-coated substrates were then baked and rubbed ten times to form an alignment layer intended to induce parallel alignment of molecules of the yet to be added liquid crystal layer. To form a precursor to a smart window article, pairs of the substrate were assembled with the rubbing directions of the alignment layer anti-parallel to each other. Silica spacer fibers were added between the pair of substrates to define a nominal cell gap of 10 μm.

A liquid crystal layer was introduced into the nominal cell gap of each of the four precursor smart window articles using capillary action at an elevated temperature (either 40° C. for Comparative Examples 2 and 3 or 90° C. for Comparative Examples 1 and 4). A negative liquid crystal, specifically HNG-715600-100 (Δn=0.153, Δε≈−12.2, HCCH, China), was added to one of the precursor articles intended to induce vertical alignment and one of the precursor articles intended to induce parallel alignment, thus forming two smart window articles. A positive single compound nematic liquid crystal, specifically 4-pentyl-4′-cyanobiphenyl, 5CB (Δn=0.138, Δε≈+13, HCCH, China), was added to one of the precursor articles intended to induce vertical alignment and one of the precursor articles intended to induce parallel alignment, thus forming two smart window articles. Thus, four smart window articles were formed, with the liquid crystal layer having either a positive liquid crystal or a negative liquid crystal but not a combination of the two. Table 5 below summarizes the four smart window articles formed representing Comparative Examples 1-4. None of the liquid crystal layers include a chiral dopant or a dichroic dye.

TABLE 5

| Comp. Ex. | Alignment | Neg. LC | Pos. LC | T(0 V) | H(0 V) | Vₒₙ | | T(Vₒₙ) | H(Vₒₙ) |
|---|---|---|---|---|---|---|---|---|---|
| 1 | Vertical | HNG- | None | ~90% | <1% | 37.5 | V | ~80% | <20% |
| | | 715600- | | | | | | | |
| | | 100 | | | | | | | |
| 2 | Parallel | None | CB5 | ~90% | <1% | 50 | V | ~90% | <3% |
| 3 | Vertical | None | CB5 | ~90% | <1% | 50 | V | ~90% | <3% |
| 4 | Parallel | HNG- | No | ~90% | <1% | 37.5 | V | ~70% | <20% |
| | | 715600- | | | | | | | |
| | | 100 | | | | | | | |

The transmittance (“T(0V)”) and haze (“H(0V)”) through each of the smart window articles without any voltage applied across the liquid crystal layer were determined. All the smart window articles exhibited a transmittance of about 90% and a haze of less than 1%.

A working voltage (“Von”) was then applied to each of the four smart window articles, which subjected the liquid crystal layer thereof to the working voltage. The working voltage applied was either 37.5 V or 50 V, as set forth in the table above.

The transmittance (“T(Von)”) and haze (“H(Von)”) through each of the smart window articles with the working voltage applied across the liquid crystal layer were determined. Despite the relatively high working voltages, the transmittance that each of the smart window articles exhibited changed only a relatively small amount—the largest change was Comparative Example 4 with about a 20% decrease in transmittance. The transmittance that Comparative Examples 2 and 3 exhibited did not exhibit a measurable change. Similarly, despite the relatively high working voltages, the haze that each of the smart window articles exhibited changed only a relatively small amount—the largest changes were Comparative Examples 1 and 4 with about a 17% increase in haze up to about 20% haze. A haze of 20% would be inadequate for many applications, such as a privacy window.

Examples 1-15—For Examples 1-15, smart window articles were fabricated similar to those of the Comparative Examples above. However, the polyimide alignment layers of each of the smart window articles were rubbed to induce vertical alignment of molecules of the liquid crystal layer. In addition, the liquid crystal layer was a combination of the negative nematic liquid crystal HNG-715600-100 and positive nematic liquid crystal 5CB. The weight percentage of the positive liquid crystal in the liquid crystal layer varied, as indicated in Table 6 below. The negative liquid crystal was the balance of the liquid crystal layer. No separate polymeric material was included in the liquid crystal layer. No chiral dopant or dichroic dye was included in the liquid crystal layer. The liquid crystal layer was added for these and all remaining examples here via capillary action at 90° C.

TABLE 6

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 1 | Vertical | HNG- | 5CB | ~90% | <1% | 30 V | 57% | <40% |
| | | 715600- | 1% | | | | | |
| | | 100 | | | | | | |
| 2 | Vertical | HNG- | 5CB | ~90% | 0.4% | 30 V | 37% | 44% |
| | | 715600- | 5% | | | | | |
| | | 100 | | | | | | |
| 3 | Vertical | HNG- | 5CB | ~90% | 0.4% | 30 V | 27% | 51% |
| | | 715600- | 7.5% | | | | | |
| | | 100 | | | | | | |
| 4 | Vertical | HNG- | 5CB | ~90% | 0.3% | 30 V | 33% | 49% |
| | | 715600- | 10% | | | | | |
| | | 100 | | | | | | |
| 5 | Vertical | HNG- | 5CB | ~90% | 0.4% | 30 V | 20% | 72% |
| | | 715600- | 15% | | | | | |
| | | 100 | | | | | | |
| 6 | Vertical | HNG- | 5CB | ~90% | 0.2% | 25 V | 14% | 78% |
| | | 715600- | 20% | | | | | |
| | | 100 | | | | | | |
| 7 | Vertical | HNG- | 5CB | ~90% | 0.2% | 30 V | 9% | 80% |
| | | 715600- | 20% | | | | | |
| | | 100 | | | | | | |
| 8 | Vertical | HNG- | 5CB | ~90% | 0.6% | 30 V | 18% | 76% |
| | | 715600- | 25% | | | | | |
| | | 100 | | | | | | |
| 9 | Vertical | HNG- | 5CB | ~90% | 0.6% | 30 V | 8% | 80% |
| | | 715600- | 25% | | | | | |
| | | 100 | | | | | | |
| 10 | Vertical | HNG- | 5CB | ~90% | 0.6% | 40 V | 7% | 92% |
| | | 715600- | 25% | | | | | |
| | | 100 | | | | | | |
| 11 | Vertical | HNG- | 5CB | ~90% | 0.5% | 30 V | 22% | 49% |
| | | 715600- | 30% | | | | | |
| | | 100 | | | | | | |
| 12 | Vertical | HNG- | 5CB | ~90% | 0.5% | 45 V | 10% | 81% |
| | | 715600- | 30% | | | | | |
| | | 100 | | | | | | |
| 13 | Vertical | HNG- | 5CB | ~90% | <1% | 30 V | 89% | <10% |
| | | 715600- | 40% | | | | | |
| | | 100 | | | | | | |
| 14 | Vertical | HNG- | 5CB | ~90% | <1% | 30 V | 86% | <10% |
| | | 715600- | 50% | | | | | |
| | | 100 | | | | | | |
| 15 | Vertical | HNG- | 5CB | ~90% | <1% | 30 V | 88% | <10% |
| | | 715600- | 90% | | | | | |
| | | 100 | | | | | | |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 1%, with Example 7 exhibiting a haze of 0.2%. Thus, all the Examples 1-15 exhibited a similarly low haze in the transparent or clear state (no voltage state) as the Comparative Examples 1-4 above did.

A working voltage (“Vₒₙ”) was then applied to each of the smart window articles, which subjected the liquid crystal layer thereof to the working voltage. The working voltage applied was either 25 V, 30 V, 40 V, or 45 V as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of many of Examples 1-15 to exhibit a haze of greater than 70%—particularly Examples 5-10 and 12, which may be considered exemplary of the smart window articles of the present disclosure. The Examples 5-10 and 12 indicate that the positive liquid crystal layer having a weight percentage of from about 15 wt % to about 30 wt % can provide extraordinarily large changes in haze. Several exhibited a haze of at least 80% and some even exhibited a haze of at least 90%. For most of Examples 1-15, a large change in transmittance accompanied the large change in haze from the no voltage state to the privacy state of application of the working voltage. Examples 5-10 and 12 in particular exhibited a change in transmittance of from about 90% to 20% or less. When subjected to the working voltage of 25 V, the smart window article of Example 6 exhibited a transmittance of just 14% and a haze of 78%.

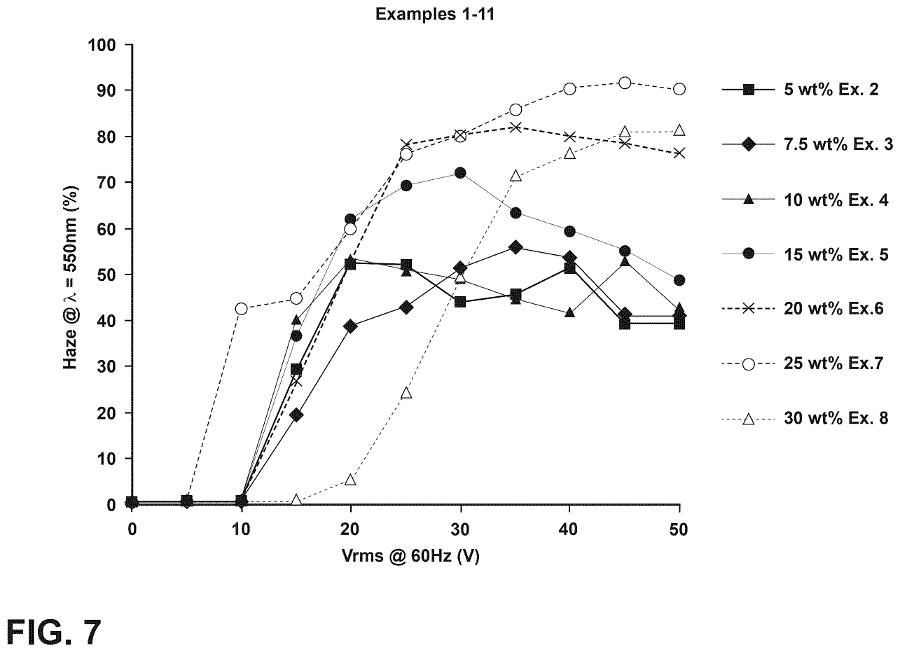

Voltage sweeps for the smart window articles of each of Examples 1-11 were conducted from a no voltage state to working voltages up to 50 V. The transmittance and haze at each voltage were measured. The results are set forth in the graphs reproduced at FIGS. 6 and 7. Results for Comparative Example 1 (0 wt % of positive liquid crystal) are included as well. The graph showing transmittance as a function of voltage illustrates that transmittance exhibited does not change much if at all when the weight percentage of the positive liquid crystal is 0 wt % or is greater than or equal to 40 wt %. The graph showing haze as a function of voltage illustrates that the smart window articles of Examples 6 and 7 (20 wt % and 25 wt % respectively) exhibited relatively high haze values (greater than 70%) at a working voltage of 25 V (and it could reasonably be assumed to be about the same at 24 V).

Examples 16-20—For Examples 16-20, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive dimer liquid crystal CB5CB. The dimer CB5C is crystalline at room temperature and exhibits positive dielectric property. The weight percentage of the positive liquid crystal in the liquid crystal layer varied, as indicated in Table 7 below. The negative liquid crystal was the balance of the liquid crystal layer. No separate polymeric material was included in the liquid crystal layer. No chiral dopant or dichroic dye was included in the liquid crystal layer.

TABLE 7

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 16 | Vertical | HNG- | CB5CB | ~90% | <1% | 30 V | 32% | <70% |
| | | 715600- | 5% | | | | | |
| | | 100 | | | | | | |
| 17 | Vertical | HNG- | CB5CB | ~90% | 0.3% | 30 V | 21% | 62% |
| | | 715600- | 7.5% | | | | | |
| | | 100 | | | | | | |
| 18 | Vertical | HNG- | CB5CB | ~90% | 0.3% | 45 V | 17% | 73% |
| | | 715600- | 7.5% | | | | | |
| | | 100 | | | | | | |
| 19 | Vertical | HNG- | CB5CB | ~90% | 0.2% | 30 V | 20% | 69% |
| | | 715600- | 10% | | | | | |
| | | 100 | | | | | | |
| 20 | Vertical | HNG- | CB5CB | ~90% | 0.2% | 40 V | 16% | 76% |
| | | 715600- | 10% | | | | | |
| | | 100 | | | | | | |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 100, with Examples 19 and 20 exhibiting a haze of 0.2%.

A working voltage (“Vₒₙ”) was then applied to each of the smart window articles, which subjected the liquid crystal layer thereof to the working voltage. The working voltage applied was either 30 V, 40 V, or 45 V as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of several of Examples 16-20 to exhibit a haze of greater than 70%—particularly Examples 18 and 20, which may be considered exemplary of the smart window articles of the present disclosure. Examples 18 and 20 indicate that the positive liquid crystal layer having a weight percentage of at least about 7.5 wt % can provide extraordinarily large changes in haze. Less weight percentage of the positive liquid crystal compared to Examples 1-15 may be attributed to the positive liquid crystal of Examples 16-20 being a dimer. For all of Examples 16-20, a large change in transmittance accompanied the large change in haze from the no voltage state to the privacy state of application of the working voltage. Examples 18-20 in particular exhibited a change in transmittance of from about 90% to 20% or less.

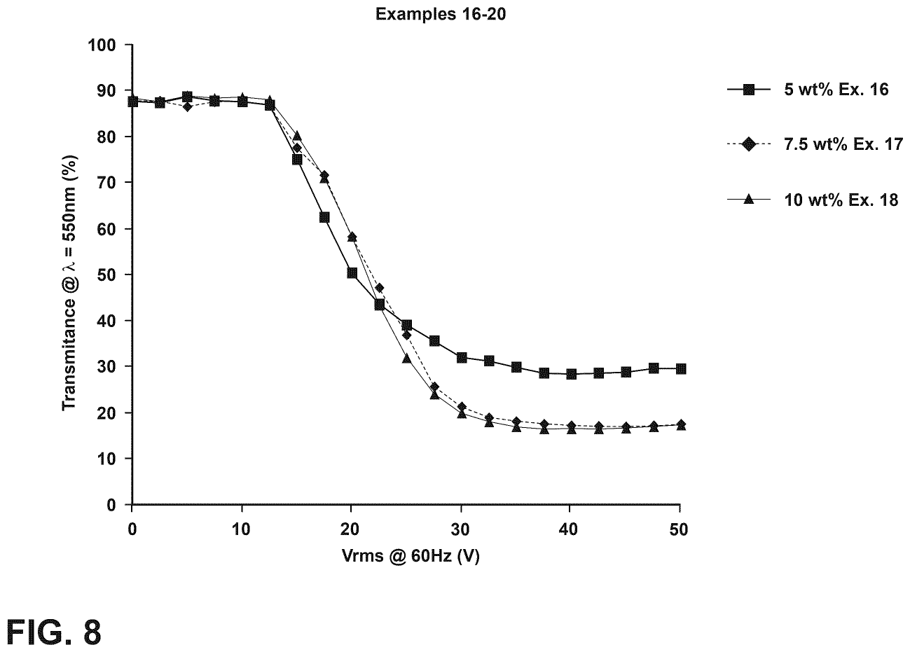

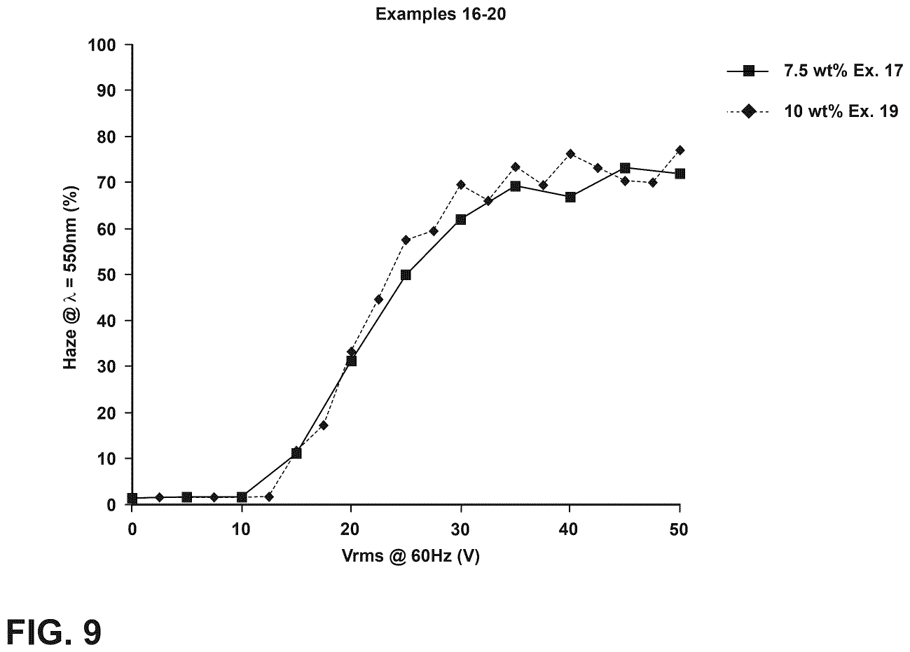

Voltage sweeps for the smart window articles of each of Examples 16, 17, and 19 were conducted from a no voltage state to working voltages up to 50 V. The transmittance and haze at each voltage were measured. The results are set forth in the graphs reproduced at FIGS. 8 and 9. The graph showing transmittance as a function of voltage illustrates that transmittance changed to a large degree in response to the working voltage for all of Examples 16, 17, and 19, when the weight percentage of the positive liquid crystal was 5 wt % to 10 wt %. The graph showing haze as a function of voltage illustrates that the smart window articles of Examples 16, 17, and 19 exhibited at tunable haze as a function of working voltage.

Examples 21 and 22—For Examples 21 and 22, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive dimer liquid crystal CB7CB. The dimer CB7CB is just like CB5CB but includes a 7-carbon chain instead of a 5-carbon chain connecting the two benzyl groups, as in CB5CB. The weight percentage of the positive liquid crystal in the liquid crystal layer varied, as indicated in Table 8 below. The negative liquid crystal was the balance of the liquid crystal layer. No separate polymeric material was included in the liquid crystal layer. No chiral dopant or dichroic dye was included in the liquid crystal layer.

TABLE 8

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 21 | Vertical | HNG- | CB7CB | ~90% | <1% | 30 V | 58% | <50% |
| | | 715600- | 7.5% | | | | | |
| | | 100 | | | | | | |
| 22 | Vertical | HNG- | CB7CB | ~90% | <1% | 30 V | 46% | <50% |
| | | 715600- | 10% | | | | | |
| | | 100 | | | | | | |

The transmittance (“T(0V)”) and haze (“H(0V)”) through each of the smart window articles without any voltage applied across the liquid crystal layer were determined. Both smart window articles exhibited a transmittance of about 90%. In addition, both smart window articles exhibited a haze of less than 1%.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 21 and 22 to exhibit a haze of less than 50%. The haze results indicate that longer dimeric positive liquid crystals may limit the level of haze that can be exhibited. For Examples 21 and 22, a substantial change in transmittance accompanied the change in haze from the no voltage state to the privacy state of application of the working voltage. However, the change in transmittance that Examples 21 and 22 exhibited was less than many of the examples already discussed.

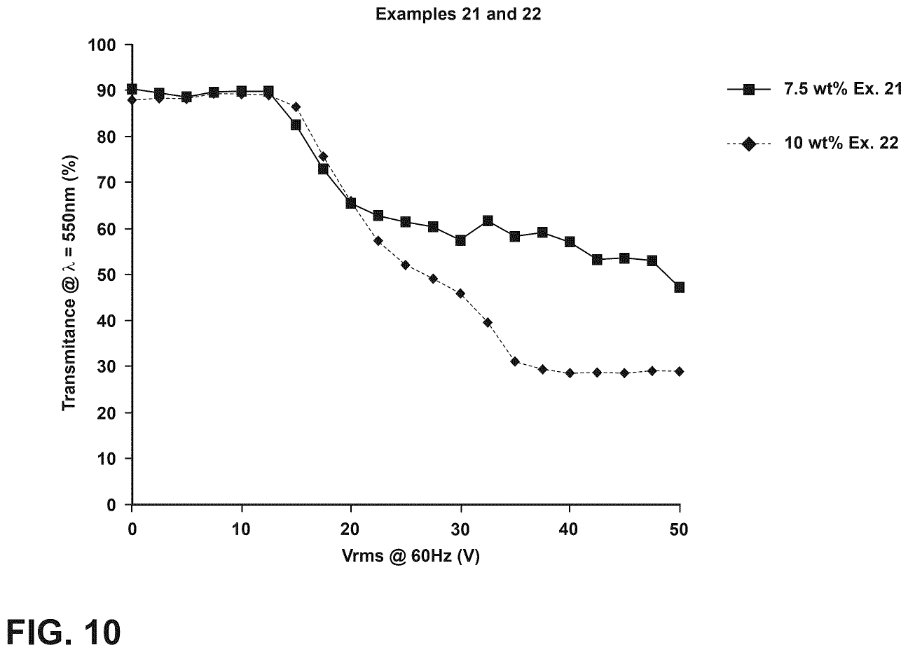

Voltage sweeps for the smart window articles of each of Examples 21 and 22 were conducted from a no voltage state to working voltages up to 50 V. The transmittance at each voltage was measured. The results are set forth in the graph reproduced at FIG. 10. The graph showing transmittance as a function of voltage illustrates that transmittance changed to a large degree in response to the working voltage for both Examples 21 and 22.

Examples 23-25—For Examples 23-25, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive dimer liquid crystal CB9CB. The dimer CB9CB is Just like CB5CB but includes a 9-carbon chain instead of a 5-carbon chain connecting the two benzyl groups, as in CB5CB. The weight percentage of the positive liquid crystal in the liquid crystal layer varied, as indicated in Table 9 below. The negative liquid crystal was the balance of the liquid crystal layer. No separate polymeric material was included in the liquid crystal layer. No chiral dopant or dichroic dye was included in the liquid crystal layer.

TABLE 9

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 23 | Vertical | HNG- | CB9CB | ~90% | <1% | 30 V | 79% | <50% |
| | | 715600- | 5% | | | | | |
| | | 100 | | | | | | |
| 24 | Vertical | HNG- | CB9CB | ~90% | <1% | 30 V | 64% | <50% |
| | | 715600- | 7.5% | | | | | |
| | | 100 | | | | | | |
| 25 | Vertical | HNG- | CB9CB | ~90% | <1% | 30 V | 66% | <50% |
| | | 715600- | 10% | | | | | |
| | | 100 | | | | | | |

The transmittance (“T(0V)”) and haze (“H(0V)”) through each of the smart window articles without any voltage applied across the liquid crystal layer were determined. Both smart window articles exhibited a transmittance of about 90%. In addition, both smart window articles exhibited a haze of less than 10%.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 23-25 to exhibit a haze of less than 500%. The haze results indicate that longer dimeric positive liquid crystals may limit the level of haze that can be exhibited. For Examples 21 and 22, a smaller change in transmittance accompanied the change in haze from the no voltage state to the privacy state of application of the working voltage than some of the other examples above.

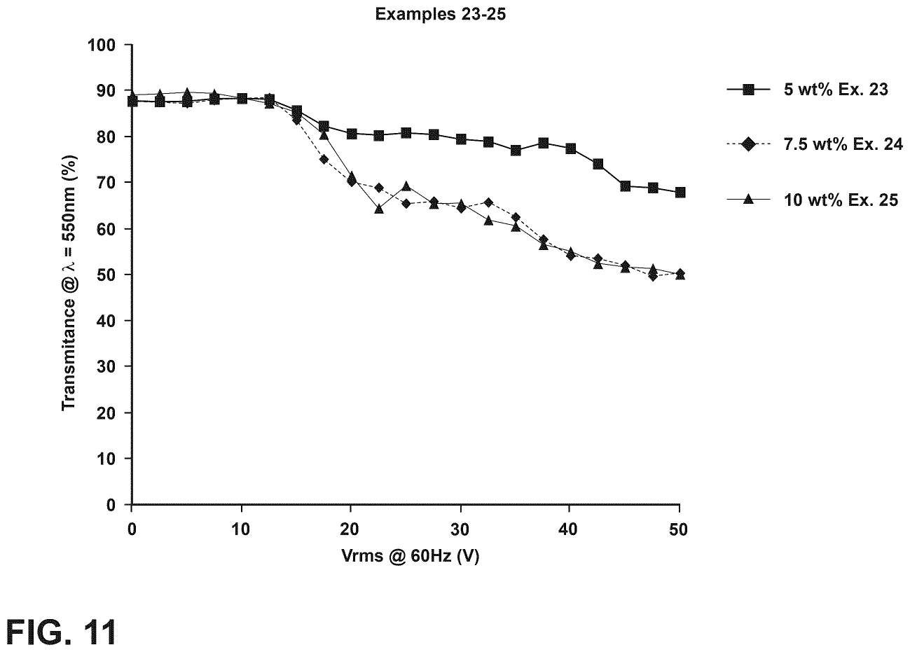

Voltage sweeps for the smart window articles of each of Examples 23-25 were conducted from a no voltage state to working voltages up to 50 V. The transmittance at each voltage was measured. The results are set forth in the graph reproduced at FIG. 11. The graph showing transmittance as a function of voltage illustrates that transmittance changed to a lesser degree in response to the working voltage for Examples 23-25 compared to prior examples.

Examples 26-28—For Examples 26-28, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive dimer liquid crystal CB11CB. The dimer CB11CB is Just like CB5CB but includes an 11-carbon chain instead of a 5-carbon chain connecting the two benzyl groups, as in CB5CB. The weight percentage of the positive liquid crystal in the liquid crystal layer varied, as indicated in Table 10 below. The negative liquid crystal was the balance of the liquid crystal layer. No separate polymeric material was included in the liquid crystal layer. No chiral dopant or dichroic dye was included in the liquid crystal layer.

TABLE 10

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 26 | Vertical | HNG- | CB11CB | ~90% | <1% | 30 V | 80% | <50% |
| | | 715600- | 5% | | | | | |
| | | 100 | | | | | | |
| 27 | Vertical | HNG- | CB11CB | ~90% | <1% | 30 V | 74% | <50% |
| | | 715600- | 7.5% | | | | | |
| | | 100 | | | | | | |
| 28 | Vertical | HNG- | CB11CB | ~90% | <1% | 30 V | 83% | <50% |
| | | 715600- | 10% | | | | | |
| | | 100 | | | | | | |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 1%.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 26-28 to exhibit a haze of less than 50%. The haze results indicate that longer dimeric positive liquid crystals may limit the level of haze that can be exhibited. For all of Examples 26-28, less change in transmittance accompanied the change in haze from the no voltage state to the privacy state of application of the working voltage than even the immediately preceding examples.

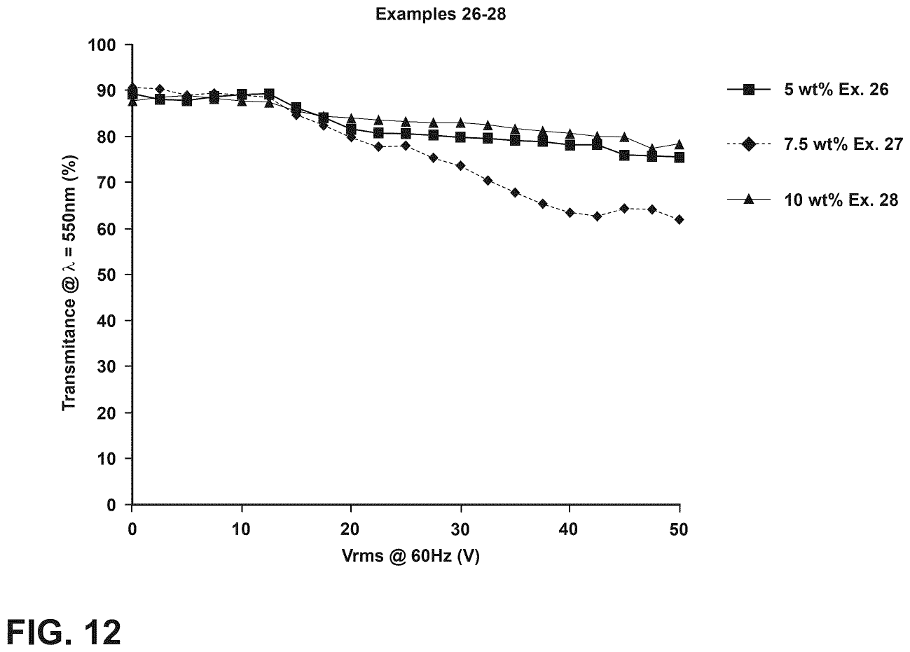

Voltage sweeps for the smart window articles of each of Examples 26-28 were conducted from a no voltage state to working voltages up to 50 V. The transmittance at each voltage was measured. The results are set forth in the graph reproduced at FIG. 12. The graph showing transmittance as a function of voltage illustrates that transmittance changed to a lesser degree in response to the working voltage for Examples 26-28 compared to prior examples.

Examples 29-34—For Examples 29-34, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive liquid crystal 5CB. The weight percentage of the positive liquid crystal 5CB was 20 wt % for all of Examples 29-34. Unlike the previous examples so far, the liquid crystal layer further included a dichroic dye. The weight percentage of the dichroic dye in the liquid crystal layer varied, as indicated in Table 11 below. The negative liquid crystal was the balance of the liquid crystal layer. No separate polymeric material was included in the liquid crystal layer. No chiral dopant was included in the liquid crystal layer.

TABLE 11

| | | | | Dichroic | | | | | |
|---|---|---|---|---|---|---|---|---|---|
| | | | Pos. LC | Dye | | | | | |
| Ex. | Alignment | Neg. LC | (wt %) | (wt %) | T(0 V) | H(0 V) | Vₒₙ | T(Vₒₙ) | H(Vₒₙ) |
| 29 | Vertical | HNG- | 5CB | M1012 | 80% | 0.2% | 30 V | 8% | 67% |
| | | 715600- | 20% | 0.5% | | | | | |
| | | 100 | | | | | | | |
| 30 | Vertical | HNG- | 5CB | M1012 | 80% | 0.2% | 40 V | 9% | 69% |
| | | 715600- | 20% | 0.5% | | | | | |
| | | 100 | | | | | | | |
| 31 | Vertical | HNG- | 5CB | M1012 | 74% | 0.2% | 30 V | 6% | 76% |
| | | 715600- | 20% | 1% | | | | | |
| | | 100 | | | | | | | |
| 32 | Vertical | HNG- | 5CB | M1012 | 59% | 0.1% | 30 V | 8% | 62% |
| | | 715600- | 20% | 2% | | | | | |
| | | 100 | | | | | | | |
| 33 | Vertical | HNG- | 5CB | M1012 | 50% | 0.4% | 30 V | 2% | 73% |
| | | 715600- | 20% | 3% | | | | | |
| | | 100 | | | | | | | |
| 34 | Vertical | HNG- | 5CB | M1012 | 50% | 0.4% | 40 V | 1% | 77% |
| | | 715600- | 20% | 3% | | | | | |
| | | 100 | | | | | | | |

The transmittance (“T(0V)”) and haze (“H(0V)”) through each of the smart window articles without any voltage applied across the liquid crystal layer were determined. The smart window articles exhibited a transmittance within a range of from 50% to 80%, with the transmittance decreasing as the weight percentage of the dichroic dye increased. In addition, all the smart window articles exhibited a haze of 0.4% or less.

A working voltage (“Vₒₙ”) was then applied to each of the smart window articles, which subjected the liquid crystal layer thereof to the working voltage. The working voltage applied was 30 V or 40 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 29-34 to exhibit a haze ranging from 62% to 76%. The haze results indicate that the presence of a dichroic dye in the liquid crystal layer may limit the haze exhibited while subjected to the working voltage. For all of Examples 29-34, a substantial decrease in transmittance accompanied the change in haze from the no voltage state to the privacy state of application of the working voltage. The large decrease in transmittance and the large increase in haze from the clear state to the privacy state may be suitable for some applications, despite the lower transparency in the clear state (e.g., no voltage state).

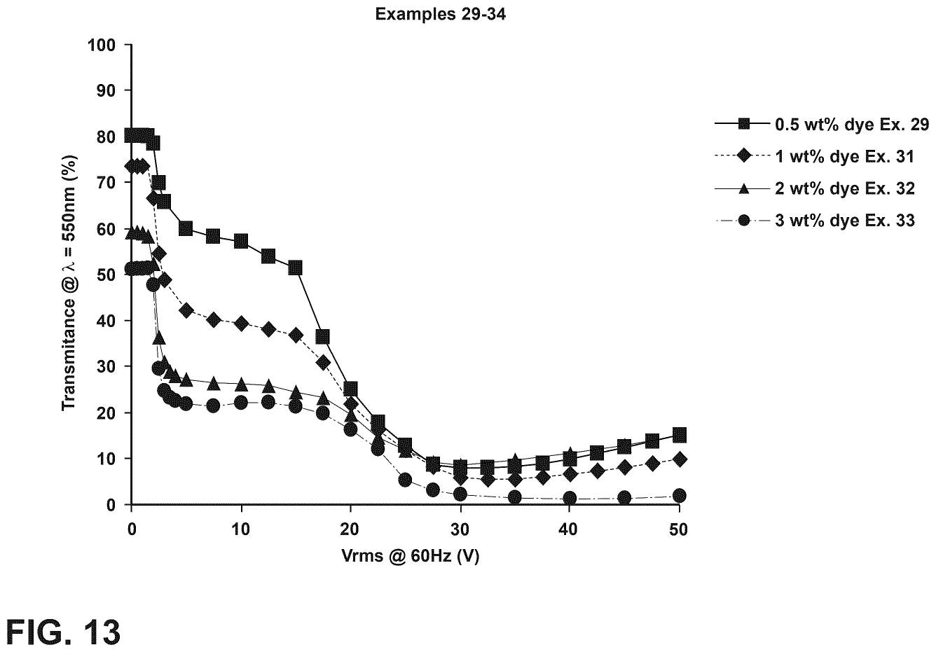

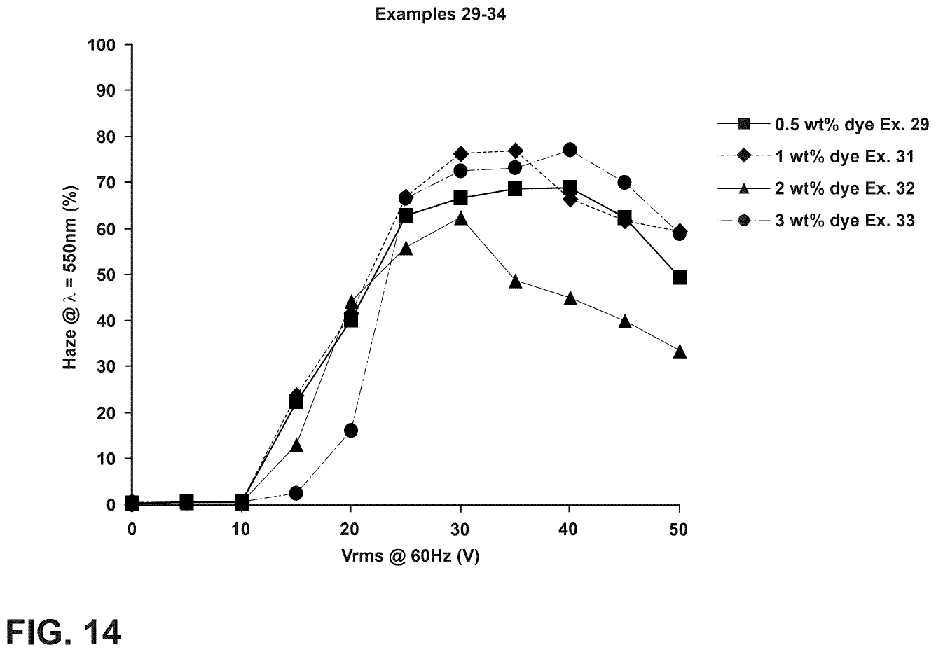

Voltage sweeps for the smart window articles of each of Examples 29-34 were conducted from a no voltage state to working voltages up to 50 V. The transmittance and haze at each voltage were measured. The results are set forth in the graphs reproduced at FIGS. 13 and 14. The graph showing transmittance as a function of voltage illustrates that transmittance changed to a large degree in response to the working voltage for all of Examples 29-34, for all weight percentages of the dichroic dye studied. The graph showing haze as a function of voltage illustrates that the smart window articles of Examples 29-34 exhibited at tunable haze as a function of working voltage.

Examples 35-37—For Examples 35-37, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and the positive dimeric liquid crystal CB5CB. The weight percentage of the positive liquid crystal CB5CB was 7.5 wt % for all of Examples 35-37. Like the immediately previous examples, the liquid crystal layer further included a dichroic dye. The weight percentage of the dichroic dye in the liquid crystal layer varied, as indicated in Table 12 below. The negative liquid crystal was the balance of the liquid crystal layer. No separate polymeric material was included in the liquid crystal layer. No chiral dopant was included in the liquid crystal layer.

TABLE 12

| | | | | Dichroic | | | | | |
|---|---|---|---|---|---|---|---|---|---|
| | | | Pos. LC | Dye | | | | | |
| Ex. | Alignment | Neg. LC | (wt %) | (wt %) | T(0 V) | H(0 V) | Vₒₙ | T(Vₒₙ) | H(Vₒₙ) |
| 35 | Vertical | HNG- | CB5CB | M1012 | 65% | 0.2% | 30 V | 17% | 56% |
| | | 715600- | 7.5% | 1.5% | | | | | |
| | | 100 | | | | | | | |
| 36 | Vertical | HNG- | CB5CB | M1012 | 60% | 0.4% | 30 V | 12% | 34% |
| | | 715600- | 7.5% | 2% | | | | | |
| | | 100 | | | | | | | |
| 37 | Vertical | HNG- | CB5CB | M1012 | 56% | 0.2% | 30 V | 13% | 23% |
| | | 715600- | 7.5% | 3% | | | | | |
| | | 100 | | | | | | | |

The transmittance (“T(0V)”) and haze (“H(0V)”) through each of the smart window articles without any voltage applied across the liquid crystal layer were determined. The smart window articles exhibited a transmittance within a range of from 56% to 65%, with the transmittance decreasing as the weight percentage of the dichroic dye increased. In addition, all the smart window articles exhibited a haze of 0.4% or less.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(V^{on})”) through each of the smart window articles with the working voltage applied across the liquid crystal layer were determined. The application of the working voltage caused the smart window article of Examples 35-37 to exhibit a haze ranging from 23% to 56%. The haze results indicate that the presence of a dichroic dye and a dimeric positive liquid crystal in the liquid crystal layer may further limit the haze exhibited while subjected to the working voltage. For all of Examples 35-37 a substantial decrease in transmittance accompanied the change in haze from the no voltage state to the privacy state of application of the working voltage. The large decrease in transmittance and the increase in haze from the clear state to the privacy state may be suitable for some applications, despite the lower transparency in the clear state (e.g., no voltage state).

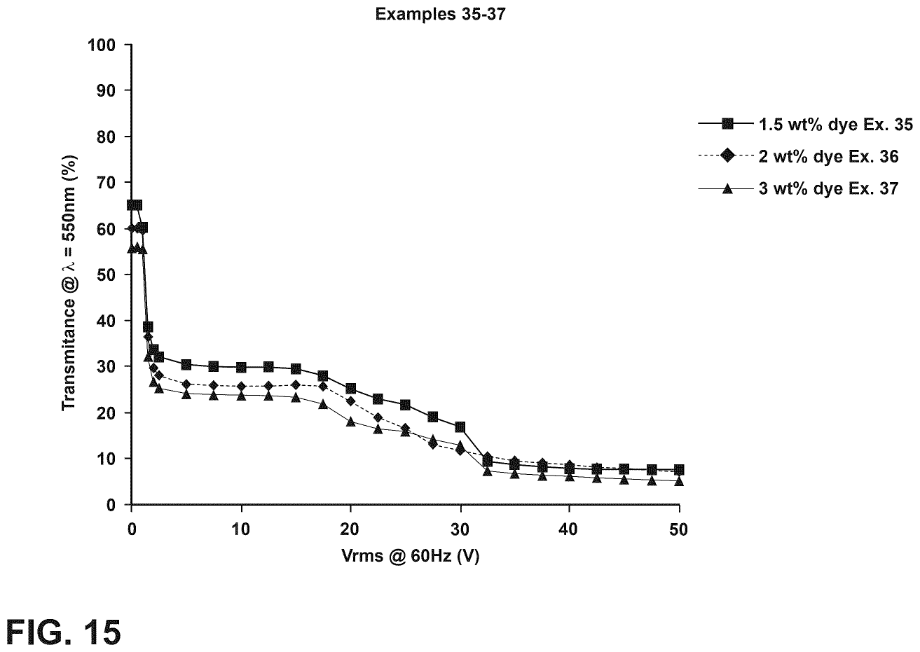

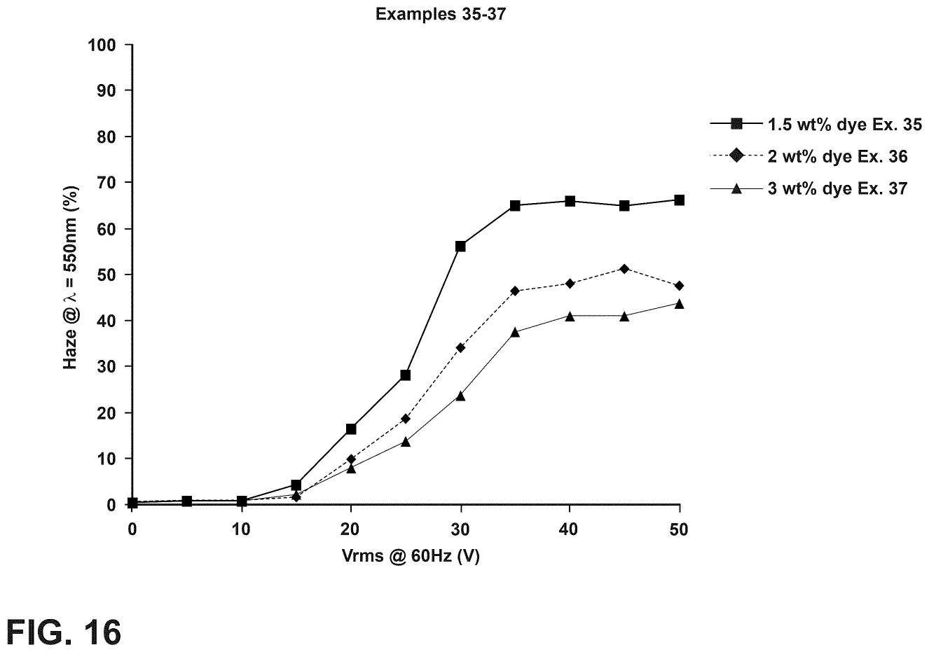

Voltage sweeps for the smart window articles of each of Examples 35-37 were conducted from a no voltage state to working voltages up to 50 V. The transmittance and haze at each voltage were measured. The results are set forth in the graphs reproduced at FIGS. 15 and 16. The graph showing transmittance as a function of voltage illustrates that transmittance changed to a large degree in response to the working voltage for all of Examples 35-37, for all weight percentages of the dichroic dye studied. The graph showing haze as a function of voltage illustrates that smart window articles of Examples 35-37 exhibited at tunable haze as a function of working voltage, with higher haze achievable with less weight percentage of dichroic dye.

Examples 38-41—For Examples 38-41, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive liquid crystal 5CB. The weight percentage of the positive liquid crystal 5CB was 20 wt % for all of Examples 38-41. The liquid crystal layer further included a chiral dopant of either CB-15 or R-811, as stated in Table 13 below. The weight percentage of the chiral dopant in the liquid crystal layer varied, as indicated in Table 13 below, as necessary to induce either ½ a twist (“0.5T”) or a full twist (“1T”). The negative liquid crystal was the balance of the liquid crystal layer. No separate polymeric material was included in the liquid crystal layer. No dichroic dye was included in the liquid crystal layer.

TABLE 13

| | | | | Chiral | | | | | |
|---|---|---|---|---|---|---|---|---|---|
| | | | Pos. LC | dopant | | | | | |
| Ex. | Alignment | Neg. LC | (wt %) | (twist) | T(0 V) | H(0 V) | Vₒₙ | T(Vₒₙ) | H(Vₒₙ) |
| 38 | Vertical | HNG- | 5CB | CB-15, | ~90% | 0.2% | 30 V | 20% | 70% |
| | | 715600- | 20% | 0.5T | | | | | |
| | | 100 | | | | | | | |
| 39 | Vertical | HNG- | 5CB | CB-15, | 73% | 17% | 30 V | 8% | 82% |
| | | 715600- | 20% | 1T | | | | | |
| | | 100 | | | | | | | |
| 40 | Vertical | HNG- | 5CB | R-811, | ~90% | 0.2% | 30 V | 13% | 78% |
| | | 715600- | 20% | 0.5T | | | | | |
| | | 100 | | | | | | | |
| 41 | Vertical | HNG- | 5CB | R-811, | ~90% | 0.3% | 30 V | 11% | 76% |
| | | 715600- | 20% | 1T | | | | | |
| | | 100 | | | | | | | |

The transmittance (“T(0V)”) and haze (“H(0V)”) through each of the smart window articles without any voltage applied across the liquid crystal layer were determined. The smart window articles exhibited a transmittance within a range of from 73% to 90. In addition, all the smart window articles exhibited a haze of 0.4% or less. The smart window articles exhibited a haze of either 0.3% or less or 17% (as was the case for Example 39). A haze of 17% in the no voltage state may be acceptable in some applications.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 38-41 to exhibit a haze ranging from 70% to 82%. The haze results indicate that the presence of a chiral dopant may result in the smart window article exhibiting both a relatively high haze and a relatively high change in haze while subjected to the working voltage compared to the no voltage state. For all of Examples 38-41 a substantial decrease in transmittance accompanied the change in haze from the no voltage state to the privacy state of application of the working voltage.

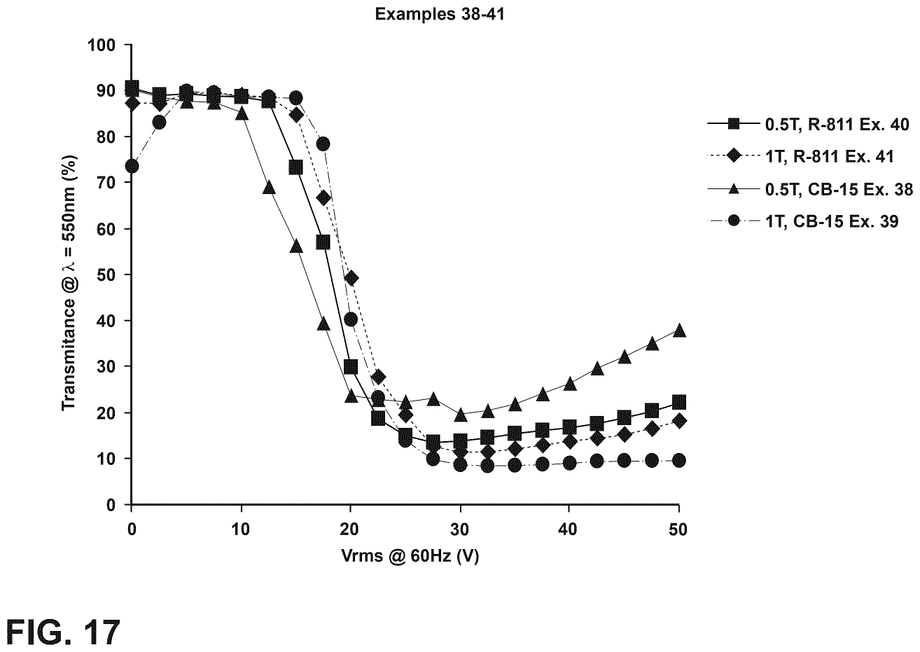

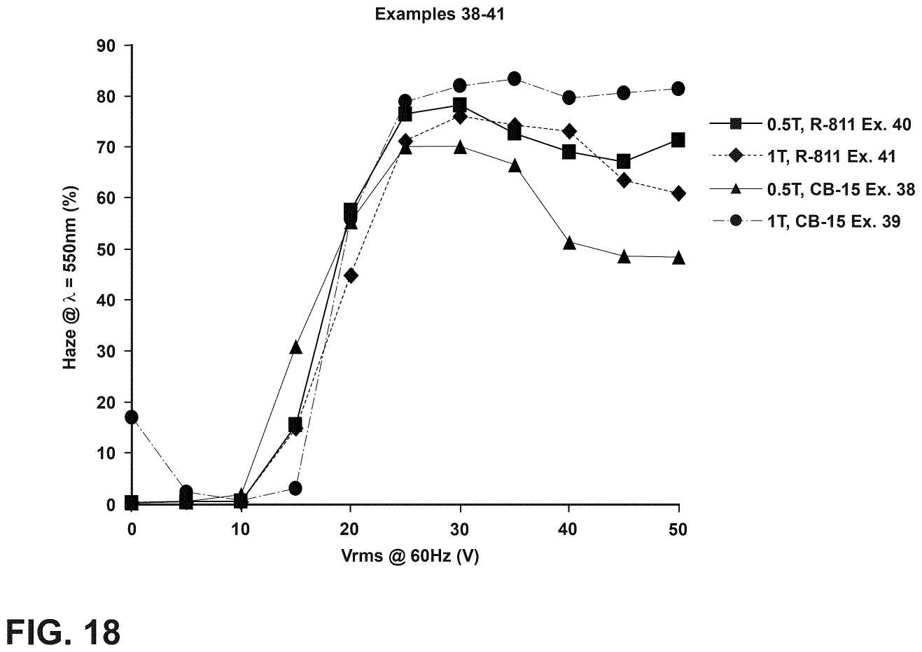

Voltage sweeps for the smart window articles of each of Examples 38-41 were conducted from a no voltage state to working voltages up to 50 V. The transmittance and haze at each voltage were measured. The results are set forth in the graphs reproduced at FIGS. 17 and 18. The graph showing transmittance as a function of voltage illustrates that transmittance changed to a large degree in response to the working voltage for all of Examples 38-41, for all weight percentages of the dichroic dye studied. The graph showing haze as a function of voltage illustrates that the smart window articles of Examples 39-41 exhibited relatively high haze values (greater than 70%) at a working voltage of 25 V (and it could reasonably be assumed to be about the same at 24 V). All of Examples 39-41 may be considered exemplary Examples of the smart window article of the present disclosure.

Examples 42-44—For Examples 42-44, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive liquid crystal 5CB. The weight percentage of the positive liquid crystal 5CB was 20 wt % for all of Examples 42-44. The liquid crystal layer further included both the chiral dopant R-811 and 3 wt % of the dichroic dye M1012. The weight percentage of the chiral dopant in the liquid crystal layer varied, as indicated in Table 14 below, as necessary to induce either ½ a twist (“0.5T”), a full twist (“1T”), or two full twists (“2T”). The negative liquid crystal was the balance of the liquid crystal layer. No separate polymeric material was included in the liquid crystal layer.

TABLE 14

| | | | | Chiral | Dichroic | | | | | |
|---|---|---|---|---|---|---|---|---|---|---|
| | | | Pos. LC | dopant | Dye | | | | | |
| Ex. | Alignment | Neg. LC | (wt %) | (twist) | (wt %) | T(0 V) | H(0 V) | Vₒₙ | T(Vₒₙ) | H(Vₒₙ) |
| 42 | Vertical | HNG- | 5CB | R-811, | M1012 | 54% | 0.1% | 30 V | 3% | 66% |
| | | 715600- | 20% | 0.75T | 3% | | | | | |
| | | 100 | | | | | | | | |
| 43 | Vertical | HNG- | 5CB | R-811, | M1012 | 48% | 0.3% | 30 V | 2% | 63% |
| | | 715600- | 20% | 1T | 3% | | | | | |
| | | 100 | | | | | | | | |
| 44 | Vertical | HNG- | 5CB | R-811, | M1012 | 10% | <1% | 30 V | 5% | N/A |
| | | 715600- | 20% | 2T | 3% | | | | | |
| | | 100 | | | | | | | | |

The transmittance (“T(0V)”) and haze (“H(0V)”) through each of the smart window articles without any voltage applied across the liquid crystal layer were determined. The smart window articles exhibited a transmittance within a range of from 10% to 54%, indicating that the presence and amount of chiral dopant can strongly affect transmittance exhibited in the no voltage state. In addition, all the smart window articles exhibited a haze of less than 10%.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 42 and 43 to exhibit a haze of 660% and 63% respectively. The haze results indicate that the presence of both a chiral dopant and a dichroic dye may result in the smart window article exhibiting both a relatively high haze and a relatively high change in haze while subjected to the working voltage compared to the no voltage state. For both Examples 42 and 43, a substantial decrease in transmittance accompanied the change in haze from the no voltage state to the privacy state of application of the working voltage.

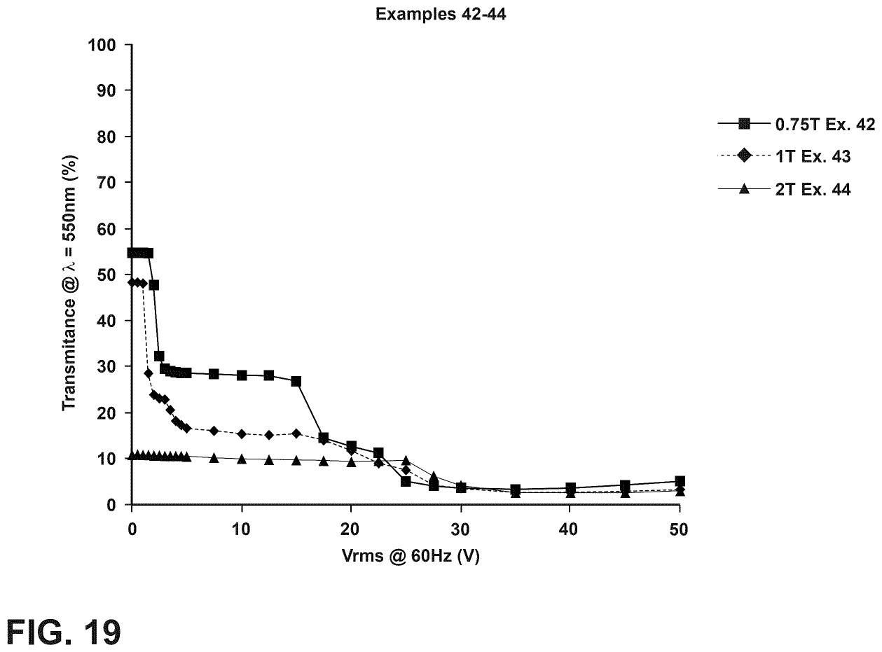

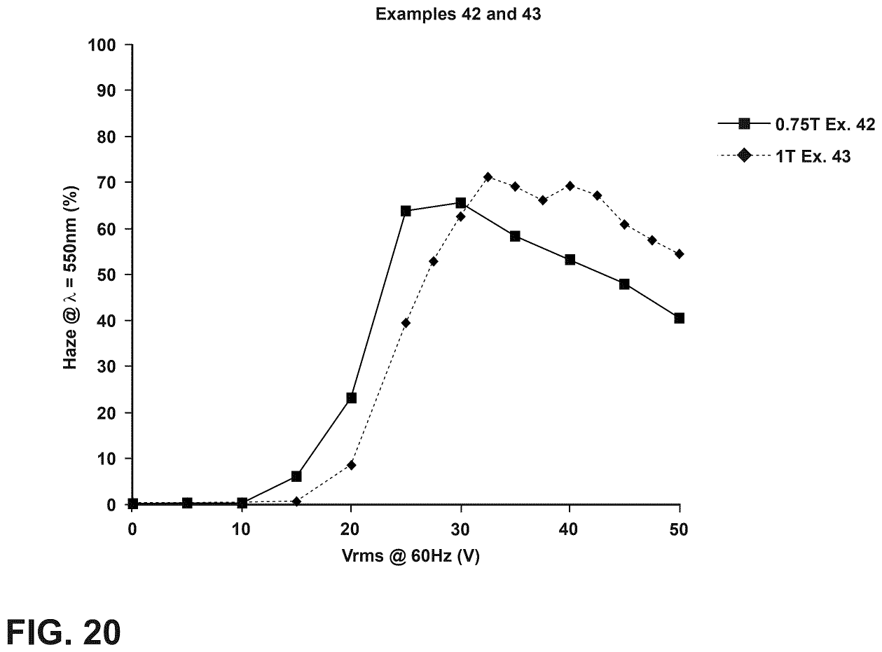

Voltage sweeps for the smart window articles of each of Examples 42-44 were conducted from a no voltage state to working voltages up to 50 V. The transmittance and haze at each voltage were measured (except for Example 44, where only transmittance was measured). The results are set forth in the graphs reproduced at FIGS. 19 and 20. The graph showing transmittance as a function of voltage illustrates that transmittance in the no voltage state is limited but is tunable changed to a large degree in response to the working voltage. The graph showing haze as a function of voltage illustrates that smart window articles of Examples 42 and 43 exhibited at tunable haze as a function of working voltage, with greater weight percentage of the chiral dopant pushing the haze as a function of working voltage to the right.

Further, the graphs for Example 42 demonstrates well the third voltage state described above. The voltage of 0V can be considered to be the first voltage state, the voltage of 25 V can be considered to be the second voltage state, and the voltage of 10 V can be considered to be the third voltage state. At the first voltage state, the transmittance and haze that the smart window article exhibits is about 55% and 0% respectively. At the second voltage state, the transmittance and haze that the smart window article exhibits is about 5% and 65% respectively. At the third voltage state, the transmittance that the smart window article exhibits has decreased (relative to the first voltage state of V) to about 29%. However, the haze that the smart window article exhibits has not increased from 0%—it is still 0%. The third working voltage achieves a drop in transmittance without a commensurate rise in haze. The rise in haze comes with increasing the voltage further from the third voltage state of 10 V. Such a phenomenon may be attributable to the presence of the dichroic dye and/or chiral dopant.

Examples 45-48—For Examples 45-48, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and positive liquid crystal 5CB. The weight percentage of the positive liquid crystal 5CB was 20 wt % for all of Examples 45-48. The liquid crystal layer further included both the chiral dopant R-811 and the dichroic dye M1012. The weight percentage of the chiral dopant in the liquid crystal layer was sufficient to induce a full twist (“1T”). The weight percentage of the dichroic dye varied from 1 wt % to 3 wt %, as set forth in Table 15 below. The negative liquid crystal was the balance of the liquid crystal layer. No separate polymeric material was included in the liquid crystal layer.

TABLE 15

| | | | | Chiral | Dichroic | | | | | |
|---|---|---|---|---|---|---|---|---|---|---|
| | | | Pos. LC | dopant | Dye | | | | | |
| Ex. | Alignment | Neg. LC | (wt %) | (twist) | (wt %) | T(0 V) | H(0 V) | Vₒₙ | T(Vₒₙ) | H(Vₒₙ) |
| 45 | Vertical | HNG-715600-100 | 5CB 20% | R-811, 1T | M1012 1% | 73% | 0.4% | 30 V | 10% | 62% |
| 46 | Vertical | HNG-715600-100 | 5CB 20% | R-811, 1T | M1012 2% | 61% | 0.3% | 30 V | 3% | 76% |
| 47 | Vertical | HNG-715600-100 | 5CB 20% | R-811, 1T | M1012 3% | 48% | 0.3% | 30 V | 2% | 63% |
| 48 | Vertical | HNG-715600-100 | 5CB 20% | R-811, 1T | M1012 3% | 48% | 0.3% | 35 V | 2% | 70% |

The transmittance (“T(0V)”) and haze (“H(0V)”) through each of the smart window articles without any voltage applied across the liquid crystal layer were determined. The smart window articles exhibited a transmittance within a range of from 48% to 73%. The transmittance in the no-voltage state may be suitable for some applications. In addition, all the smart window articles exhibited a haze of less than 0.4%.

A working voltage (“Vₒₙ”) was then applied to each of the smart window articles, which subjected the liquid crystal layer thereof to the working voltage. The working voltage applied was either 30 V or 35 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 45-48 to exhibit a haze within a range of from 62% to 76%. For all of Examples 45-48, a substantial decrease to 10% or less in transmittance accompanied the change in haze from the no voltage state to the privacy state of application of the working voltage.

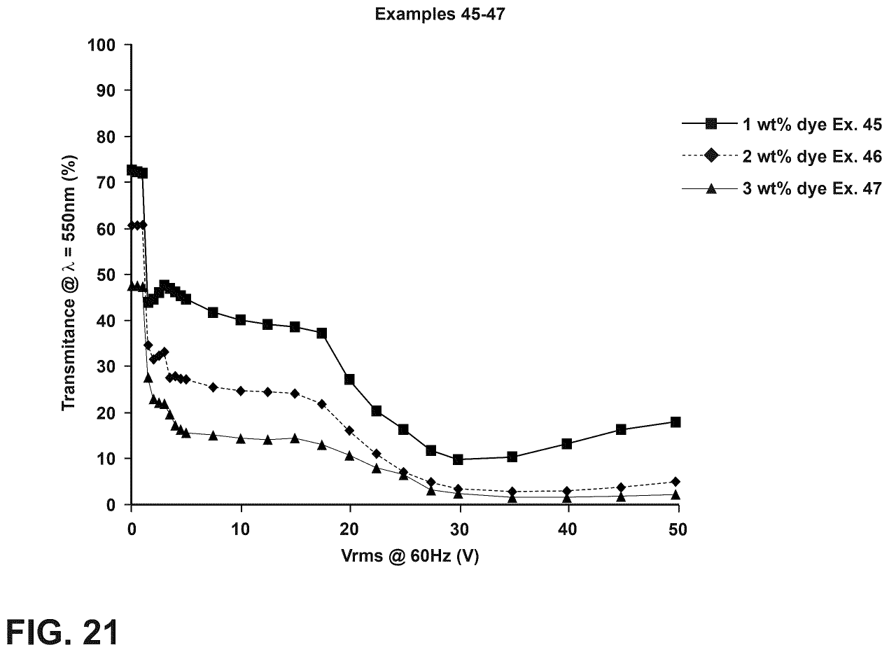

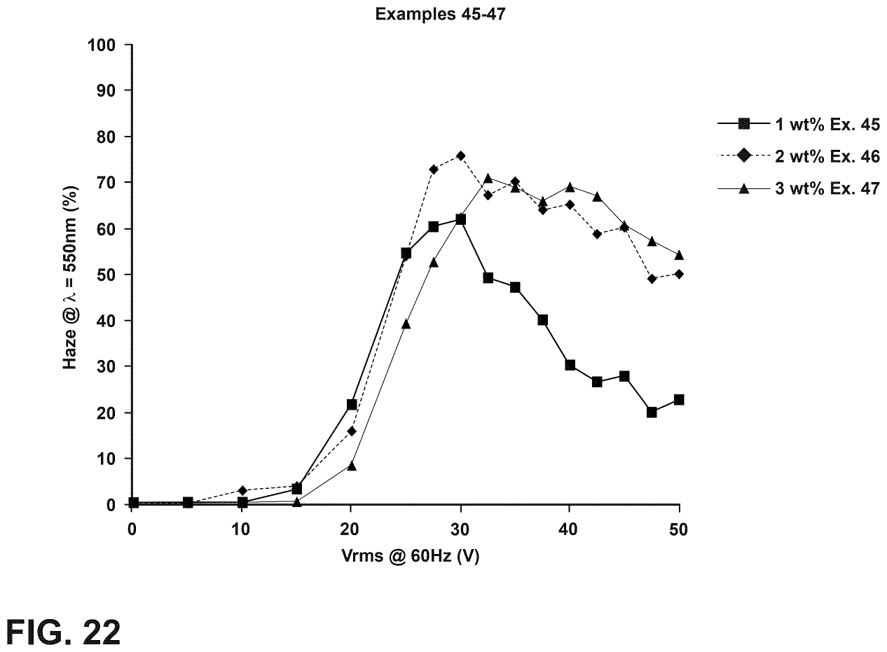

Voltage sweeps for the smart window articles of each of Examples 45-47 were conducted from a no voltage state to working voltages up to 50 V. The transmittance and haze at each voltage were measured. The results are set forth in the graphs reproduced at FIGS. 21 and 22. The graph showing transmittance as a function of voltage illustrates that transmittance changed to a large degree in response to the working voltage for all of Examples 45-47, for all weight percentages of the dichroic dye studied. The graph showing haze as a function of voltage illustrates that smart window articles of Examples 45-47 exhibited at tunable haze as a function of working voltage.

Examples 49-50—For Examples 49-50, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and the positive dimeric liquid crystal CB5CB. The weight percentage of the positive liquid crystal CB5CB was 7.5 wt % for all of Examples 49-50. The liquid crystal layer further included both the chiral dopant R-811 and the dichroic dye M1012. The weight percentage of the chiral dopant in the liquid crystal layer was sufficient to induce a half twist (“0.5T”). The weight percentage of the dichroic dye was 2 wt %, as set forth in Table 16 below. The negative liquid crystal was the balance of the liquid crystal layer. No separate polymeric material was included in the liquid crystal layer.

TABLE 16

| | | | | Chiral | Dichroic | | | | | |
|---|---|---|---|---|---|---|---|---|---|---|
| | | | Pos. LC | dopant | Dye | | | | | |
| Ex. | Alignment | Neg. LC | (wt %) | (twist) | (wt %) | T(0 V) | H(0 V) | Vₒₙ | T(Vₒₙ) | H(Vₒₙ) |
| 49 | Vertical | HNG-715600-100 | CB5CB 7.5% | R-811, 0.5T | M1012 2% | 61% | 0.3% | 30 V | 15% | 51% |
| 50 | Vertical | HNG-715600-100 | CB5CB 7.5% | R-811, 0.5T | M1012 2% | 61% | 0.3% | 40 V | 3% | 90% |

The transmittance (“T(0V)”) and haze (“H(0V)”) through each of the smart window articles without any voltage applied across the liquid crystal layer were determined. The smart window articles exhibited a transmittance of 61%. The transmittance in the no-voltage state may be suitable for some applications. In addition, the smart window articles exhibited a haze of 0.3%.

A working voltage (“Vₒₙ”) was then applied to each of the smart window articles, which subjected the liquid crystal layer thereof to the working voltage. The working voltage applied was either 30 V or 40 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window article of Examples 49 and 50 to exhibit a haze of 51% and 90% respectively. For both Examples 49 and 50, a substantial decrease to 15% and 90% respectively in transmittance accompanied the change in haze from the no voltage state to the privacy state of application of the working voltage.

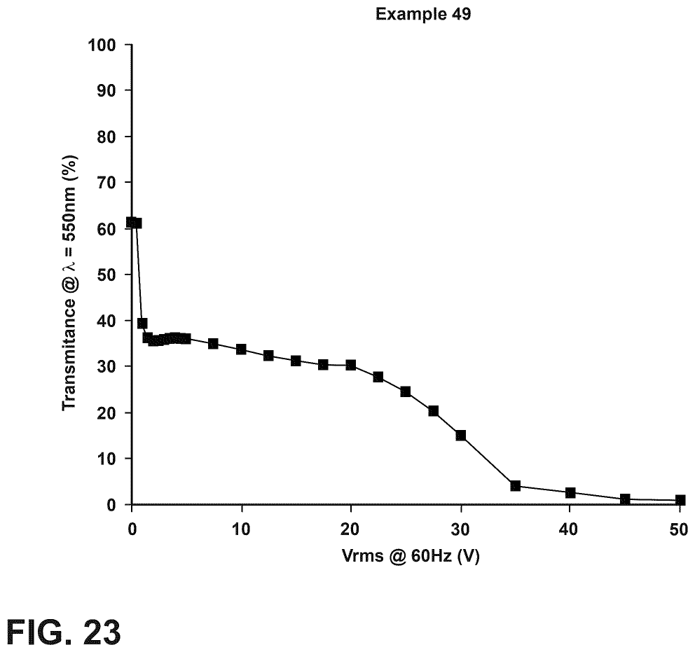

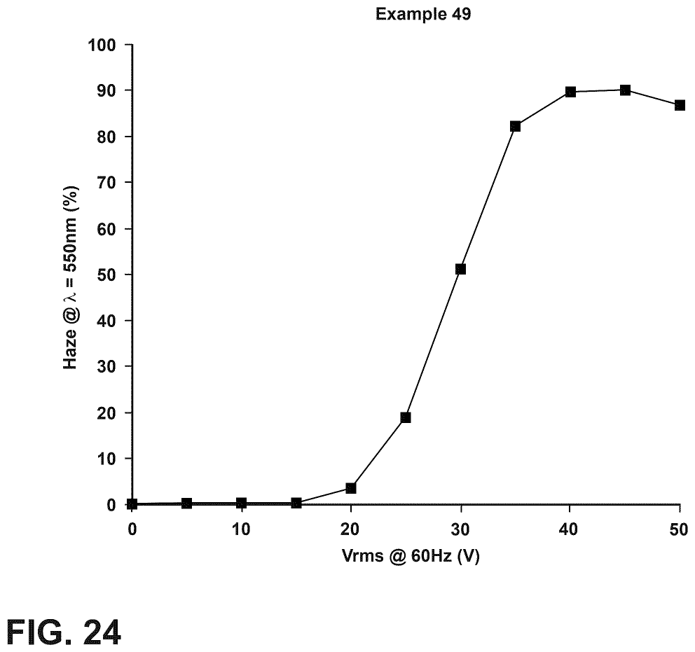

A voltage sweeps for the smart window article of Example 49 were conducted from a no voltage state to working voltages up to 50 V. The transmittance and haze at each voltage were measured. The results are set forth in the graphs reproduced at FIGS. 23 and 24. The graph showing transmittance as a function of voltage illustrates that transmittance changed to a large degree in response to the working voltage. The graph showing haze as a function of voltage illustrates that smart window articles of Example 49 exhibited a tunable haze as a function of working voltage, with haze values over 80% achievable at higher voltages.

Examples 51-56—For Examples 51-56, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal HNG-715600-100 and the positive liquid crystal HTG-135200-100. The weight percentage of the positive liquid crystal HTG-135200-100 varied from 1 wt % to 20 wt %, as set forth in Table 17 below. No chiral dopant or dichroic dye was included. The negative liquid crystal was the balance of the liquid crystal layer. No separate polymeric material was included in the liquid crystal layer.

TABLE 17

| Ex. | Alignment | Neg. LC | Pos. LC (wt %) | T(0 V) | H(0 V) | Vₒₙ | | T(Vₒₙ) | H(Vₒₙ) |
|---|---|---|---|---|---|---|---|---|---|
| 51 | Vertical | HNG-715600-100 | HTG-135200-100 1% | ~90% | <1% | 30 | V | 73% | <50% |
| 52 | Vertical | HNG-715600-100 | HTG-135200-100 5% | ~90% | <1% | 30 | V | 77% | <50% |
| 53 | Vertical | HNG-715600-100 | HTG-135200-100 7% | ~90% | <1% | 22.5 | V | 58% | <50% |
| 54 | Vertical | HNG-715600-100 | HTG-135200-100 10% | ~90% | <1% | 20 | V | 57% | <50% |
| 55 | Vertical | HNG-715600-100 | HTG-135200-100 20% | ~90% | 0.2% | 30 | V | 17% | 78% |
| 56 | Vertical | HNG-715600-100 | HTG-135200-100 20% | ~90% | 0.2% | 35 | V | 10% | 82% |

The transmittance (“T(0V)”) and haze (“H(0V)”) through each of the smart window articles without any voltage applied across the liquid crystal layer were determined. The smart window articles exhibited a transmittance of about 90%. In addition, the smart window articles exhibited a haze of less than 1%, with Example 55 exhibiting a haze of 0.2%.

A working voltage (“Vₒₙ”) was then applied to each of the smart window articles, which subjected the liquid crystal layer thereof to the working voltage. The working voltage applied ranged from 22.5 V to 35 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused at least the smart window article of Examples 55 and 56 to exhibit a haze of 78% and 82% respectively. For Examples 55 and 56, a substantial decrease to 17% and 10% respectively in transmittance accompanied the change in haze from the no voltage state to the privacy state of application of the working voltage.

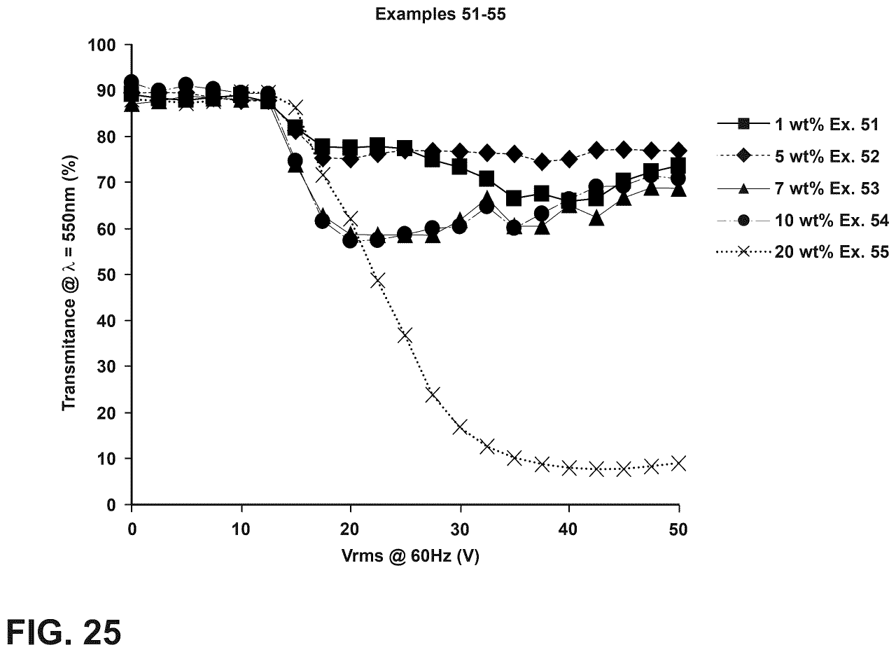

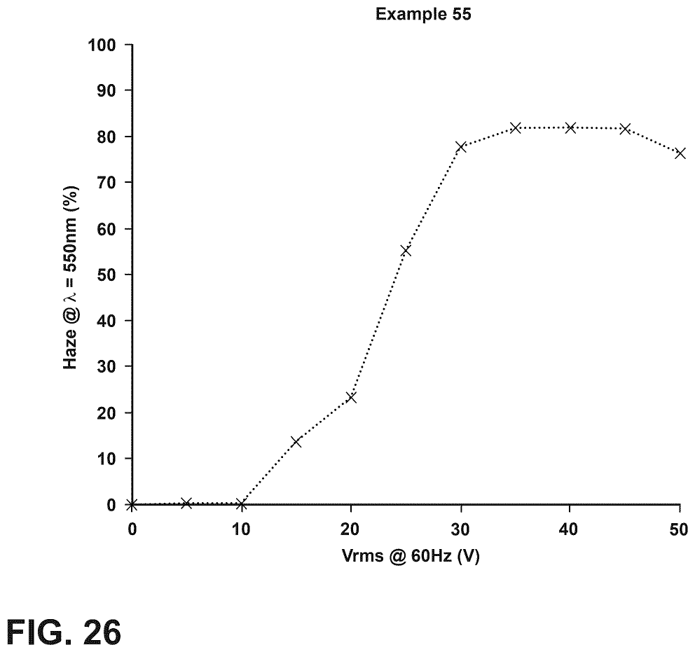

Voltage sweeps for the smart window article of Examples 51-55 were conducted from a no voltage state to working voltages up to 50 V. The transmittance and haze at each voltage were measured. The results are set forth in the graphs reproduced at FIGS. 25 and 26. The graph showing transmittance as a function of voltage illustrates that Example 55 with the 20 wt % positive liquid crystal exhibited a large decrease in transmittance as a function of increase in the working voltage. The graph showing haze as a function of voltage illustrates that the smart window article of Example 55 exhibited a tunable haze as a function of working voltage, with haze values over 70% and even 80% achievable at higher voltages.

Examples 57-62—For Examples 57-62, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal MLC-2079 and the positive liquid crystal 5CB. The weight percentage of the positive liquid crystal HTG-135200-100 varied from 10 wt to 20 wt %, as set forth in Table 18 below. No chiral dopant or dichroic dye was included. The negative liquid crystal was the balance of the liquid crystal layer. No separate polymeric material was included in the liquid crystal layer.

TABLE 18

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 57 | Vertical | MLC-2079 | 5CB 10% | ~90% | 0.1% | 30 V | 27% | 58% |
| 58 | Vertical | MLC-2079 | 5CB 12.5% | ~90% | 0.2% | 30 V | 9% | 72% |
| 59 | Vertical | MLC-2079 | 5CB 12.5% | ~90% | 0.2% | 45 V | 6% | 83% |
| 60 | Vertical | MLC-2079 | 5CB 15% | ~90% | 0.1% | 30 V | 15% | 71% |
| 61 | Vertical | MLC-2079 | 5CB 15% | ~90% | 0.1% | 45 V | 10% | 84% |
| 62 | Vertical | MLC-2079 | 5CB 20% | ~90% | <0.3% | 30 V | 87% | <10% |

The transmittance (“T(0V)”) and haze (“H(0V)”) through each of the smart window articles without any voltage applied across the liquid crystal layer were determined. The smart window articles exhibited a transmittance of about 90%. In addition, the smart window articles exhibited a haze of less than 0.3%.

A working voltage (“Vₒₙ”) was then applied to each of the smart window articles, which subjected the liquid crystal layer thereof to the working voltage. The working voltage applied ranged from 30 V to 45 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused at least the smart window article of Examples 57-61 to exhibit a haze of at least 58%, with Examples 58-61 exhibiting a haze ranging from 71% to 83%. For Examples 58-61, a substantial decrease to 15% or less in transmittance accompanied the change in haze from the no voltage state to the privacy state of application of the working voltage.

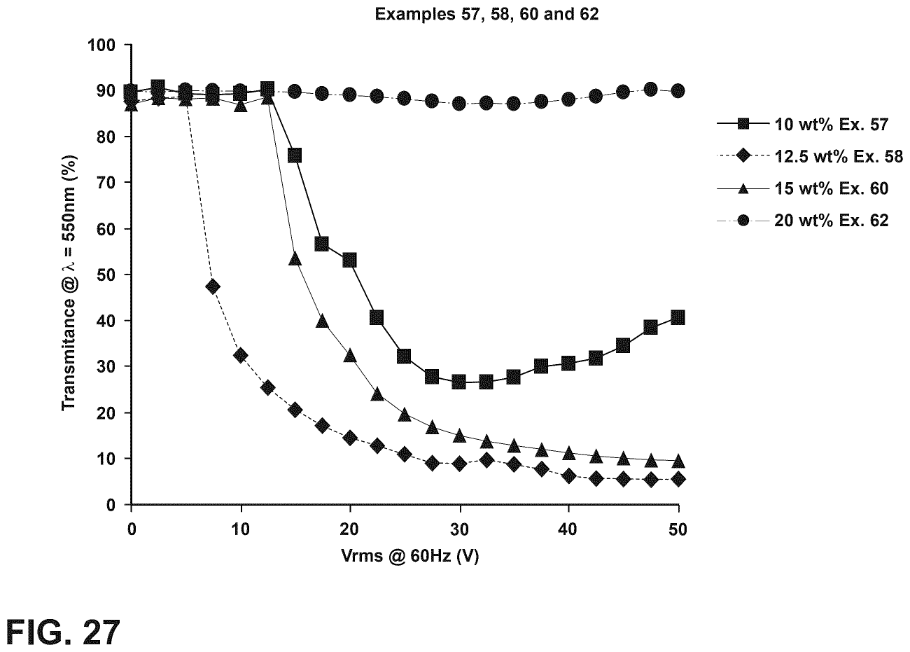

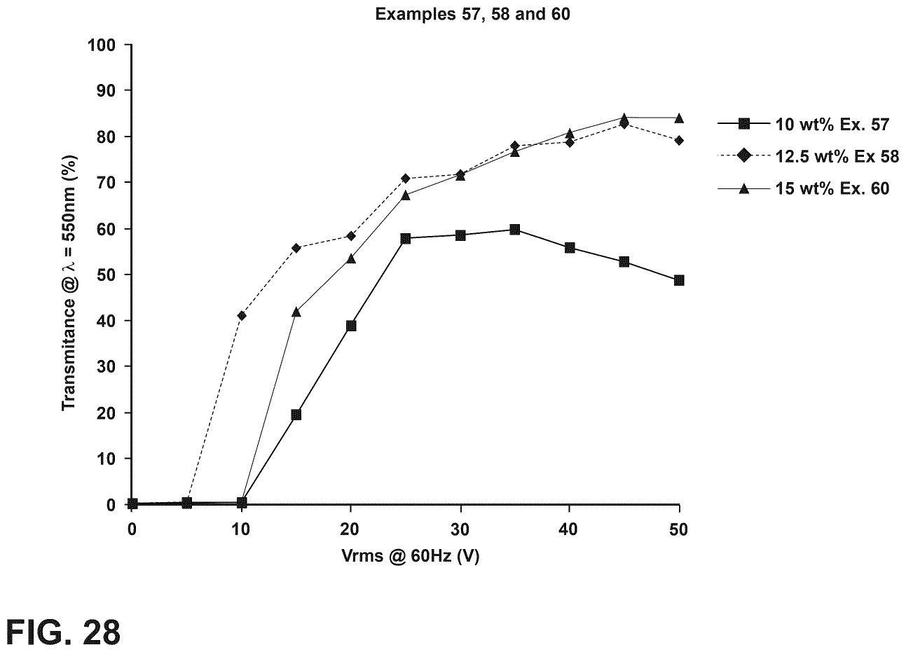

Voltage sweeps for the smart window article of Examples 57, 58, 60, and 62 were conducted from a no voltage state to working voltages up to 50 V. The transmittance and haze at each voltage were measured. The results are set forth in the graphs reproduced at FIGS. 27 and 28. The graph showing transmittance as a function of voltage illustrates that Examples 58 and 60 with the higher weight percentages of the positive liquid crystal exhibited a large decrease in transmittance as a function of increase in the working voltage. The graph showing haze as a function of voltage illustrates that smart window articles of Examples 58 and 60 exhibited a tunable haze as a function of working voltage, with haze values over 70% and even 80% achievable at higher voltages.

Examples 63-65—For Examples 63-65, smart window articles were fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal MLC-2079 and the positive dimeric liquid crystal CB5CB. The weight percentage of the positive liquid crystal CB5CB was either 7.5 wt % or 10 wt %, as set forth in Table 19 below. No chiral dopant or dichroic dye was included. The negative liquid crystal was the balance of the liquid crystal layer. No separate polymeric material was included in the liquid crystal layer.

TABLE 19

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 63 | Vertical | MLC-2079 | CB5CB 7.5% | ~90% | 0.1% | 30 V | 26% | 71% |
| 64 | Vertical | MLC-2079 | CB5CB 7.5% | ~90% | 0.1% | 45 V | 8% | 84% |
| 65 | Vertical | MLC-2079 | CB5CB 10% | ~90% | 0.2% | 30 V | 6% | 90% |

The transmittance (“T(0V)”) and haze (“H(0V)”) through each of the smart window articles without any voltage applied across the liquid crystal layer were determined. The smart window articles exhibited a transmittance of about 90%. In addition, the smart window articles exhibited a haze of 0.2% or less. Thus, Examples 63-65 exhibited a much lower haze in the transparent or clear state (no voltage state) than the Comparative Examples 1-4 above.

A working voltage (“Vₒₙ”) was then applied to each of the smart window articles, which subjected the liquid crystal layer thereof to the working voltage. The working voltage applied ranged from 30 V to 45 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused at least the smart window article of Examples 63-65 to exhibit a haze of at least 71%, with Examples 64 and 65 exhibiting a haze of 84% and 90% respectively. For Examples 63-65, a substantial decrease to 26% or less in transmittance accompanied the change in haze from the no voltage state to the privacy state of application of the working voltage.

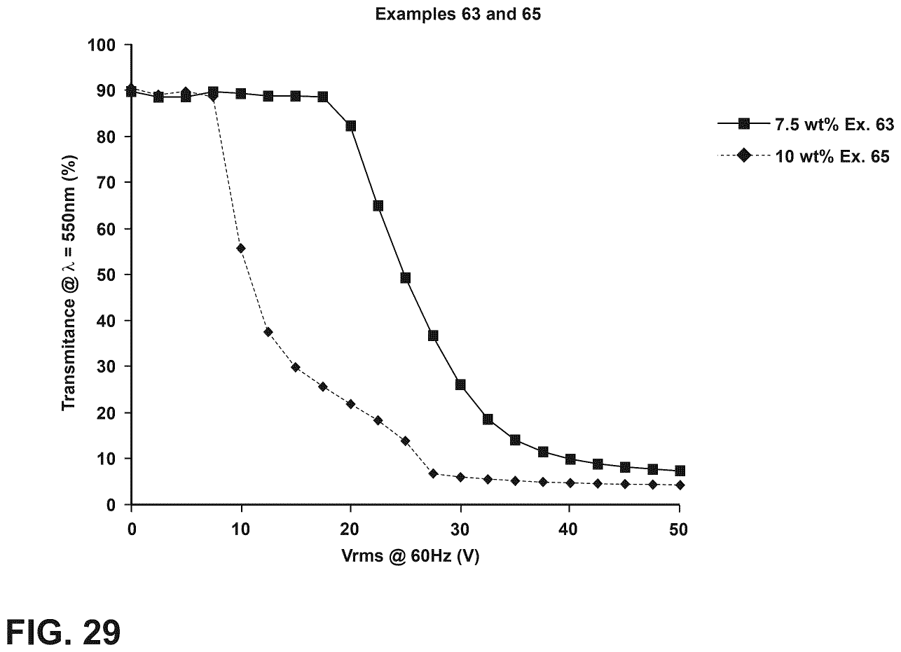

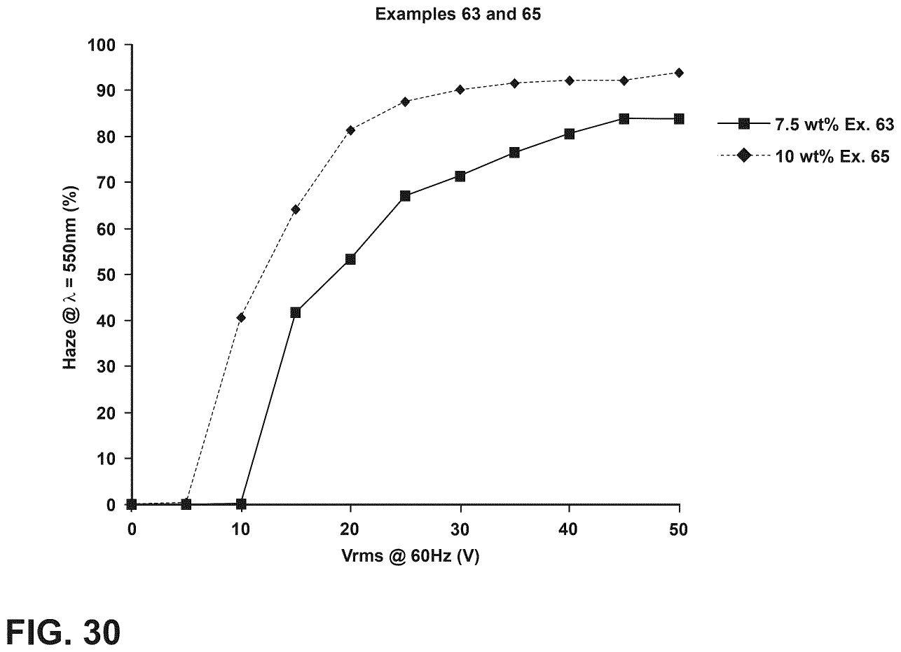

Voltage sweeps for the smart window article of Examples 63 and 65 were conducted from a no voltage state to working voltages up to 50 V. The transmittance and haze at each voltage were measured. The results are set forth in the graphs reproduced at FIGS. 29 and 30. The graph showing transmittance as a function of voltage illustrates that the smart window articles exhibited a large decrease in transmittance as a function of increase in the working voltage. The graph showing haze as a function of voltage illustrates that the smart window articles exhibited a tunable haze as a function of working voltage, with haze values over 70% and even 90% achievable at higher voltages. The graph of haze for Example 63 shows that a haze greater than 80% is achievable at a working voltage of only 20 V. Example 63 can be considered exemplary of the smart window articles of the present disclosure.

Example 66—For Example 66, a smart window article was fabricated similar to those of the Examples above. Again, the polyimide alignment layers of each of the smart window articles were rubbed to induce vertical alignment of molecules of the liquid crystal layer. The liquid crystal layer was a combination of the negative nematic liquid crystal MLC-2079 and the positive liquid crystal 8CB. The weight percentage of the positive liquid crystal 8CB was 7.5 wt %, as set forth in Table 20 below. No chiral dopant or dichroic dye was included. The negative liquid crystal was the balance of the liquid crystal layer. No separate polymeric material was included in the liquid crystal layer.

TABLE 20

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 66 | Vertical | MLC-2079 | 8CB 7.5% | ~90% | <1% | 30 V | 20% | <50% |

The transmittance (“T(0V)”) and haze (“H(0V)”) through the smart window articles without any voltage applied across the liquid crystal layer were determined. The smart window article exhibited a transmittance of about 90%. In addition, the smart window article exhibited a haze of less than 1%.

A working voltage (“Vₒₙ”) was then applied to the smart window article, which subjected the liquid crystal layer thereof to the working voltage. The working voltage applied was 30 V, as set forth in the table above.

The transmittance (“T(Vₒₙ)”) and haze (“H(Vₒₙ)”) through the smart window article with the working voltage applied across the liquid crystal layer were determined. The application of the working voltage caused the smart window article of Example 66 to exhibit a haze of less than 50%. A substantial decrease to 20% in transmittance accompanied the change in haze from the no voltage state to the privacy state of application of the working voltage.

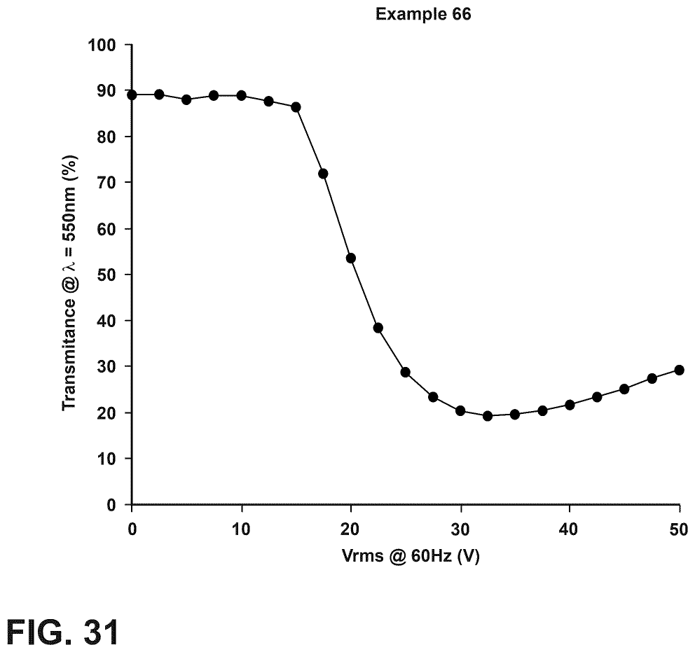

A voltage sweep for the smart window article of Example 66 was conducted from a no voltage state to working voltages up to 50 V. The transmittance at each voltage was measured. The results are set forth in the graph reproduced at FIG. 31. The graph showing transmittance as a function of voltage illustrates that the smart window article exhibited a large decrease in transmittance as a function of increase in the working voltage.

Examples 67-79—For Examples 67-79, smart window articles were fabricated similar to those of the Comparative Examples above. However, the polyimide alignment layers of each of the smart window articles were rubbed to induce parallel alignment of molecules of the liquid crystal layer. In addition, the liquid crystal layer was a combination of the negative nematic liquid crystal HNG-715600-100 and positive nematic liquid crystal 5CB. The weight percentage of the positive liquid crystal in the liquid crystal layer varied, as indicated in Table 21 below. The negative liquid crystal was the balance of the liquid crystal layer. No separate polymeric material was included in the liquid crystal layer. No chiral dopant or dichroic dye was included in the liquid crystal layer.

TABLE 21

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 67 | Parallel | HNG-715600-100 | 5CB 1% | ~90% | <1% | 30 V | 32% | <60% |
| 68 | Parallel | HNG-715600-100 | 5CB 5% | ~90% | <1% | 30 V | 25% | <60% |
| 69 | Parallel | HNG-715600-100 | 5CB 7.5% | ~90% | <1% | 30 V | 24% | <60% |
| 70 | Parallel | HNG-715600-100 | 5CB 10% | ~90% | <1% | 30 V | 36% | <60% |
| 71 | Parallel | HNG-715600-100 | 5CB 15% | ~90% | 0.5% | 30 V | 14% | 74% |
| 72 | Parallel | HNG-715600-100 | 5CB 20% | ~90% | 0.7% | 30 V | 9% | 83% |
| 73 | Parallel | HNG-715600-100 | 5CB 25% | ~90% | 0.6% | 30 V | 10% | 80% |
| 74 | Parallel | HNG-715600-100 | 5CB 25% | ~90% | 0.6% | 40 V | 4% | 91% |
| 75 | Parallel | HNG-715600-100 | 5CB 30% | ~90% | 0.5% | 30 V | 13% | 78% |
| 76 | Parallel | HNG-715600-100 | 5CB 30% | ~90% | 0.5% | 50 V | 5% | 91% |
| 77 | Parallel | HNG-715600-100 | 5CB 40% | ~90% | <1% | 30 V | 89% | N/A |
| 78 | Parallel | HNG-715600-100 | 5CB 50% | ~90% | <1% | 30 V | 87% | N/A |
| 79 | Parallel | HNG-715600-100 | 5CB 90% | ~90% | <1% | 30 V | 89% | N/A |

Dielectric anisotropy and viscosity of some of the liquid crystal layers of Examples 67-79 were measured. The results are set forth in Table 21A below:

TABLE 21A

| 5CB | HNG-715600-100-100 | | η |
|---|---|---|---|
| (wt %) | (wt %) | Δε | (mPa · s) |
| 0.0 | 100.0 | −11.8 | 107.7 |
| 1.2 | 98.8 | −11.7 | — |
| 10.0 | 90.0 | −8.5 | — |
| 15.0 | 85.0 | −6.0 | — |
| 20.3 | 79.7 | −3.5 | 74.1 |
| 25.1 | 74.9 | −2.2 | 69.1 |
| 30.4 | 69.6 | −0.1 | 65.0 |
| 40.7 | 59.3 | 3.1 | — |
| 49.9 | 50.1 | 5.5 | — |
| 88.9 | 11.1 | 11.8 | — |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 100. Thus, all the Examples 67-79 exhibited a similar low haze in the transparent or clear state (no voltage state) as the Comparative Examples 1-4 above.

A working voltage (“Vₒₙ”) was then applied to each of the smart window articles, which subjected the liquid crystal layer thereof to the working voltage. The working voltage applied was either 30 V, 40 V, or 50 V as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles of Examples 71-76 to exhibit a haze of greater than 70%, with several examples exhibiting a haze of greater than 90%. The haze exhibited generally increased with increasing weight percentage of positive liquid crystal, up to a certain point. For Examples 71-76, a large change in transmittance accompanied the large change in haze from the no voltage state to the privacy state of application of the working voltage, with the transmittance exhibited ranging from 5% to 15%. When subjected to the working voltage of 25 V, the smart window article of Example 6 exhibited a transmittance of just 14% and a haze of 78%.

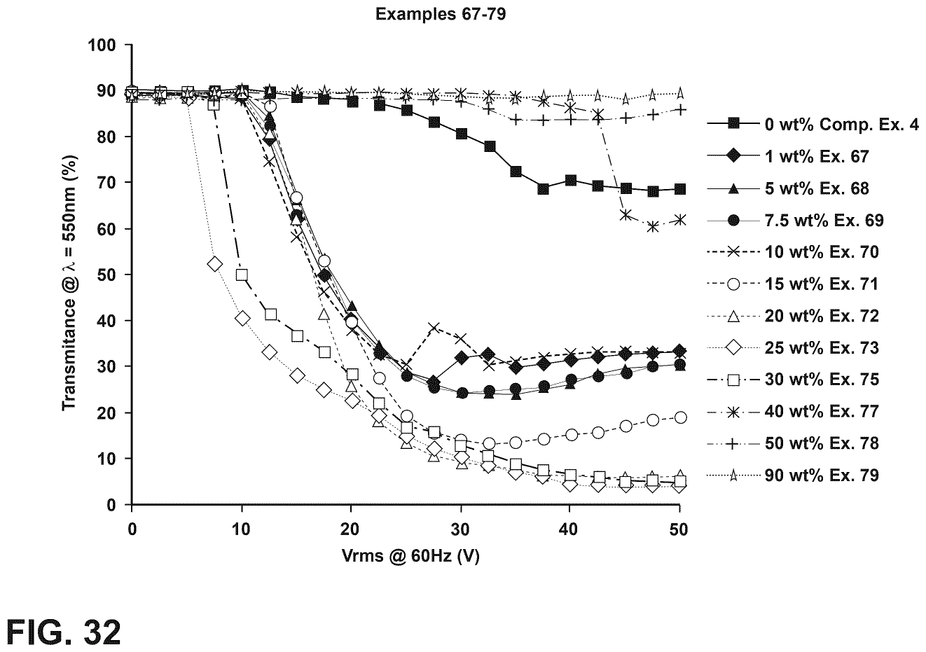

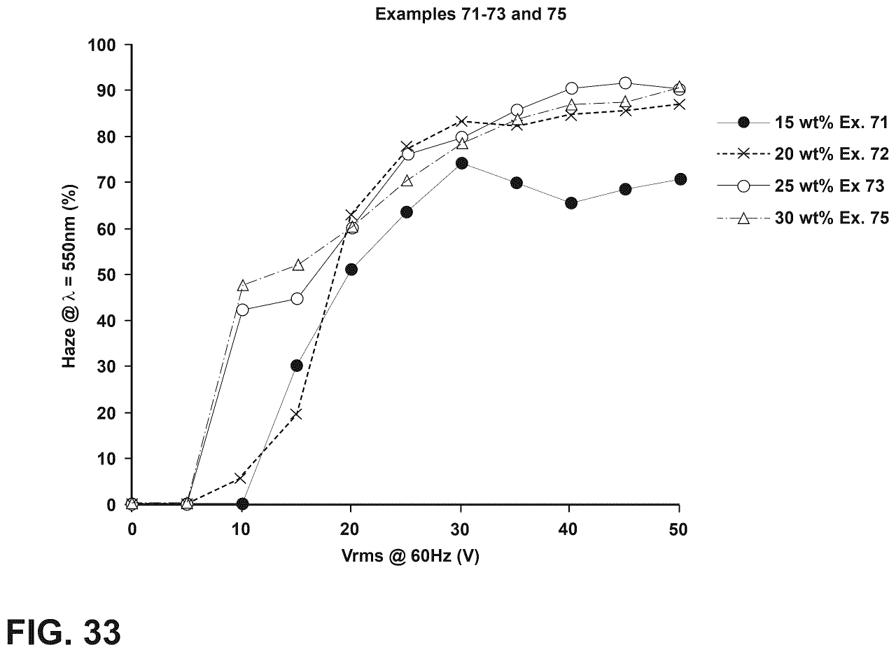

Voltage sweeps for the smart window articles of each of the Examples 67-79 were conducted from a no voltage state to working voltages up to 50 V. The transmittance and haze at each voltage were measured. The results are set forth in the graphs reproduced at FIGS. 32 and 33. Results for Comparative Example 41 (0 wt % of positive liquid crystal) are included as well. The graph showing transmittance as a function of voltage illustrates that transmittance exhibited does not change much if at all when the weight percentage of the positive liquid crystal is 0 wt % or is greater than or equal to 40 wt % but otherwise shows large transmittance change as a function of working voltage. Without being bound by theory, it is believed that when the effective Δε of the liquid crystal layer is greater than 0, then the threshold working voltage to cause light scattering is beyond the working voltages tested. The graph showing haze as a function of voltage illustrates that smart window articles of Examples 72, 73, and 75 (20 wt %, 25 wt %, and 30 wt % respectively) exhibited relatively high haze values (greater than 70%) at a working voltage of 25 V (and it could reasonably be assumed to be about the same at 24 V). Examples 72, 73, and 75 may be considered to be exemplary smart window articles of the present disclosure.

To explain the improvement in the scattering state in the liquid crystal layers of the present disclosure, it is proposed that the electric field induces a vortex flow of the negative nematic liquid crystal (n-NLC), imparted by the electroconvection of ions in the system. Meanwhile, the interaction with the electric field maintains the positive nematic liquid crystal (p-NLC) parallel to the field direction. As a consequence, the p-NLC interrupts the vortex motion of the n-NLC, resulting in turbulent flow which is evidenced by the enhanced scattering of incident light. In parallel aligned cells, as the voltage is increased, the n-NLC remains aligned along the substrate until the onset of EHDI while the p-NLC tilts toward the electric field direction, undergoing the Fréedericksz transition before becoming fully parallel to the electric field. In vertically aligned cells, the n-NLC first undergoes the Fréedericksz transition to become perpendicular to the electric field direction before the onset of the EHDI, while the p-NLC remains parallel to the field as the voltage is increased.

As the concentration of 5CB is increased from 1 wt % to 20 wt %, the domain size of the scattering centers becomes smaller. Consider the p-NLC molecules as posts in the path of the cylindrical vortex flow fields of the n-NLC. Higher concentrations of the p-NLC implies an increase in the locations at which the flow of the n-NLC can be interrupted. This translates into the transmittance becoming lower (and haze increasing), e.g., an improvement in the scattering of the DSM. However, there seems to be a saturation point beyond which the DSM is only marginally improved when the concentration of 5CB is increased.

For one or more of the Examples, the onset of the scattering state is at a much higher voltage, and for other of the Examples scattering is altogether absent. The threshold voltage, Vth, for the initiation of EHDI depends on several material parameters. For planar alignment the derived threshold voltage is given by the equation:

$${V}_{t h} = \sqrt{\frac{4 {π}^{3} {K}_{33}}{Δ ε ( \frac{{σ}_{‖}}{{σ}_{⊥}} ) - ( \frac{{α}_{3}}{{η}_{1}} ) {ε}_{‖} ( \frac{{σ}_{‖}}{{σ}_{⊥}} - \frac{{ε}_{‖}}{{ε}_{⊥}} )}}$$

where K₃₃ is the bend elastic constant, α₃ is a Leslie friction coefficient, and η₁ is the viscosity in the direction normal to the flow direction. All these parameters including the conductivity and dielectric constants change when a mixture is made. The salient decrease in the Vth for some of the examples is evidence for a significant change in the materials properties, unlike other of the examples for which the threshold is relatively unchanged. When Δε_{eff}<0, scattering is observed at Vth equal to or less than that of the neat n-NLC component, whereas Vth is markedly increased when Δε_{eff}>0. For neat 5CB, Vth is about 110 V (for an AC frequency of 50 Hz), so it is likely that when Δε_{eff}>0, Vₜₕ skews towards that of 5CB such that for some of the examples, if scattering occurs, it is well beyond the observation voltage range. Another possible explanation for the delayed scattering of one of the examples (and lack thereof for other of the examples) is that the proportion of p-NLC molecules significantly overwhelms that of the n-NLC, so that the interaction of the p-NLC with the electric field is enough to suppress the EHDI of the n-NLC.

Examples 80-84—For Examples 80-84, smart window articles were fabricated similar to those of Examples 67-79 above. The polyimide alignment layers of each of the smart window articles were rubbed to induce parallel alignment of molecules of the liquid crystal layer. In addition, the liquid crystal layer was a combination of the negative nematic liquid crystal HNG-715600-100 and the positive dimeric liquid crystal CB5CB. The weight percentage of the positive liquid crystal in the liquid crystal layer varied, as indicated in Table 22 below. The negative liquid crystal was the balance of the liquid crystal layer. No separate polymeric material was included in the liquid crystal layer. No chiral dopant or dichroic dye was included in the liquid crystal layer.

TABLE 22

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 80 | Parallel | HNG-715600-100 | CB5CB 5% | ~90% | 0.5% | 30 V | 25% | 58% |
| 81 | Parallel | HNG-715600-100 | CB5CB 7.5% | ~90% | 0.5% | 30 V | 30% | 60% |
| 82 | Parallel | HNG-715600-100 | CB5CB 7.5% | ~90% | 0.5% | 50 V | 12% | 79% |
| 83 | Parallel | HNG-715600-100 | CB5CB 10% | ~90% | 0.4% | 30 V | 28% | 69% |
| 84 | Parallel | HNG-715600-100 | CB5CB 10% | ~90% | 0.4% | 45 V | 7% | 87% |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of 0.5% or less.

A working voltage (“Vₒₙ”) was then applied to each of the smart window articles, which subjected the liquid crystal layer thereof to the working voltage. The working voltage applied was either 30 V, 45 V, or 50 V as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles of Examples 80-84 to exhibit a haze ranging from 58% to 87%, with Examples 82 and 84 exhibiting haze values of 79% and 87% respectively. A large change in transmittance accompanied the large change in haze from the no voltage state to the privacy state of application of the working voltage, with the transmittance exhibited ranging from 7% to 30%.

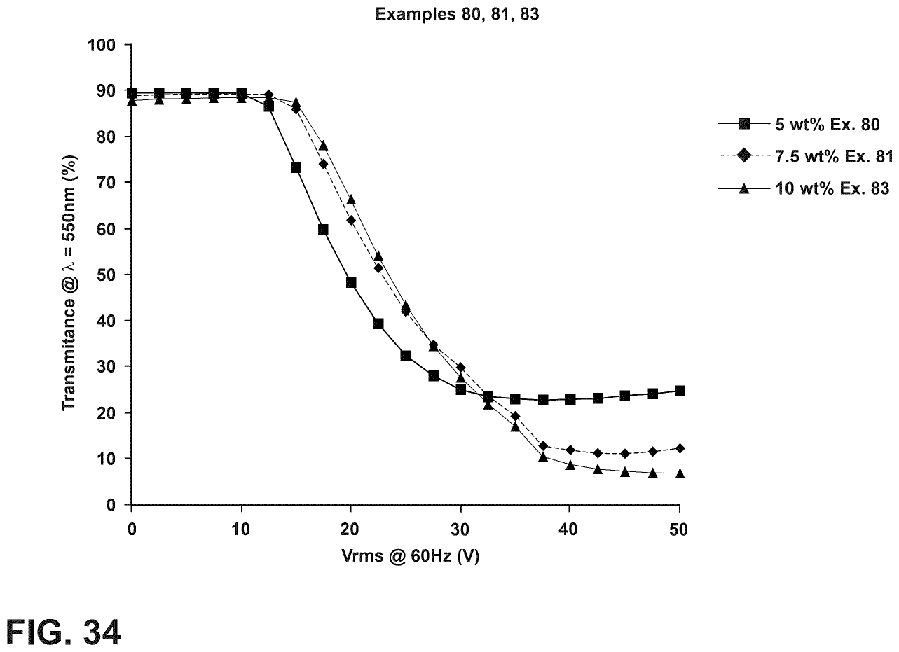

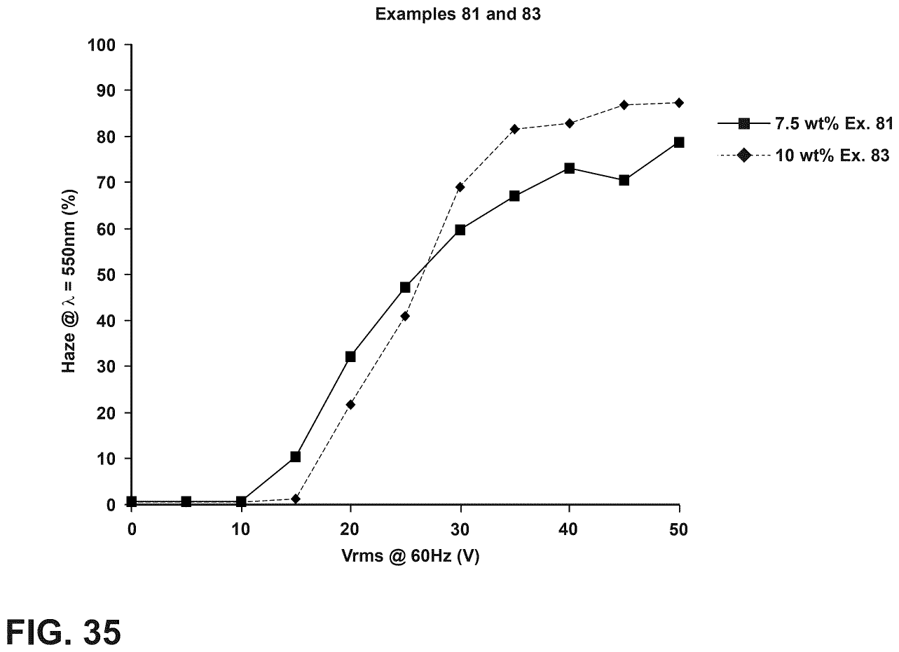

Voltage sweeps for the smart window articles of each of Examples 80-84 were conducted from a no voltage state to working voltages up to 50 V. The transmittance and haze at each voltage were measured. The results are set forth in the graphs reproduced at FIGS. 34 and 35. The graph showing transmittance as a function of voltage illustrates that large changes in transmittance as a function of voltage can be achieved. The graph showing haze as a function of voltage illustrates that haze values of greater than or equal to 7000 can be achieved at higher voltages for Examples 81 and 83.

Examples 85-89—For Examples 85-89, smart window articles were fabricated similar to those of Examples 67-79 above. The polyimide alignment layers of each of the smart window articles were rubbed to induce parallel alignment of molecules of the liquid crystal layer. In addition, the liquid crystal layer was a combination of the negative nematic liquid crystal HNG-715600-100 and positive liquid crystal 5CB. The weight percentage of the positive liquid crystal in the liquid crystal layer for each example was 20 wt %. The negative liquid crystal further included a dichroic dye, the weight percentage of which varied, as indicated in Table 23 below. The negative liquid crystal was the balance of the liquid crystal layer. No separate polymeric material was included in the liquid crystal layer. No chiral dopant was included in the liquid crystal layer.

TABLE 23

| | | | Pos. LC | Dichroic | | | | | |
|---|---|---|---|---|---|---|---|---|---|
| Ex. | Alignment | Neg. LC | (wt %) | Dye (wt %) | T(0 V) | H(0 V) | Vₒₙ | T(Vₒₙ) | H(Vₒₙ) |
| 85 | Parallel | HNG-715600-100 | 5CB 20% | M1012 0.5% | 58% | 0.4% | 30 V | 8% | 78% |
| 86 | Parallel | HNG-715600-100 | 5CB 20% | M1012 0.5% | 58% | 0.4% | 35 V | 8% | 81% |
| 87 | Parallel | HNG-715600-100 | 5CB 20% | M1012 1% | 37% | 0.7% | 30 V | 6% | 64% |
| 88 | Parallel | HNG-715600-100 | 5CB 20% | M1012 2% | 25% | 0.4% | 30 V | 4% | 50% |
| 89 | Parallel | HNG-715600-100 | 5CB 20% | M1012 3% | 21% | 0.5% | 30 V | 3% | 81% |

The transmittance (“T(0V)”) and haze (“H(0V)”) through each of the smart window articles without any voltage applied across the liquid crystal layer were determined. The inclusion of the dichroic dye decreased the transmittance exhibited in the no voltage state, with the transmittance ranging from 21% to 58%. All the smart window articles exhibited a haze of 0.7% or less.

A working voltage (“Vₒₙ”) was then applied to each of the smart window articles, which subjected the liquid crystal layer thereof to the working voltage. The working voltage applied was either 30 V or 35 V as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles of Examples 85-89 to exhibit a haze ranging from 50% to 81%, with Examples 86 and 89 both exhibiting haze values of 81%. A large change in transmittance accompanied the large change in haze from the no voltage state to the privacy state of application of the working voltage, with the transmittance exhibited ranging from 3% to 8%.

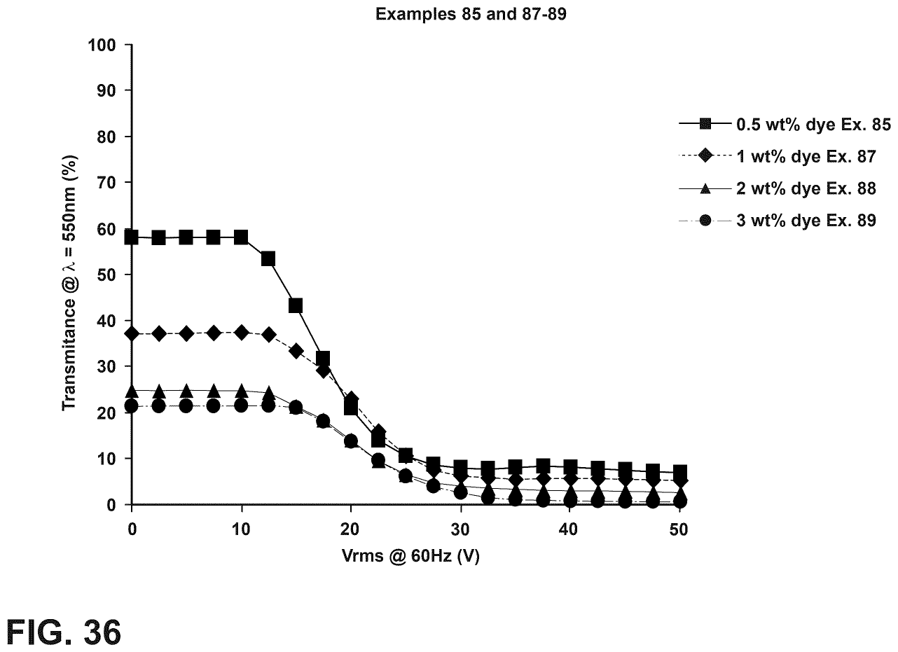

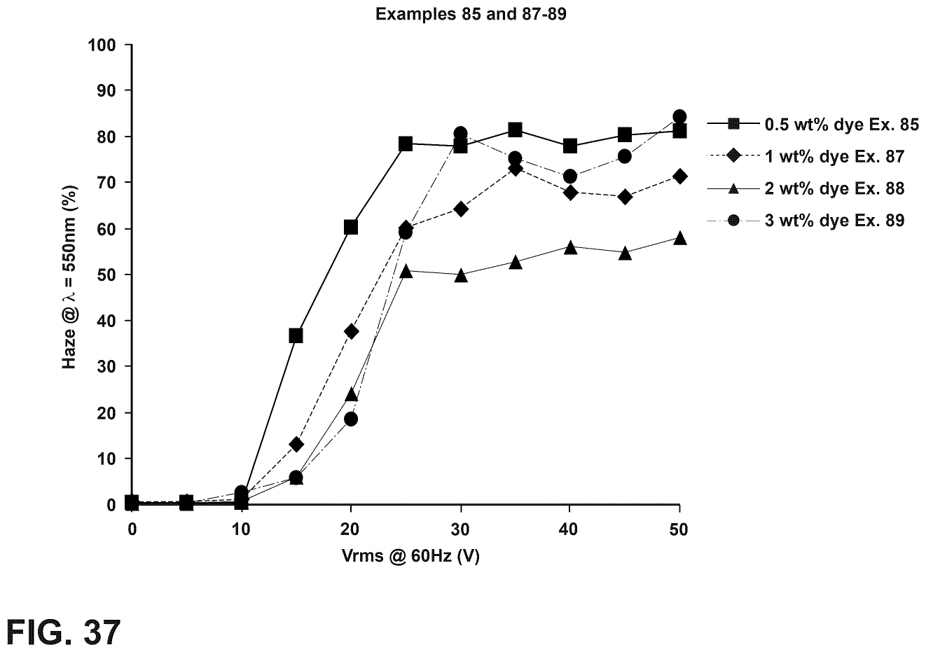

Voltage sweeps for the smart window articles of each of Examples 85-89 were conducted from a no voltage state to working voltages up to 50 V. The transmittance and haze at each voltage were measured. The results are set forth in the graphs reproduced at FIGS. 36 and 37. The graph showing transmittance as a function of voltage illustrates that large changes in transmittance as a function of voltage can be achieved, with Example 85 (0.5 wt % dichroic dye) exhibiting the highest no voltage transmittance. The graph showing haze as a function of voltage illustrates that haze values of greater than or equal to 70% can be achieved at higher voltages for all but Example 88. Example 85 (0.5 wt % dichroic dye) exhibited a haze of just under 80% at a working voltage of 25 V, indicating that a haze of over 70% can reasonably be assumed for a working voltage of 24 V. Example 85 may be considered to be an exemplary smart window article of the present disclosure.

Examples 90-93—For Examples 90-93, smart window articles were fabricated similar to those of Examples 67-79 above. The polyimide alignment layers of each of the smart window articles were rubbed to induce parallel alignment of molecules of the liquid crystal layer. In addition, the liquid crystal layer was a combination of the negative nematic liquid crystal HNG-715600-100 and positive liquid crystal 5CB. The weight percentage of the positive liquid crystal in the liquid crystal layer for each example was 20 wt %. The negative liquid crystal further included a chiral dopant, the weight percentage of which varied as needed to induce a half twist (“0.5 T”) or a full twist (“1T”), as indicated in Table 24 below. The negative liquid crystal was the balance of the liquid crystal layer. No separate polymeric material was included in the liquid crystal layer. No dichroic dye was included in the liquid crystal layer.

TABLE 24

| | | | | Chiral | | | | | |
|---|---|---|---|---|---|---|---|---|---|
| | | | Pos. LC | dopant | | | | | |
| Ex. | Alignment | Neg. LC | (wt %) | (twist) | T(0 V) | H(0 V) | Vₒₙ | T(Vₒₙ) | H(Vₒₙ) |
| 90 | Parallel | HNG-715600-100 | 5CB 20% | CB-15, 0.5T | ~90% | 0.9% | 30 V | 9% | 84% |
| 91 | Parallel | HNG-715600-100 | 5CB 20% | CB-15, 1T | ~90% | 0.6% | 30 V | 7% | 84% |
| 92 | Parallel | HNG-715600-100 | 5CB 20% | R-811, 0.5T | ~90% | 0.6% | 30 V | 8% | 83% |
| 93 | Parallel | HNG-715600-100 | 5CB 20% | R-811, 1T | ~90% | 0.4% | 30 V | 9% | 81% |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 0.9%.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles of Examples 90-93 to exhibit a haze ranging from 810% to 84%. A large change in transmittance accompanied the large change in haze from the no voltage state to the privacy state of application of the working voltage, with the transmittance exhibited ranging from 7% to 9%.

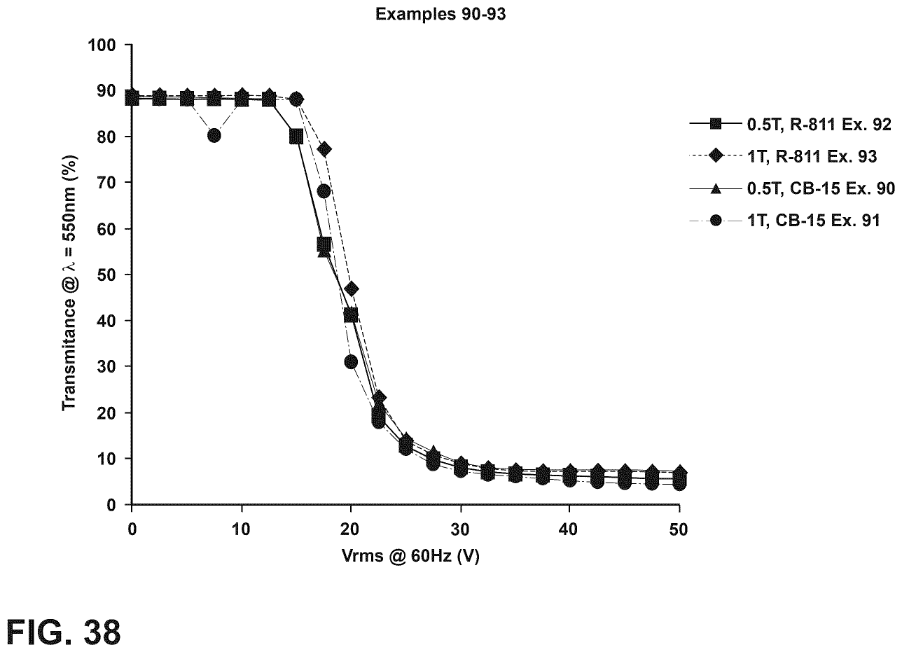

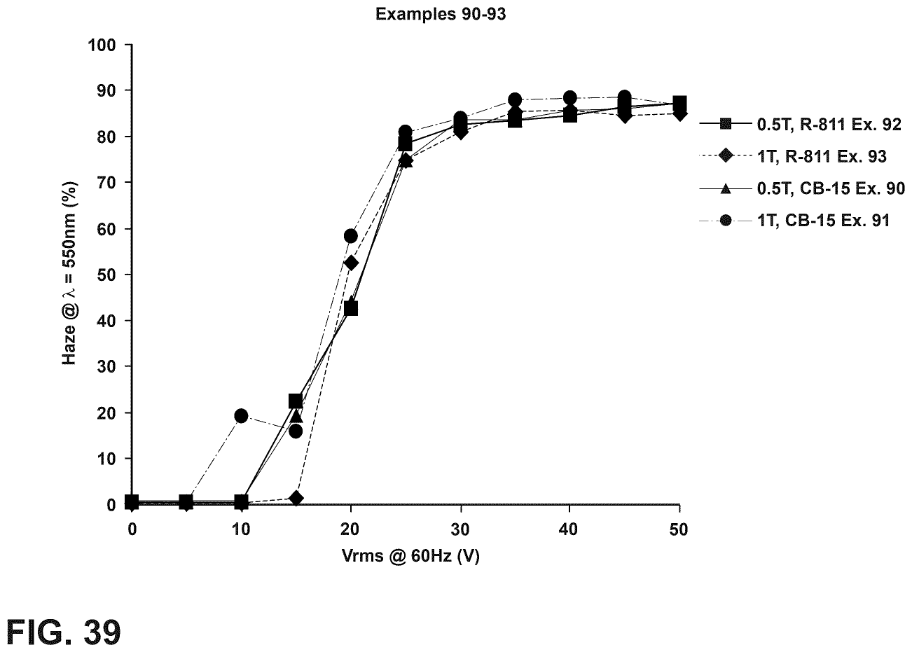

Voltage sweeps for the smart window articles of each of Examples 90-93 were conducted from a no voltage state to working voltages up to 50 V. The transmittance and haze at each voltage were measured. The results are set forth in the graphs reproduced at FIGS. 38 and 39. The graph showing transmittance as a function of voltage illustrates that large changes in transmittance as a function of voltage can be achieved. The graph showing haze as a function of voltage illustrates that smart window articles of all of Examples 90-93 exhibited relatively high haze values (greater than 70% or even 80%) at a working voltage of 25 V, indicating that a haze of over 70% can reasonably be assumed for a working voltage of 24 V. Examples 90-93 may be considered to be exemplary smart window articles of the present disclosure.

Examples 94-102—For Examples 90-102, smart window articles were fabricated similar to those of Examples 67-79 above. The polyimide alignment layers of each of the smart window articles were rubbed to induce parallel alignment of molecules of the liquid crystal layer. In addition, the liquid crystal layer was a combination of the negative nematic liquid crystal HNG-715600-100 and positive liquid crystal HTG-135200-100. The weight percentage of the positive liquid crystal in the liquid crystal layer varied from 1 wt % to 50%, as set forth in Table 25 below. The negative liquid crystal was the balance of the liquid crystal layer. No separate polymeric material was included in the liquid crystal layer. No dichroic dye or chiral dopant was included in the liquid crystal layer.

TABLE 25

| Ex. | Alignment | Neg. LC | Pos. LC (wt %) | T(0 V) | H(0 V) | Vₒₙ | T(Vₒₙ) | H(Vₒₙ) |
|---|---|---|---|---|---|---|---|---|
| 94 | Parallel | HNG-715600-100 | HTG-135200-100 1% | ~90% | <1% | 30 V | 47% | <80% |
| 95 | Parallel | HNG-715600-100 | HTG-135200-100 5% | ~90% | <1% | 30 V | 46% | <80% |
| 96 | Parallel | HNG-715600-100 | HTG-135200-100 7% | ~90% | <1% | 30 V | 36% | <80% |
| 97 | Parallel | HNG-715600-100 | HTG-135200-100 10% | ~90% | <1% | 30 V | 32% | <80% |
| 98 | Parallel | HNG-715600-100 | HTG-135200-100 20% | ~90% | 0.4% | 30 V | 22% | 82% |
| 99 | Parallel | HNG-715600-100 | HTG-135200-100 20% | ~90% | 0.4% | 40 V | 8% | 90% |
| 100 | Parallel | HNG-715600-100 | HTG-135200-100 25% | ~90% | <1% | 30 V | 87% | N/A |
| 101 | Parallel | HNG-715600-100 | HTG-135200-100 30% | ~90% | <1% | 30 V | 86% | N/A |
| 102 | Parallel | HNG-715600-100 | HTG-135200-100 50% | ~90% | <1% | 30 V | 89% | N/A |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 1%, with Example 98 exhibiting a haze of 0.40%.

A working voltage (“Vₒₙ”) was then applied to each of the smart window articles, which subjected the liquid crystal layer thereof to the working voltage. The working voltage applied was 30 V or 40 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles of Examples 98 and 99 to exhibit haze values of 82% and 90% respectively. For Examples 98 and 99, a large change in transmittance accompanied the large change in haze from the no voltage state to the privacy state of application of the working voltage, with the transmittance values being 22% and 8% respectively.

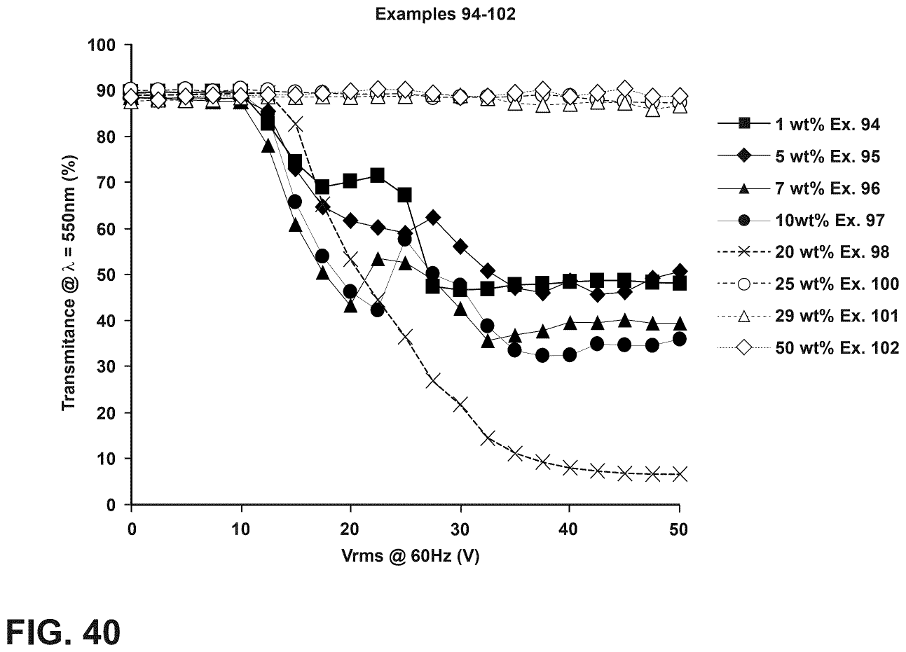

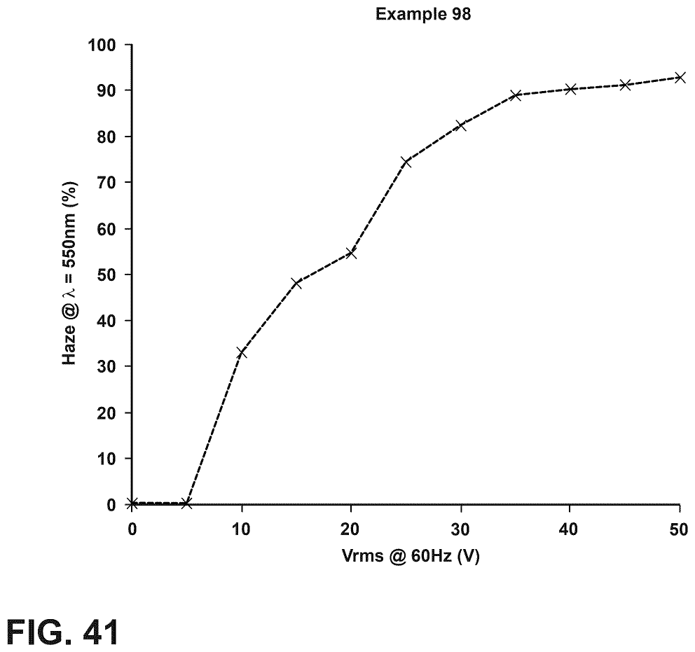

Voltage sweeps for the smart window articles of each of Examples 94-102 were conducted from a no voltage state to working voltages up to 50 V. The transmittance and haze at each voltage were measured. The results are set forth in the graphs reproduced at FIGS. 40 and 41. The graph showing transmittance as a function of voltage illustrates that large changes in transmittance as a function of voltage can be achieved when the weight percentage of the positive liquid crystal is less than or equal to 20 wt %. The change in transmittance as a function of working voltage for Example 102 was particularly large. The graph showing haze as a function of voltage for Example 98 illustrates that the smart window article exhibited relatively high haze values (greater than 70%) at a working voltage of 25 V, indicating that a haze of over 70% can reasonably be assumed for a working voltage of 24 V. Example 98 may be considered to be an exemplary smart window article of the present disclosure.

Examples 103-107—For Examples 103-107, smart window articles were fabricated similar to those of Examples 67-79 above. The polyimide alignment layers of each of the smart window articles were rubbed to induce parallel alignment of molecules of the liquid crystal layer. In addition, the liquid crystal layer was a combination of the negative nematic liquid crystal HNG-715600-100 and a positive liquid crystal, the specific compound of which varied by example, as set forth in Table 26 below. The weight percentage of the positive liquid crystal in the liquid crystal layer was constant at 20 wt %. The negative liquid crystal was the balance of the liquid crystal layer. No separate polymeric material was included in the liquid crystal layer. No dichroic dye or chiral dopant was included in the liquid crystal layer.

TABLE 26

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 103 | Parallel | HNG-715600-100 | BL006 20% | ~90% | 0.7% | 30 V | 9% | 82% |
| 104 | Parallel | HNG-715600-100 | E7 20% | ~90% | <1% | 30 V | 26% | <70% |
| 105 | Parallel | HNG-715600-100 | MLC-6080 | ~90% | <1% | 30 V | 39% | <70% |
| 106 | Parallel | HNG-715600-100 | MBBA 20% | ~90% | <1% | 30 V | 30% | <70% |
| 107 | Parallel | HNG-715600-100 | 8OCB 20% | ~90% | <1% | 30 V | 24% | <70% |

The transmittance (“T(0V)”) and haze (“H(0V)”) through each of the smart window articles without any voltage applied across the liquid crystal layer were determined. All of the smart window articles exhibited a transmittance of about 90%. In addition, all the smart window articles exhibited a haze of less than 1%, with Example 107 exhibiting a haze of 0.4%.

A working voltage (“Vₒₙ”) was then applied to each of the smart window articles, which subjected the liquid crystal layer thereof to the working voltage. The working voltage applied was 30 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles to exhibit haze values of less than 70% except for Example 103, which exhibited a haze value of 82%. For Example 103, a large change in transmittance accompanied the large change in haze from the no voltage state to the privacy state of application of the working voltage, with the transmittance values being 9%.

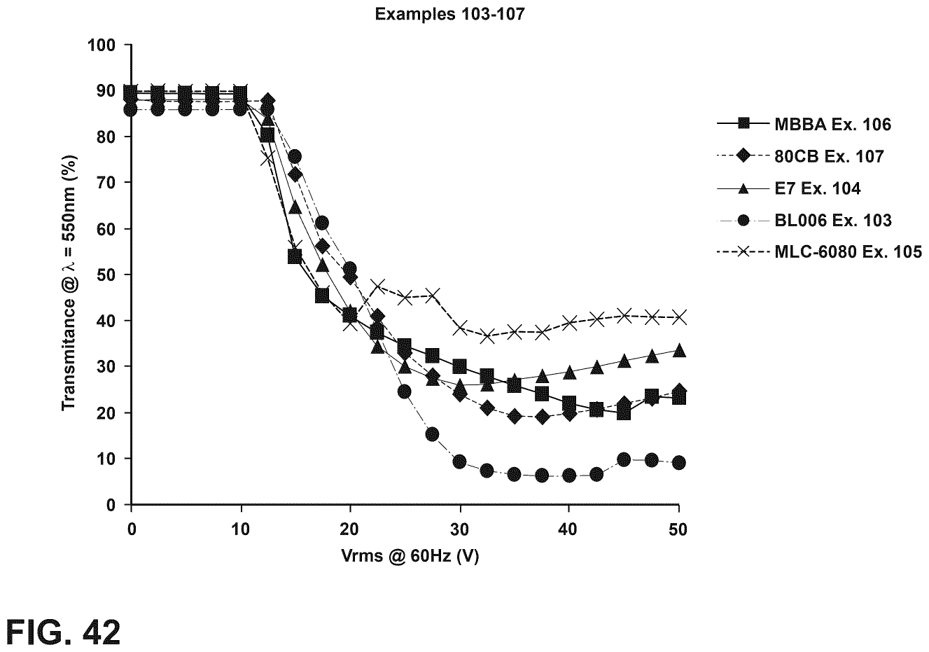

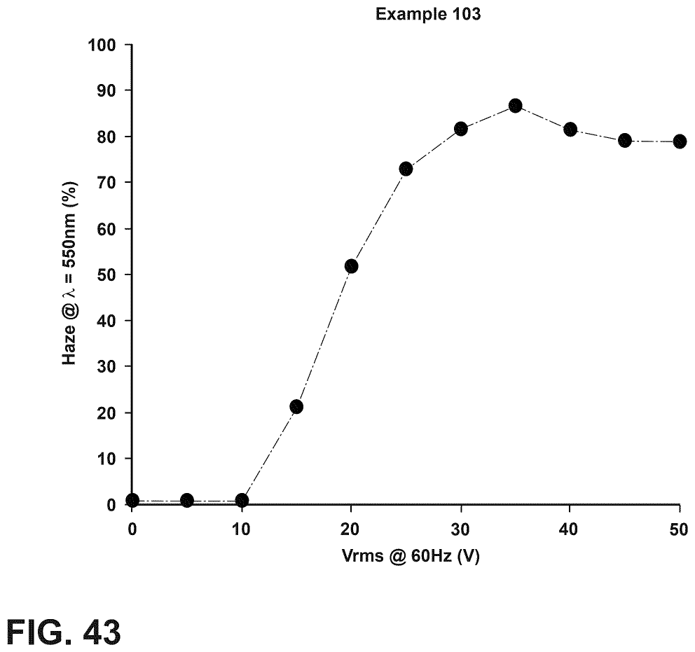

Voltage sweeps for the smart window articles of each of Examples 103-107 were conducted from a no voltage state to working voltages up to 50 V. The transmittance and haze at each voltage were measured. The results are set forth in the graphs reproduced at FIGS. 42 and 43. The graph showing transmittance as a function of voltage illustrates that large changes in transmittance as a function of voltage can be achieved. The change in transmittance as a function of working voltage for Example 103 was particularly large. The graph showing haze as a function of voltage for Example 103 illustrates that the smart window article exhibited relatively high haze values (greater than 70%) at a working voltage of 25 V, indicating that a haze of over 70% can reasonably be assumed for a working voltage of 24 V. Example 103 may be considered to be an exemplary smart window article of the present disclosure. However, these examples show that the list of positive liquid crystals that can be used to achieve haze of 7000 or more is extensive, since the weight percentage of each was limited to 20 wt % and the weight percentage can be optimized to achieve a haze of over 70% at the working voltage.

Examples 108-114—For Examples 108-114, smart window articles were fabricated similar to those of Examples 67-79 above. The polyimide alignment layers of each of the smart window articles were rubbed to induce parallel alignment of molecules of the liquid crystal layer. In addition, the liquid crystal layer was a combination of the negative nematic liquid crystal MLC-2079 and the positive liquid crystal 5CB. The weight percentage of the positive liquid crystal in the liquid crystal layer varied from 10 to 20 wt %, as set forth in Table 27 below. The negative liquid crystal was the balance of the liquid crystal layer. No separate polymeric material was included in the liquid crystal layer. No dichroic dye or chiral dopant was included in the liquid crystal layer.

TABLE 27

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 108 | Parallel | MLC-2079 | 5CB 10% | ~90% | 0.4% | 30 V | 12% | 76% |
| 109 | Parallel | MLC-2079 | 5CB 10% | ~90% | 0.4% | 50 V | 5% | 88% |
| 110 | Parallel | MLC-2079 | 5CB 12.5% | ~90% | 0.5% | 30 V | 8% | 86% |
| 111 | Parallel | MLC-2079 | 5CB 12.5% | ~90% | 0.5% | 45 V | 5% | 91% |
| 112 | Parallel | MLC-2079 | 5CB 15% | ~90% | 0.3% | 30 V | 10% | 79% |
| 113 | Parallel | MLC-2079 | 5CB 15% | ~90% | 0.3% | 50 V | 6% | 88% |
| 114 | Parallel | MLC-2079 | 5CB 20% | ~90% | <1% | 30 V | 88% | <10% |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 1%, with Examples 108-113 exhibiting a haze of less than or equal to 0.5%.

A working voltage (“Vₒₙ”) was then applied to each of the smart window articles, which subjected the liquid crystal layer thereof to the working voltage. The working voltage applied was 30 V, 45 V, or 50 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles to exhibit a haze within a range of from 76% to 91%, except for Example 114. For all except Example 114, a large change in transmittance accompanied the large change in haze from the no voltage state to the privacy state of application of the working voltage, with the transmittance values ranging from 5% to 12%.

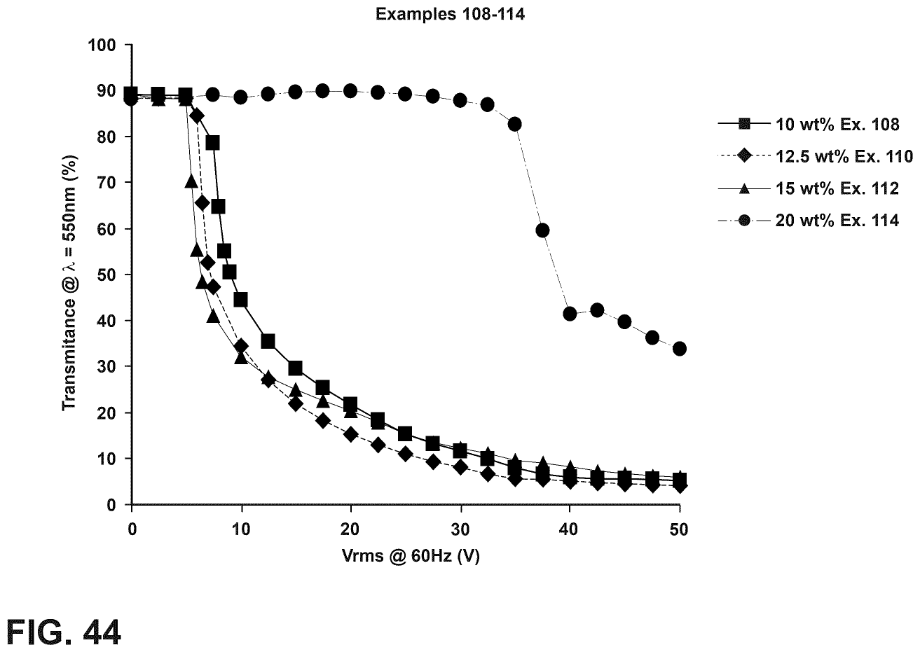

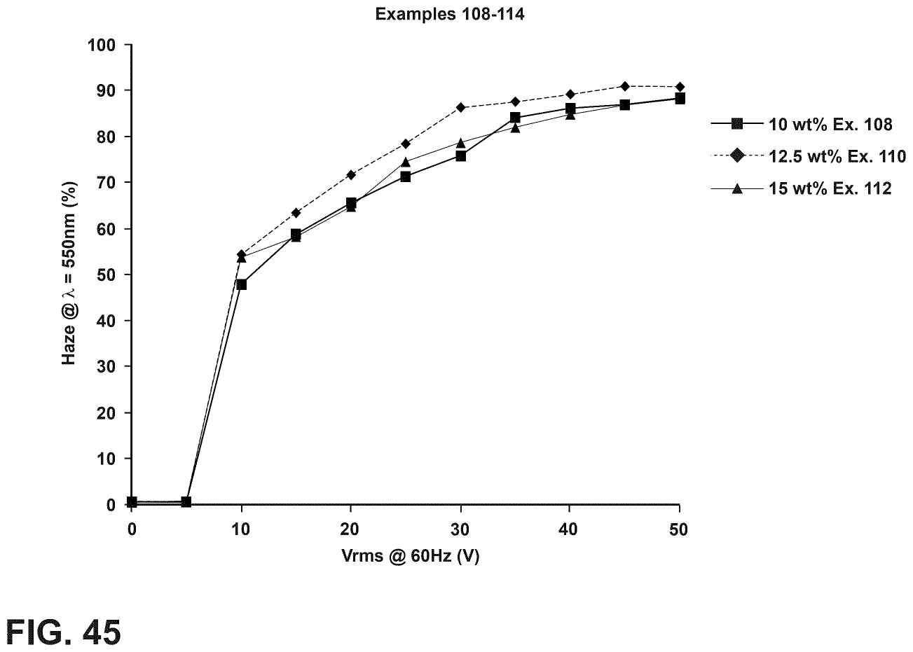

Voltage sweeps for the smart window articles of each of Examples 108-114 were conducted from a no voltage state to working voltages up to 50 V. The transmittance and haze at each voltage were measured. The results are set forth in the graphs reproduced at FIGS. 44 and 45. The graph showing transmittance as a function of voltage illustrates that large changes in transmittance as a function of voltage can be achieved when the weight percentage of the positive liquid crystal is less than or equal to 15 wt %. The graph showing haze as a function of voltage for Examples 110 and 112 illustrates that the smart window article exhibited relatively high haze values (greater than 70%) at a working voltage of 25 V, indicating that a haze of over 70% can reasonably be assumed for a working voltage of 24 V. Examples 110 and 112 may be considered to be exemplary smart window articles of the present disclosure.

Examples 115-121—For Examples 115-121, smart window articles were fabricated similar to those of Examples 67-79 above. The polyimide alignment layers of each of the smart window articles were rubbed to induce parallel alignment of molecules of the liquid crystal layer. In addition, the liquid crystal layer was a combination of the negative nematic liquid crystal MLC-2079 and a positive liquid crystal, the specific compound of which varied by example, as set forth in Table 28 below. The weight percentage of the positive liquid crystal in the liquid crystal layer for all of these examples was 15 wt %. The negative liquid crystal was the balance of the liquid crystal layer. No separate polymeric material was included in the liquid crystal layer. No dichroic dye or chiral dopant was included in the liquid crystal layer.

TABLE 28

| | | | Pos. LC | | | | | |
|---|---|---|---|---|---|---|---|---|
| Ex. | Alignment | Neg. LC | (wt %) | T(0 V) | H(0 V) | Vₒₙ | T(Vₒₙ) | H(Vₒₙ) |
| 115 | Parallel | MLC-2079 | BL006 15% | ~90% | 0.6% | 30 V | 14% | 77% |
| 116 | Parallel | MLC-2079 | BL006 15% | ~90% | 0.6% | 50 V | 5% | 90% |
| 117 | Parallel | MLC-2079 | E7 15% | ~90% | <1% | 30 V | 21% | <70% |
| 118 | Parallel | MLC-2079 | MLC-6080 | ~90% | <1% | 30 V | 35% | <70% |
| 119 | Parallel | MLC-2079 | MBBA 15% | ~90% | <1% | 30 V | 25% | <70% |
| 120 | Parallel | MLC-2079 | 8OCB 15% | ~90% | 0.4% | 30 V | 16% | 78% |
| 121 | Parallel | MLC-2079 | 8OCB 15% | ~90% | 0.4% | 50 V | 7% | 88% |

The transmittance (“T(0V)”) and haze (“H(0V)”) through each of the smart window articles without any voltage applied across the liquid crystal layer were determined. All the smart window articles exhibited a transmittance of about 90%. In addition, all the smart window articles exhibited a haze of less than 10%.

A working voltage (“Vₒₙ”) was then applied to each of the smart window articles, which subjected the liquid crystal layer thereof to the working voltage. The working voltage applied was 30 V or 50 V, as set forth in the table above.

The transmittance (“T(Vₒₙ)”) and haze (“H(Vₒₙ)”) through each of the smart window articles with the working voltage applied across the liquid crystal layer were determined. The application of the working voltage caused the smart window articles to exhibit a haze within a range of from 77% to 90%, for Examples 115, 116, 120, and 121. All the Examples 115-121 exhibited a large change in transmittance from the no voltage state to the privacy state of application of the working voltage, with the transmittance values ranging from 5% to 35%.

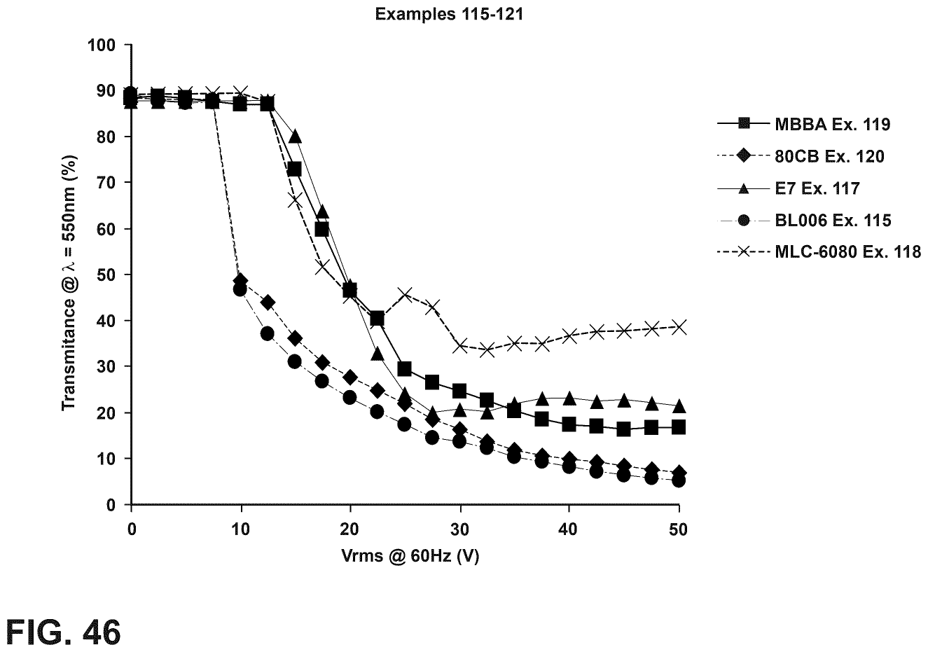

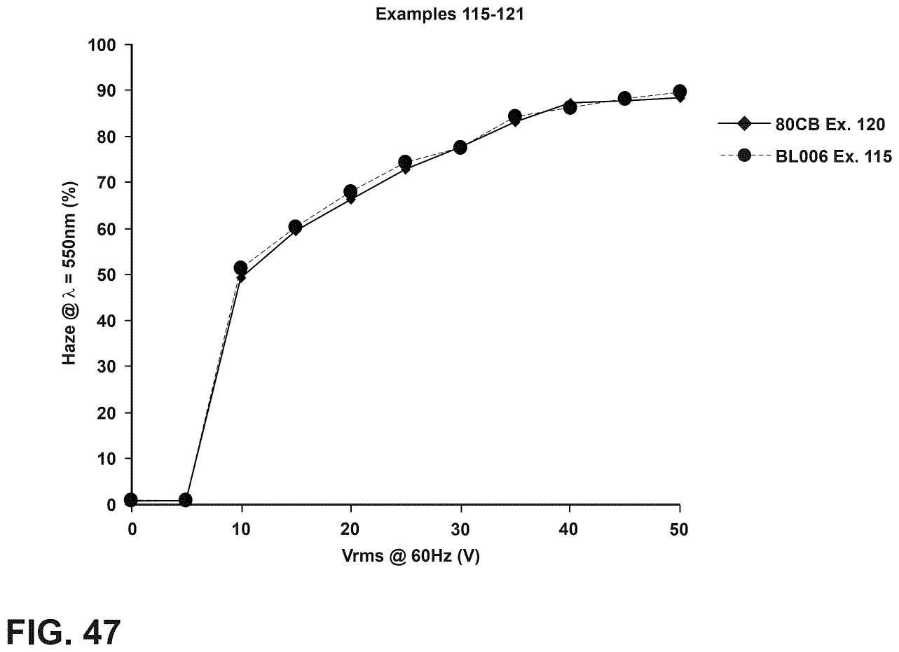

Voltage sweeps for the smart window articles of each of Examples 115-121 were conducted from a no voltage state to working voltages up to 50 V. The transmittance and haze at each voltage were measured. The results are set forth in the graphs reproduced at FIGS. 46 and 47. The graph showing transmittance as a function of voltage illustrates that large changes in transmittance as a function of voltage can be achieved regardless of the positive liquid crystal incorporated. However, Examples 115 and 120 exhibited especially large changes in transmittance in response to the application of the working voltage. The graph showing haze as a function of voltage for Examples 115 and 120 illustrates that the smart window article exhibited relatively high haze values (greater than 70%) at a working voltage of 25 V, indicating that a haze of over 70% can reasonably be assumed for a working voltage of 24 V. Examples 115 and 120 may be considered to be exemplary smart window articles of the present disclosure. However, these examples show that the list of positive liquid crystals that can be used to achieve haze of 70% or more is extensive, since the weight percentage of each was limited to 20 wt % and the weight percentage can be optimized to achieve a haze of over 70% at the working voltage.

Examples 122-129—For Examples 122-129, smart window articles are fabricated similar to those of the Examples above, with the addition of a polymer network to the liquid crystal layer. The alignment layers are either vertically or parallelly aligned by rubbing. The LC layer includes positive liquid crystals, negative liquid crystals, polymerizable monomers (2-methyl-1,4-phenylene bis(4-(3-(acryloyloxy)propoxy)benzoate; RM257 available from Merck), and a small amount (0.05% to 0.25% by weight) of photoinitiator (IRG 651 (Ciba® IRGACURE® 651, 2,2-Dimethoxy-2-phenylacetophenone, available from Ciba Specialty Chemicals)). Polymerization is then initiated and the resulting polyacrylate is aligned with the liquid crystals, which are aligned by the vertical or parallel alignment layers. In some examples, polymerization is initiated when an external electric field is applied and the alignment layers may not be needed. The liquid crystal layer is a combination of the negative nematic liquid crystal HNG-715600-100. The weight percentage of the positive liquid crystal 5CB is 19 wt % for all of Examples 122-129, based on the total weight of the liquid crystal layer and 20 wt. % based on the total weight of the positive and negative liquid crystals. The negative liquid crystal is 76 wt % of the liquid crystal layer and 80 wt % based on the total weight of the positive and negative liquid crystals. The polymer network is formed by exposing the mixture to ultraviolet light to activate the photoinitiator, triggering polymerization of the RM257 monomer within the liquid crystal matrix. The compositions and expected results are set forth in Table 29 below.

TABLE 29

| | | | | Monomer/ | | | | | | | | |
|---|---|---|---|---|---|---|---|---|---|---|---|---|
| | | | Pos. LC | polymer | Chiral | Dichroic | | | | | | |
| Ex. | Alignment | Neg. LC (wt %) | (wt %) | (wt %) | dopant | Dye | T(0 V) | H(0 V) | Vₒₙ | | T(Vₒₙ) | H(Vₒₙ) |
| 122 | Vertical | HNG-715600-100, 76% | 5CB 19% | RM257, 5% | — | — | ~90% | <5% | 30 | V | 9% | 80% |
| 123 | Vertical | HNG-715600-100, 76% | 5CB 19% | RM257, 5% | R-811, 0.5T | — | ~90% | <5% | 30 | V | 13% | 78% |
| 124 | Vertical | HNG-715600-100, 76% | 5CB 19% | RM257, 5% | — | M1012, 2% | 59% | <5% | 30 | V | 8% | 62% |
| 125 | Vertical | HNG-715600-100, 76% | 5CB 19% | RM257, 5% | R-811, 1T | M1012, 2% | 61% | <5% | 30 | V | 3% | 76% |
| 126 | Parallel | HNG-715600-100, 76% | 5CB 19% | RM257, 5% | — | — | ~90% | <5% | 30 | V | 9% | 83% |
| 127 | Parallel | HNG-715600-100, 76% | 5CB 19% | RM257, 5% | R- 811, 0.5T | — | ~90% | <5% | <35 | V | 8% | 83% |
| 128 | Parallel | HNG-715600-100, 76% | 5CB 19% | RM257, 5% | — | M1012, 2% | 58% | <5% | 30 | V | 8% | 78% |
| 129 | Parallel | HNG-715600-100, 76% | 5CB 19% | RM257, 5% | R-811, 0.5T | M1012, 2% | 58% | <5% | 30 | V | <8% | >78% |

The transmittance (“T(0V)”) and haze (“H(0V)”) through each of the smart window articles without any voltage applied across the liquid crystal layer are determined. The smart window articles exhibit a transmittance within a range of from 58% to 90%, with the transmittance decreasing when a dichroic dye is included. All the smart window articles exhibit a haze of less than 5% in the no voltage state. In general, the smart window articles in examples 122-129 exhibit a haze higher than those without any polymer in the no voltage state. The haze in the smart window articles having a polymer can be less than 5%, less than 4%, or less than 3% depending on the weight percent of the polymer.

A working voltage (“Vₒₙ”) is then applied to each of the smart window articles, which subjects the liquid crystal layer thereof to the working voltage. The working voltage applied is 30 V or less than 35 V, as set forth in the table above.

The transmittance (“T(Vₒₙ)”) and haze (“H(Vₒₙ)”) through each of the smart window articles with the working voltage applied across the liquid crystal layer are determined. The application of the working voltage causes the smart window articles of Examples 122-129 to exhibit a haze ranging from 62% to 83%. Examples 122, 123, 125, 126, 127, 128, and 129 exhibit haze values of 76% or greater, with Examples 122, 126, and 127 exhibiting haze values of 80% or greater. For all of Examples 122-129, a substantial decrease in transmittance accompanies the change in haze from the no voltage state to the privacy state of application of the working voltage, with the transmittance ranging from 3% to 13%.

Examples 122-129 demonstrate that the incorporation of a polymer network into the liquid crystal layer containing both positive and negative nematic liquid crystals maintains the advantageous switching performance achieved in the polymer-free examples. The polymer network, formed at 5 wt % from the RM257 monomer, does not substantially diminish the dynamic scattering effect produced by the positive-negative liquid crystal mixture. The smart window articles with the polymer network exhibit high haze values (greater than 70%) at working voltages of 35 V or less, while maintaining low haze values (less than 5% or less than 3%) in the clear state at 0 V.

The inclusion of the polymer network in Examples 122-129 provides compatibility with existing roll-to-roll film production facilities for polymer network liquid crystals, while retaining the advantages of dynamic scattering in the positive-negative liquid crystal mixture. The cell gap for these examples is within a range of from 2 μm to 20 μm, enabling use of existing LC panel production lines. The working voltage of 30 V or less is significantly lower than the 40-100 V typically required by conventional PDLC, PNLC, PSCT, and BCLC privacy technologies.

In summary, Examples 1-129 demonstrate that smart window articles incorporating a liquid crystal layer with both a positive liquid crystal and a negative liquid crystal achieve high haze values (greater than 70%, and in many cases greater than 80% or 90%) at working voltages of 55 V or less, while exhibiting low haze values (less than 20%, and in many cases less than 1%) in the no voltage state. The examples further demonstrate that the smart window articles function with both vertical alignment and parallel alignment configurations, with various combinations of negative liquid crystals (HNG-715600-100, MLC-2079), positive liquid crystals (5CB, CB5CB, CB7CB, CB9CB, CB11CB, HTG-135200-100, BL006, E7, MLC-6080, MBBA, 80CB, 8CB), chiral dopants (CB-15, R-811), and dichroic dyes (M1012). Examples 122-129 further demonstrate that the incorporation of a polymer network (at 5 wt %) into the liquid crystal layer maintains the advantageous switching performance while providing compatibility with polymer network liquid crystal manufacturing infrastructure. The weight percentage of the positive liquid crystal within the liquid crystal layer is optimized within a range of from 6.0 wt % to 35 wt % to achieve the desired haze and transmittance performance at the working voltage.

It will be apparent to those skilled in the art that various modifications and variations can be made without departing from the spirit or scope of the claims.

What is claimed is:

1. A smart window article comprising:
a first transparent substrate comprising a first inward facing surface and a first outward facing surface;
a second transparent substrate comprising a second inward facing surface and a second outward facing surface, the second inward facing surface opposing the first inward facing surface;
a first transparent electrode layer disposed on the first inward facing surface of the first transparent substrate;
a second transparent electrode layer disposed on the second inward facing surface of the second transparent substrate; and
a liquid crystal layer sandwiched between the first transparent electrode layer and the second transparent electrode layer, the liquid crystal layer comprising:
a negative liquid crystal that exhibits a dielectric anisotropy (Δε) that is less than 0; and
a positive liquid crystal that exhibits a dielectric anisotropy (Δε) that is greater than 0,
wherein, the smart window article is operable to, from, and between (i) a first voltage state and (ii) a second voltage state during which the smart window article subjects the liquid crystal layer to a working voltage that is greater than a voltage to which the liquid crystal layer is subjected during the first voltage state,
wherein, during the first voltage state, the smart window article exhibits a haze of less than or equal to 20%,
wherein, during the second voltage state, the smart window article exhibits a haze of greater than or equal to 70%, and
wherein, the working voltage during the second voltage state is less than or equal to 55 V.

2. The smart window article of claim 1, wherein the first transparent substrate and second transparent substrate each individually comprise glass, glass-ceramic, or plastic.

3. The smart window article of claim 1, wherein the liquid crystal layer further comprises a polymer.

4. The smart window article of claim 3, wherein the polymer comprises a polyacrylate, a diacrylate, a polyurethane, a polyurethane acrylate, a polyvinyl alcohol, a polyvinyl acetate, a poly(vinyl alcohol-co-vinyl acrylate), polyethylene, polypropylene, copolymers of any of the foregoing, or mixtures of any of the foregoing.

5. The smart window article of claim 3, wherein a weight percentage of the polymer within the liquid crystal layer is in a range of 1 wt. % to 15 wt. %, based on the total weight of the liquid crystal layer.

6. The smart window article of claim 1, wherein during the first voltage state, the smart window article exhibits a transmittance of greater than or equal to 20%.

7. The smart window article of claim 1, wherein the negative liquid crystal and the positive liquid crystal are both organic molecules that lack fluorine as an atomic constituent.

8. The smart window article of claim 1, wherein a weight percentage of the positive liquid crystal within the liquid crystal layer is within a range of from 6.0 wt % to 35 wt %, based on the total weight of the positive liquid crystal and the negative liquid crystal.

9. The smart window article of claim 1, wherein the liquid crystal layer has a LC layer thickness that is within a range of from 2 μm to 20 μm.

10. The smart window article of claim 1, wherein:
the liquid crystal layer further comprises a chiral dopant, and
the liquid crystal layer exhibits a chiral nematic phase at room temperature.

11. The smart window article of claim 1, wherein a weight percentage of the chiral dopant within the liquid crystal is sufficient to cause the liquid crystal to exhibit a twist within a range of from 0.25 T to 1.25 T.

12. The smart window article of claim 1, wherein the liquid crystal layer further comprises a dichroic dye, wherein a weight percentage of the dichroic dye within the liquid crystal layer is within a range of from 0.2 wt % to 3.5 wt %, based on the total weight of the dichroic dye and liquid crystals.

13. The smart window article of claim 1, further comprising:
a first alignment layer disposed on the first transparent electrode; and
a second alignment layer disposed on the second transparent electrode and opposing the first alignment layer,
wherein, the liquid crystal layer is sandwiched between and contacting the first alignment layer and the second alignment layer.

14. The smart window article of claim 1, further comprising: a total thickness that is within a range of from 0.15 mm to 1.1 mm.

15. The smart window article of claim 1, wherein during the first voltage state, the haze that the smart window article exhibits is less than or equal to 3%.

16. The smart window article of claim 1, wherein during the second voltage state, the haze that the smart window article exhibits is greater than or equal to 80%.

17. The smart window article of claim 1, wherein
the smart window article is operable at a third voltage state, wherein the working voltage during the third voltage state is less than the working voltage during the second voltage state and greater than or equal to the working voltage during the first voltage state, and
during the third voltage state, the transmittance that the smart window article exhibits is (i) lower than the transmittance that the smart window article exhibits during the first voltage state and (ii) higher than the transmittance that the smart window article exhibits during the second voltage state.

18. A method of operating the smart window article of claim 1 comprising: a privacy transition step comprising applying a working voltage of less than or equal to 55 V to the first transparent electrode layer and the second transparent electrode layer, thereby causing the smart window article to transition from the first voltage state to the second voltage state.

19. An insulated glass unit comprising:
a first outer pane;
a second outer pane; and
at least one spacer element defining a space between the first outer pane and the second outer pane; wherein at least one of the first outer pane and the second outer pane comprises the smart window article of claim 1.

20. An insulated glass unit comprising:
a first outer pane;
a second outer pane;
an inner pane disposed between the first outer pane and the second outer pane; and
at least one spacer element further defines (i) a first space between the first outer pane and the inner pane and (ii) a second space between the inner pane and the second outer pane,
wherein at least one of the first outer pane, the second outer pane, and the inner pane comprises the smart window article of claim 1.
